(19) United States
(12) Patent Application Publication
(10) Pub. No.: US 2008/0145571 A1
(43) Pub. Date: Jun. 19, 2008

(54) Polymer Compound And Polymer Light Emitting Device Using The Same

(75) Inventors: Shigeya Kobayashi, Ibaraki (JP); Satoshi Kobayashi, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku, Tokyo (JP)

(21) Appl. No.: 11/722,225

(22) PCT Filed: Dec. 21, 2005
(86) PCT No.: PCT/JP2005/024011

§ 371 Date: Jun. 20, 2007

(30) Foreign Application Priority Data
Dec. 28, 2004 (JP) 2004-378517

(51) Int. Cl. H01J 1/63; C08F 12/32; C08F 30/02; C08F 30/08; C08F 34/00; C08F 34/04; C09K 19/08

(52) U.S. Cl. 428/1.4; 526/280; 526/279; 526/256; 526/259; 526/275; 428/523

(57) ABSTRACT

A polymer compound comprising a structure of the following formula (1):

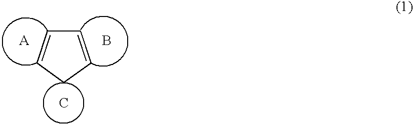

(wherein, A ring and B ring each independently represent an aromatic hydrocarbon ring optionally having a substituent, and C ring represents an alicyclic hydrocarbon ring containing no condensed aromatic compound and having at least one substituent. The alicyclic hydrocarbon may contain a hetero atom).

### TECHNOLOGICAL FIELD

The present invention relates to a polymer compound and a polymer light emitting device using the same.

### BACKGROUND TECHNOLOGY

Light emitting materials and charge transporting materials of higher molecular weight are soluble in solvents and capable of forming an organic layer in a light emitting device by a coating method, differing from those of lower molecular weight, thus, have been investigated variously, and for example, there is known a polymer compound having as a repeating unit the following structure in which two benzene rings are condensed to a cyclopentadiene ring and two alkyl groups are connected to a carbon atom of the cyclopentadiene ring, the carbon atom not being condensed to the benzene ring (e.g., Advanced Materials 1999, vol. 9, no. 10, p. 798; International Publication 99/54385 pamphlet).

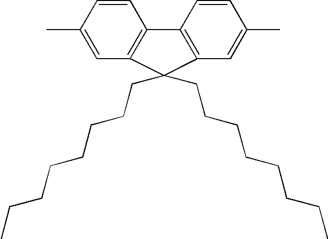

There is a problem, however, that the above-mentioned polymer compound has not necessarily sufficient heat resistance.

### DISCLOSURE OF THE INVENTION

The present invention has an object of providing a polymer compound useful as a light emitting material or charge transporting material and having excellent heat resistance.

That is, the present invention provides a polymer compound containing a structure of the following formula (1):

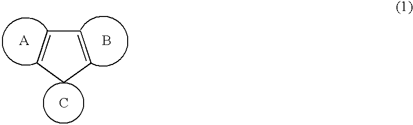

wherein, A ring and B ring each independently represent an aromatic hydrocarbon ring optionally having a substituent, and C ring represents an alicyclic hydrocarbon ring having at least one substituent. The alicyclic hydrocarbon ring may contain a hetero atom.

### BEST MODES FOR CARRYING OUT THE INVENTION

The polymer compound of the present invention contains a structure of the above-described formula (1). As one preferable structure of the formula (1), a structure of the following formula (1-A) is mentioned:

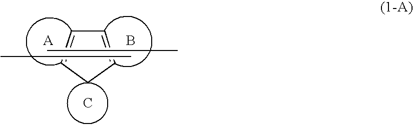

wherein, A ring, B ring and C ring represent the same meanings as described above, and two connecting bonds are present each on A ring or B ring.

The structure of the above-described formula (1-A) is contained in a proportion of one molecule in a main chain of the polymer compound in some cases, contained as a repeating unit in some cases, or contained in a side chain in some cases. From the stand point of device properties such as heat resistance, solubility, light emitting property, luminance half-lifetime and the like, the structure is preferably contained as a repeating unit in the polymer compound. When the polymer compound of the present invention contains the structure of the above-described formula (1-A) as a repeating unit, its content is usually 1 mol % or more and 100 mol % or less, preferably 20 mol % or more, and further preferably 30 mol % or more and 100 mol % or less based on the sum of all repeating units in the polymer compound of the present invention.

As another preferable structure of the above-described formula (1), a structure of the following formula (1-B) is mentioned:

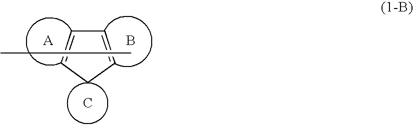

wherein, A ring, B ring and C ring represent the same meanings as described above, and one connecting bond is present on A ring or B ring.

The structure of the above-described formula (1-B) is present on a side chain or end of the polymer compound. In these cases, a structure of the above-described formula (1-A) may or may not be contained in a repeating unit of the polymer compound.

As another preferable structure of the above-described formula (1), a structure of the following formula (1-C) is mentioned:

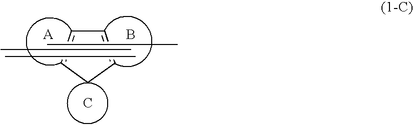

wherein, A ring, B ring and C ring represent the same meanings as described above, and three connecting bonds are present each on A ring or B ring.

When the structure of the above-described formula (1-C) is contained, the polymer compound usually has a branched structure. When the above-described formula (1-C) is contained, the content of the structure of the above-described formula (1-C) is preferably 10 mol % or less, more preferably 1 mol % or less, from the standpoint of solubility and the like.

Mentioned as the structure of the above-described formula (1) are structures having four or more connecting bonds on A ring and B ring, structures having at least one connecting bond on C ring, and the like, in addition to the above-described formulae (1-A), (1-B) and (1-C).

In the above-described formula (1), A ring and B ring each independently represent an aromatic hydrocarbon ring optionally having a substituent, and it is preferable, from the standpoint of heat resistance, fluorescence intensity, device properties and the like, that at least one of them is an aromatic hydrocarbon ring formed by condensation of two or more benzene rings. To this aromatic hydrocarbon ring, an aromatic hydrocarbon ring other than a benzene ring and/or a non-aromatic hydrocarbon-based condensed ring may further be condensed.

In the above-described formula (1), the aromatic hydrocarbon ring A and the aromatic hydrocarbon ring B may have mutually the same ring structure or different ring structures, and it is preferable, from the standpoint of heat resistance and fluorescence intensity, that the aromatic hydrocarbon ring A and the aromatic hydrocarbon ring B have mutually different ring structures.

As the aromatic hydrocarbon ring, a single benzene ring or that formed by condensation of two or more benzene rings is preferable, and examples thereof include aromatic hydrocarbon rings such as a benzene ring, naphthalene ring, anthracene ring, tetracene ring, pentacene ring, pyrene ring, phenanthrene ring and the like, and preferably include a benzene ring, naphthalene ring, anthracene ring and phenanthrene ring.

As a combination of A ring and B ring, preferably mentioned are combinations of benzene ring and naphthalene ring, benzene ring and anthracene ring, benzene ring and phenanthrene ring, naphthalene ring and anthracene ring, naphthalene ring and phenanthrene ring, and, anthracene ring and phenanthrene ring, and more preferable is a combination of benzene ring and naphthalene ring.

The phrase that the aromatic hydrocarbon ring A and the aromatic hydrocarbon ring B have mutually different ring structures means that when

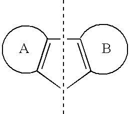

in the formula (1) is represented by a plane structural formula, the aromatic hydrocarbon ring A and the aromatic hydrocarbon ring B are asymmetrical over a symmetry axis (dot line) connecting the peak of a 5-membered ring situated at the center of the structural formula and the midpoint of a side opposed to the peak.

For example, when A ring and B ring are naphthalene rings, A ring and B ring have different ring structures in the case of

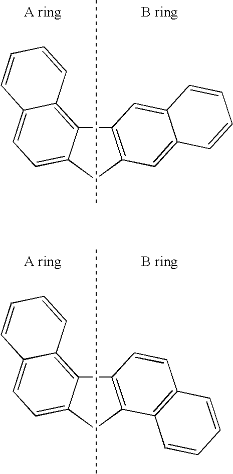

While even if A ring and B ring are naphthalene rings, A ring and B ring have the same ring structure in the case of

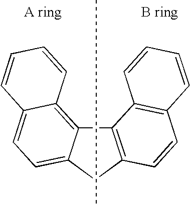

Specific examples of the structure of the above-described formula (1-A) include structures described below (1A-1 to 1A-64, 1B-1 to 1B-64, 1C-1 to 1C-64, 1D-1 to 1D-20) and those having a substituent on these structures. In the following descriptions, a connecting bond on an aromatic hydrocarbon ring can reside on any position of A ring and B ring. C ring represents the same meaning as described above.

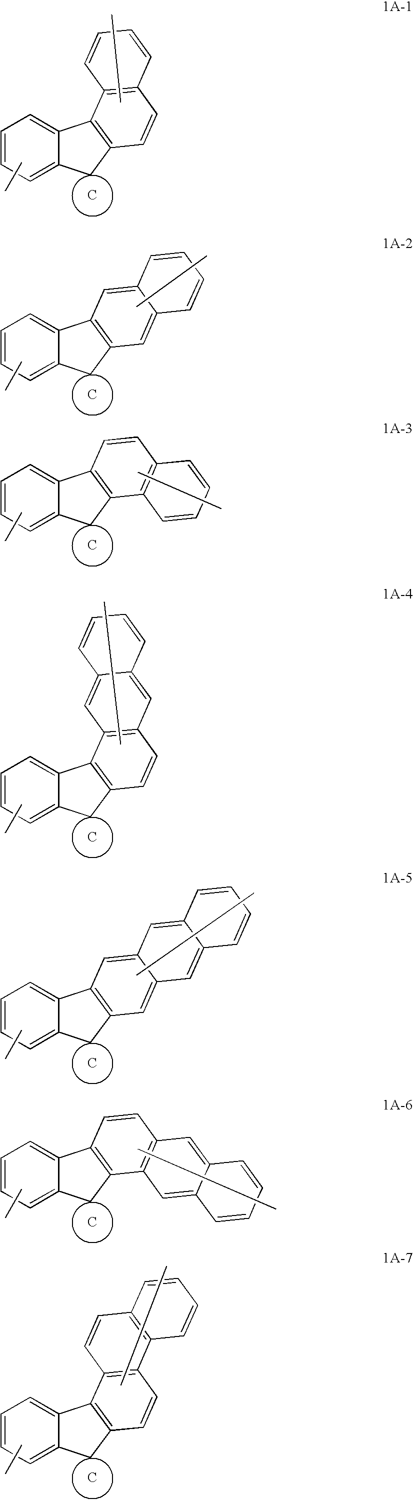

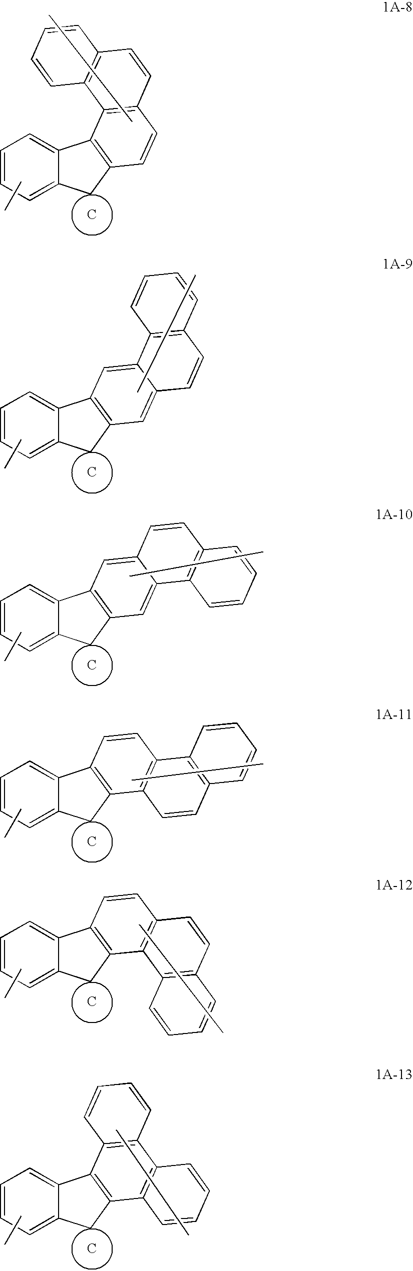

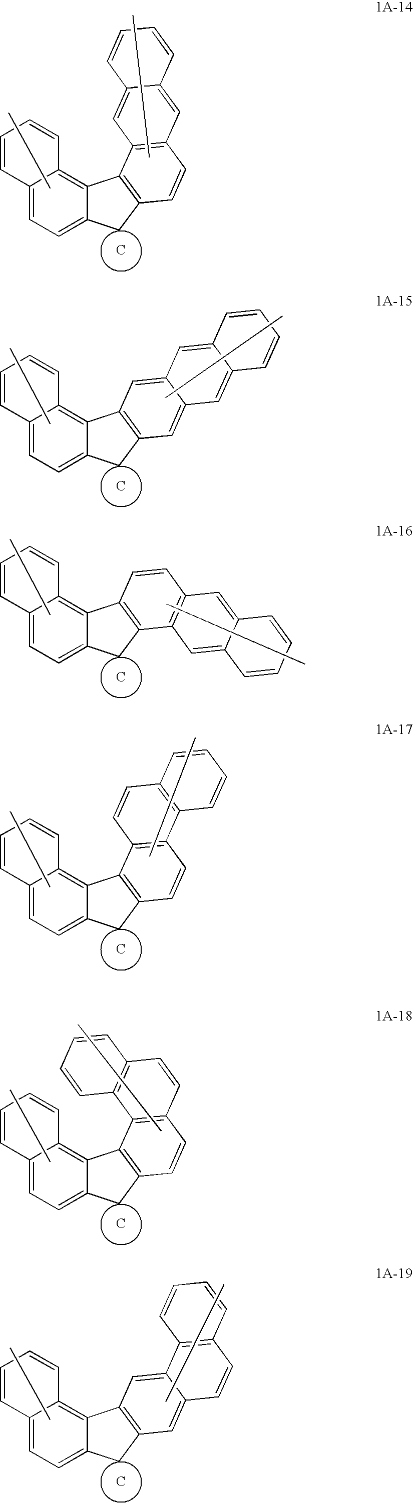

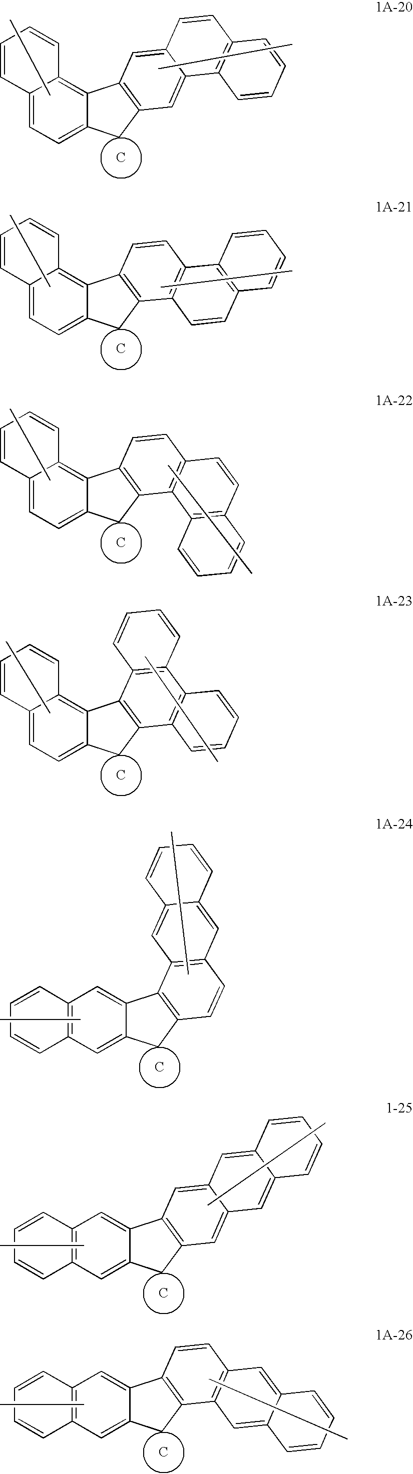

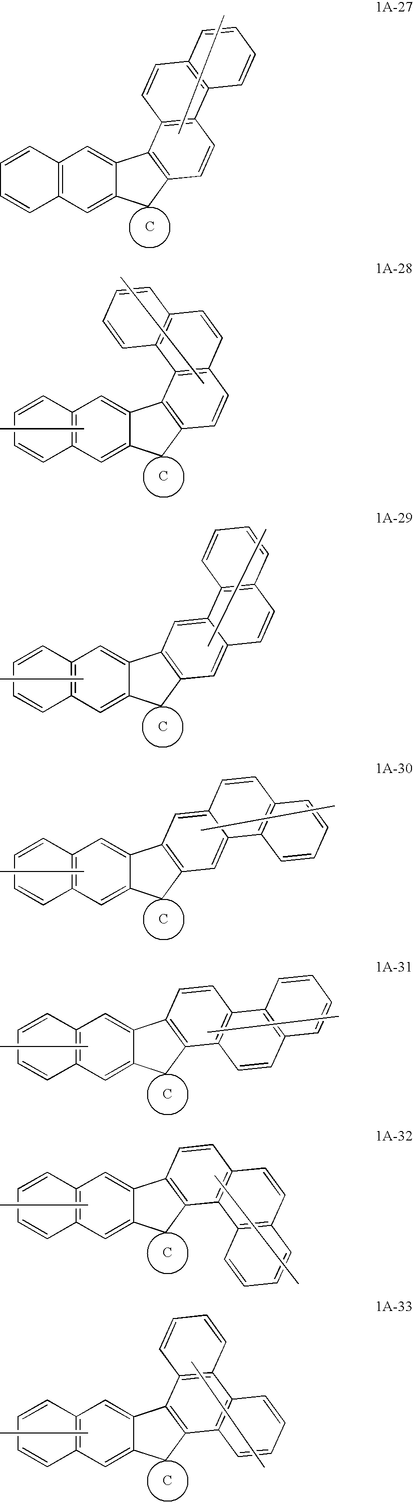

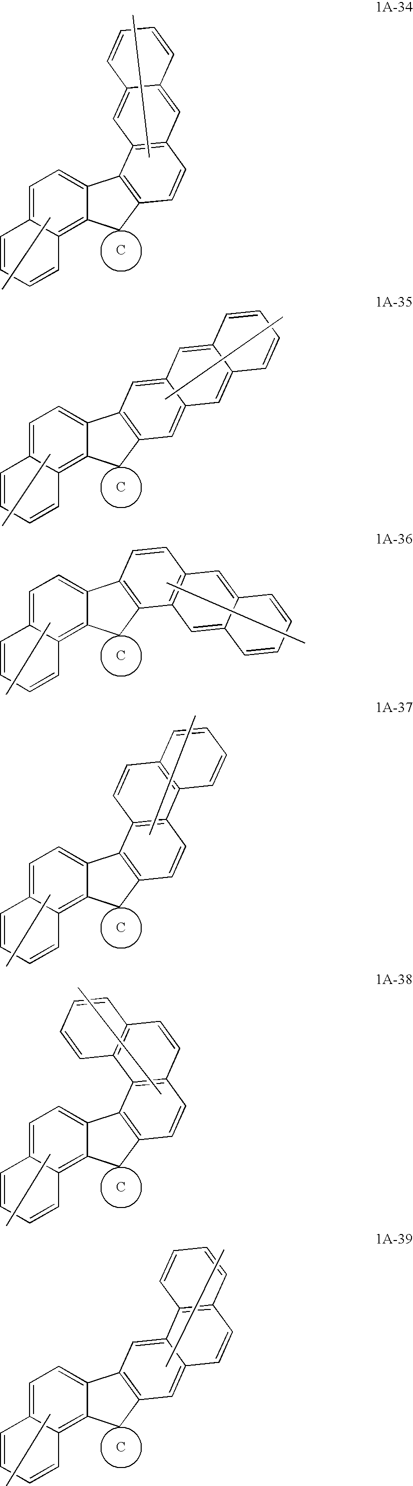

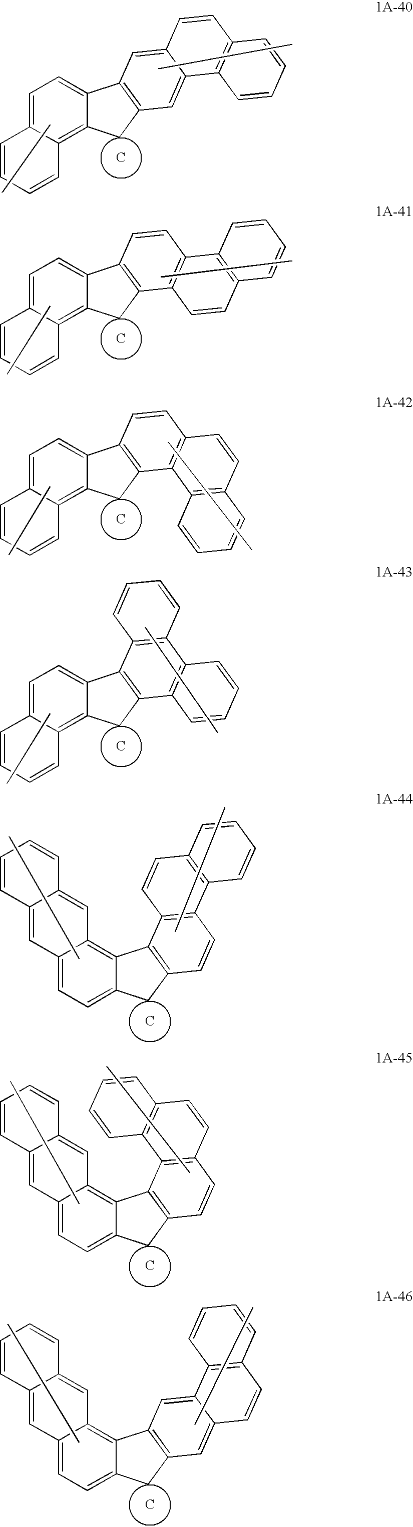

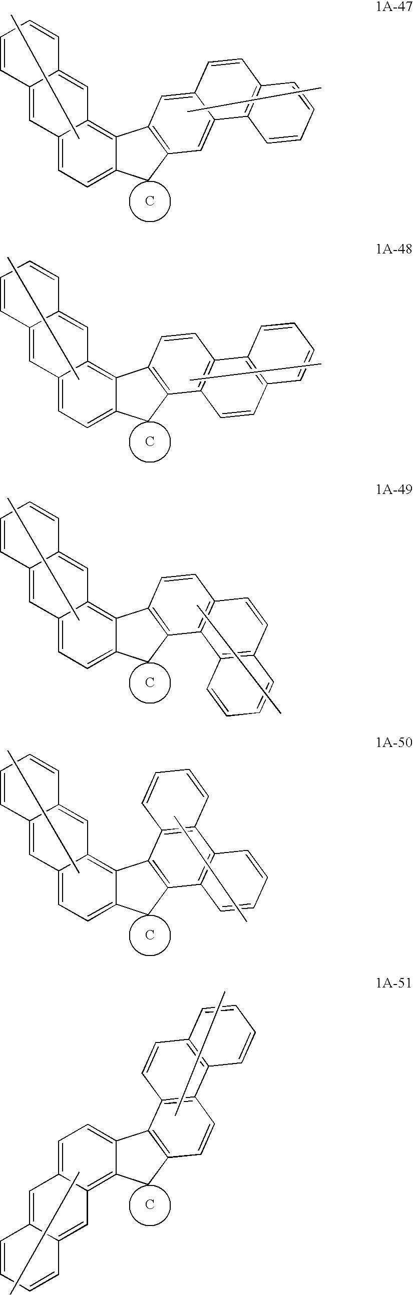

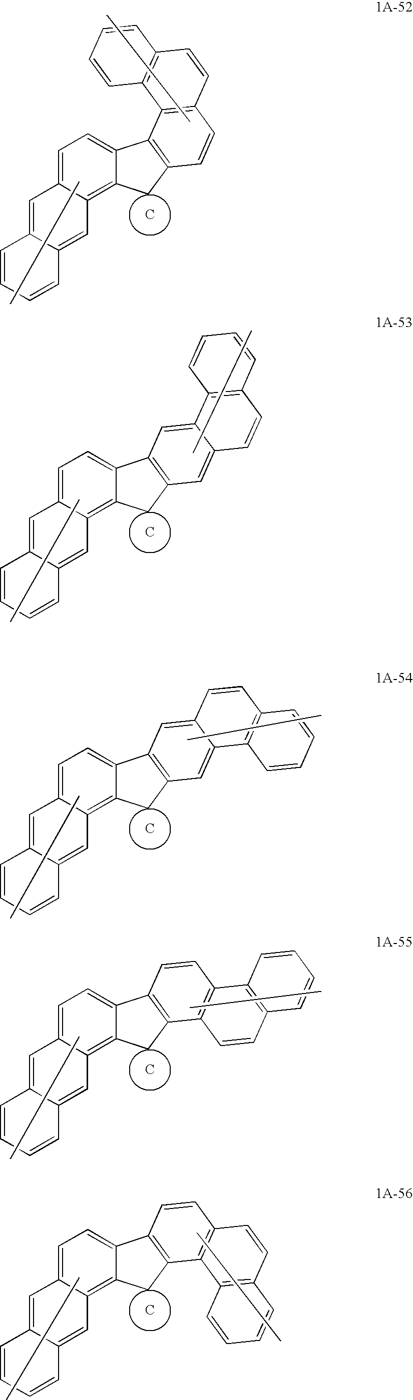

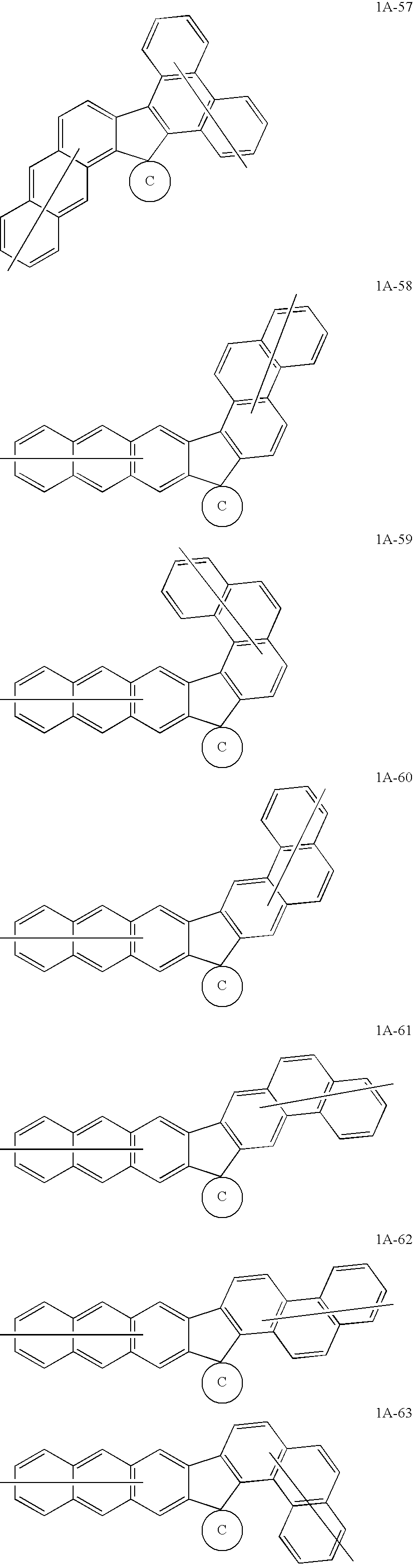

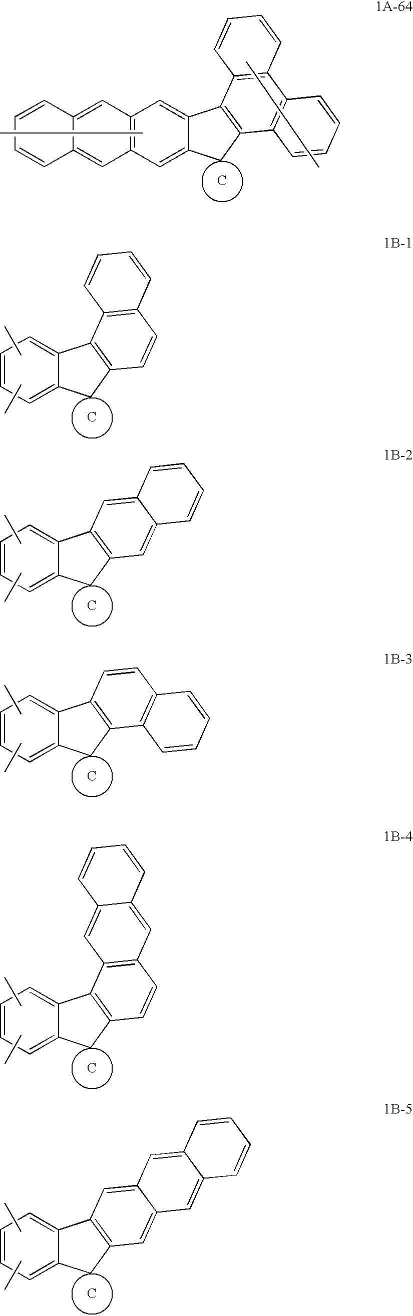

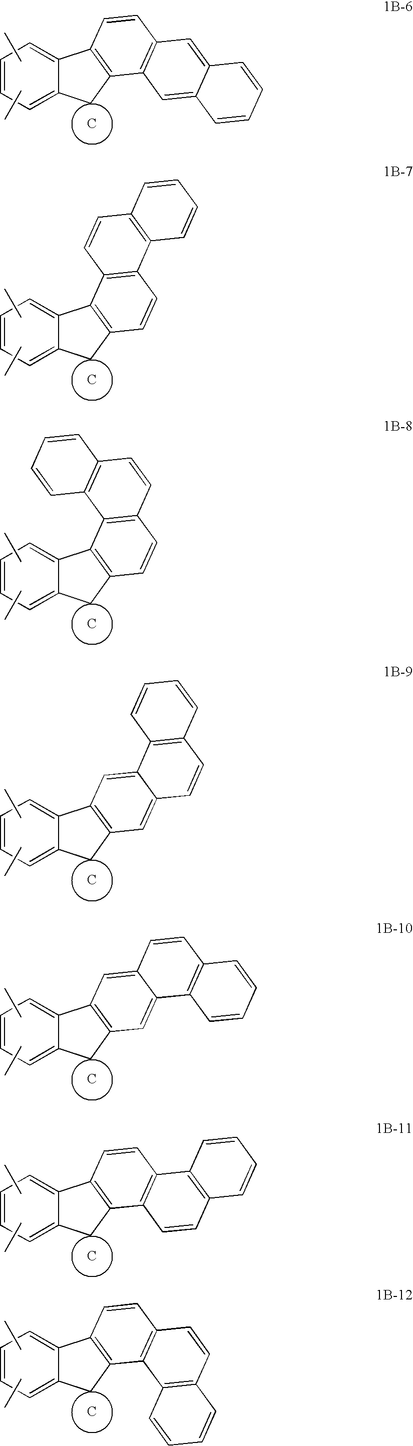

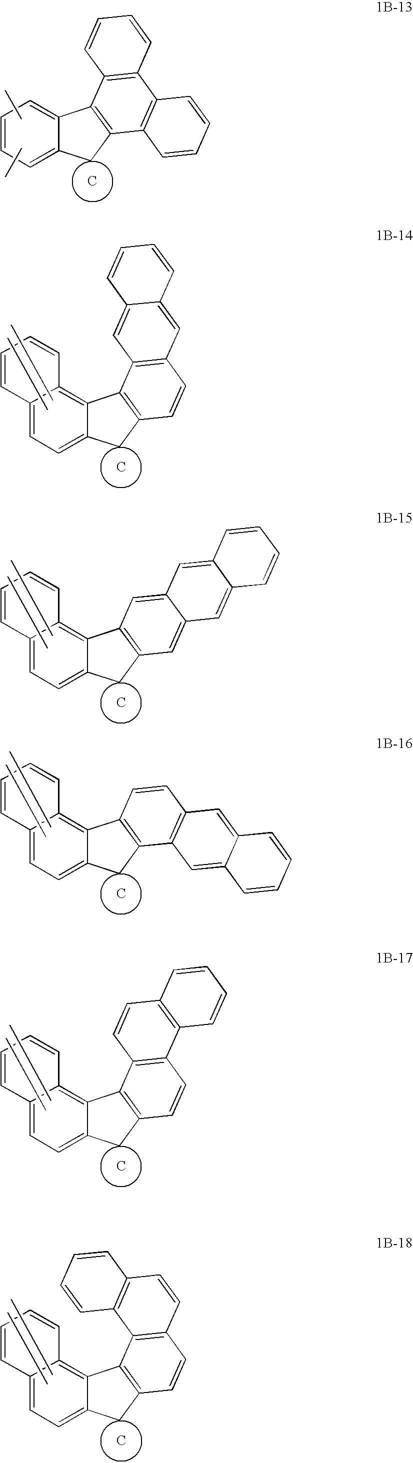

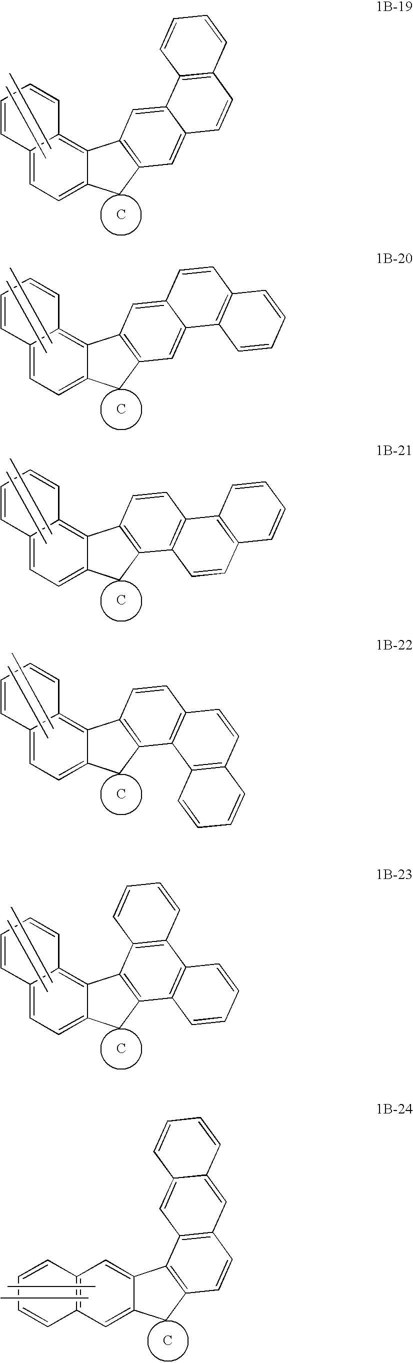

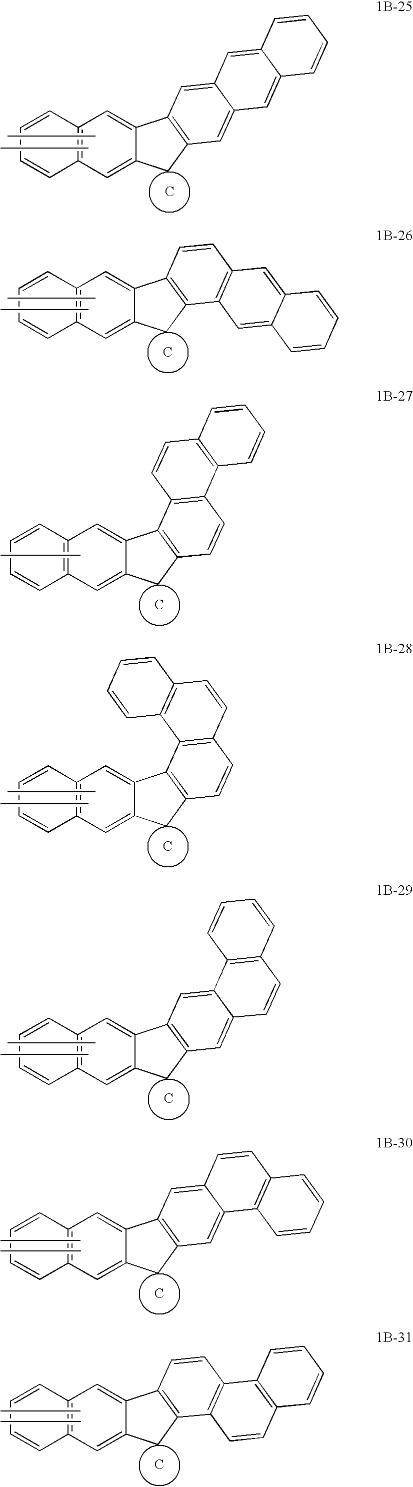

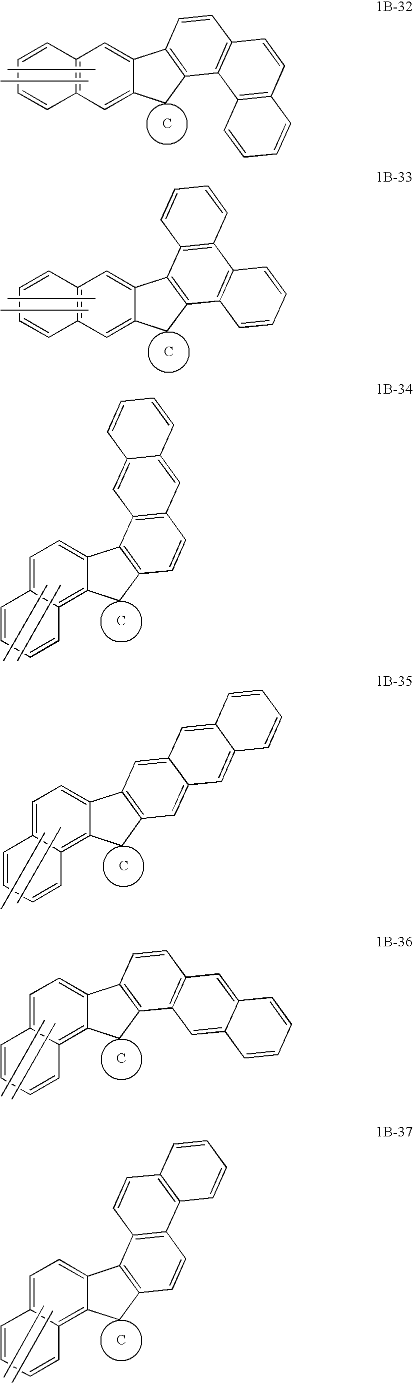

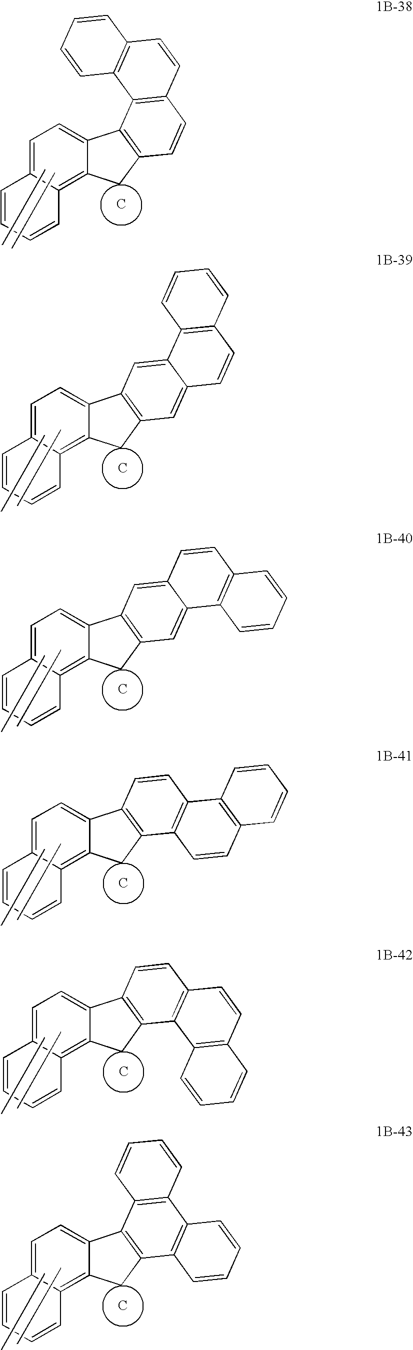

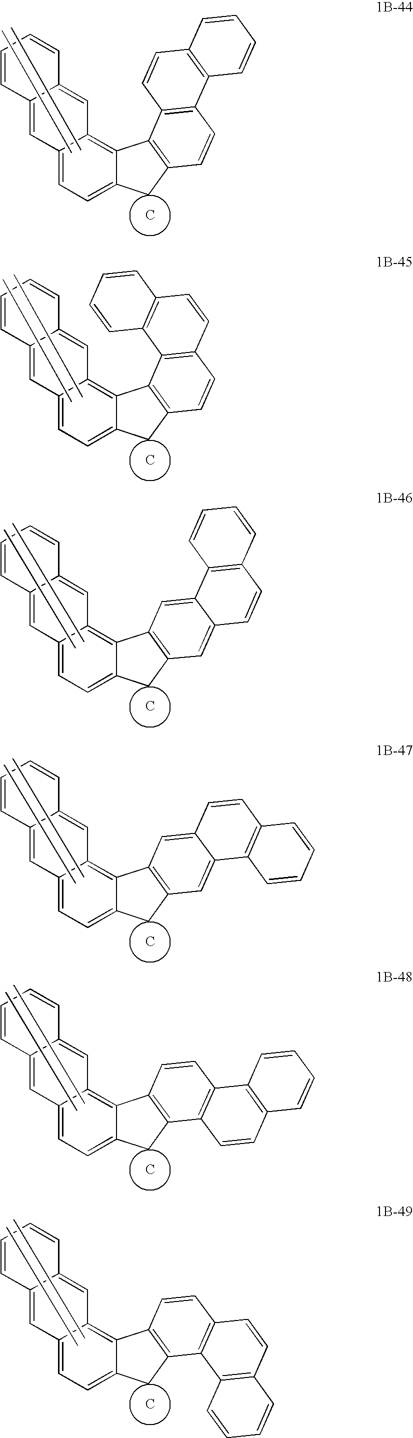

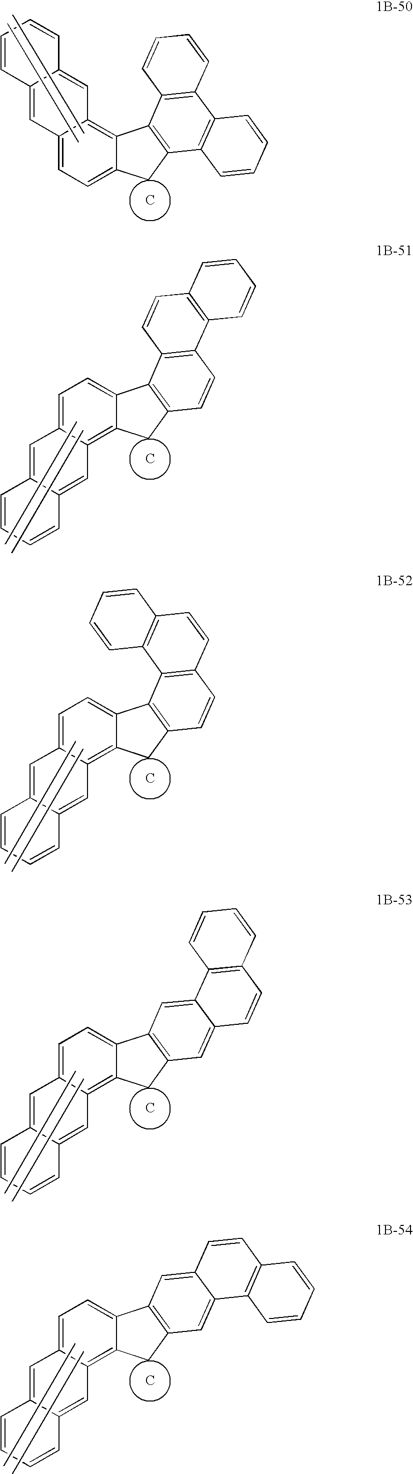

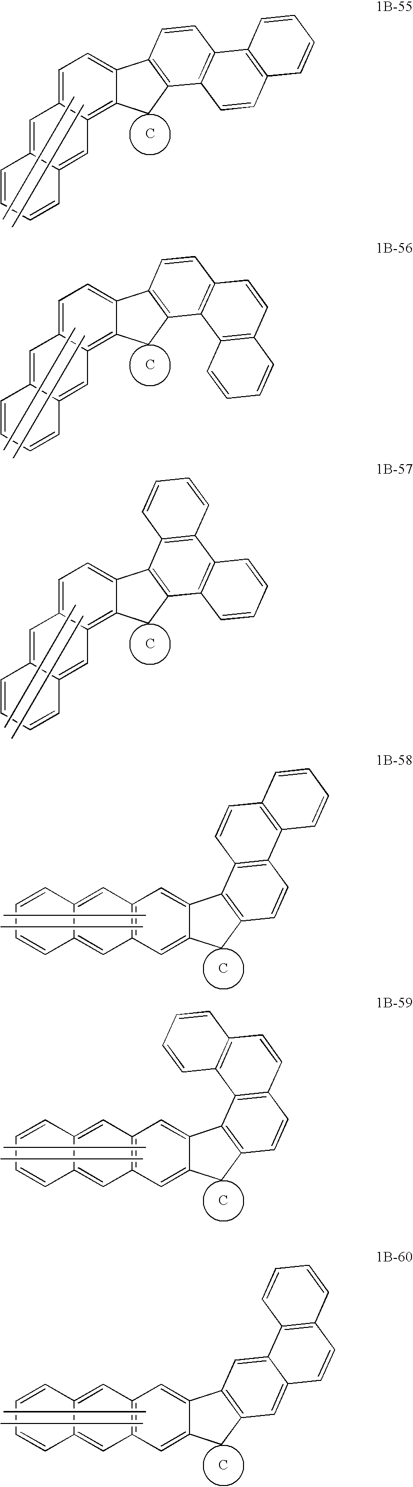

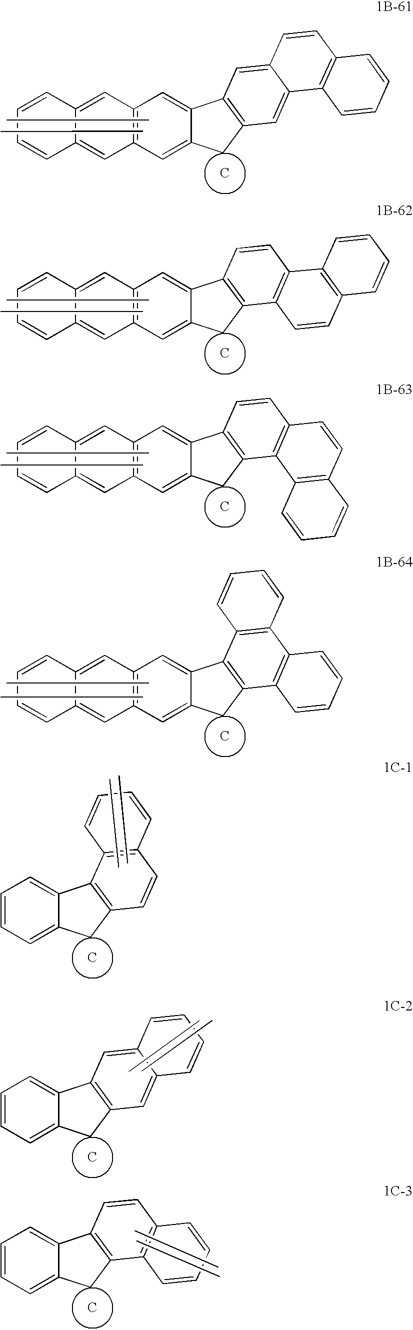

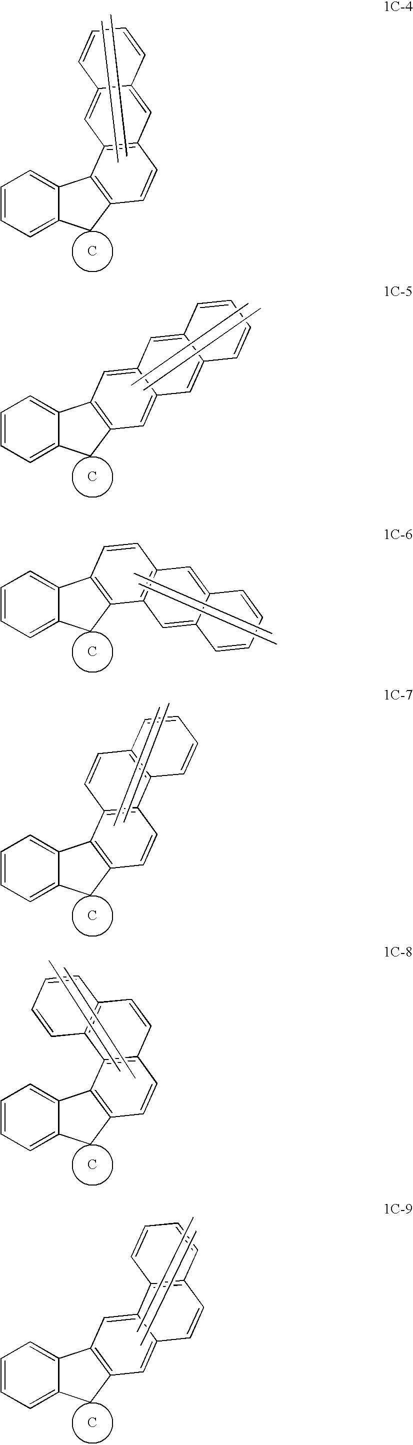

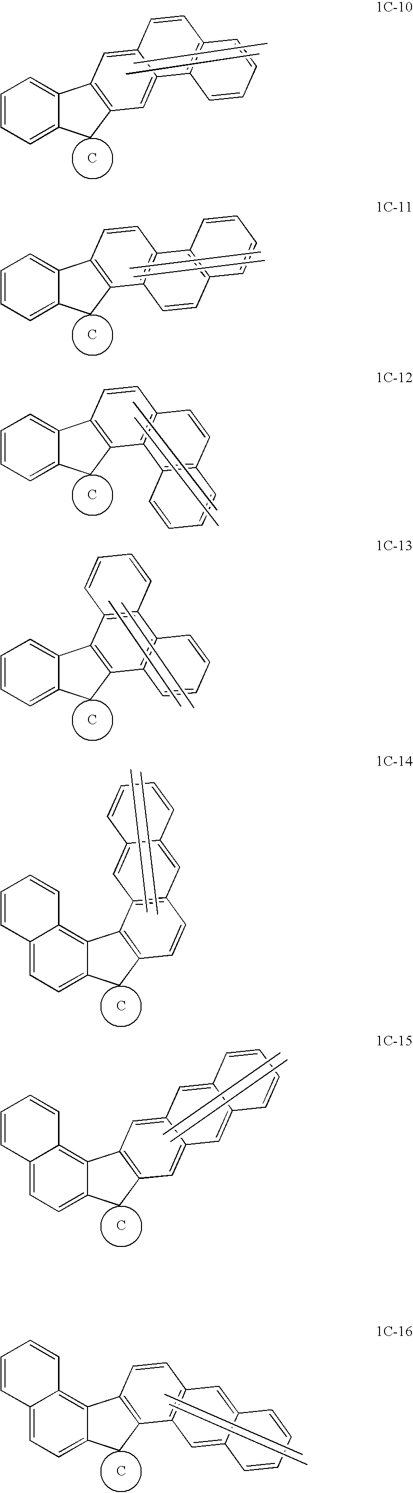

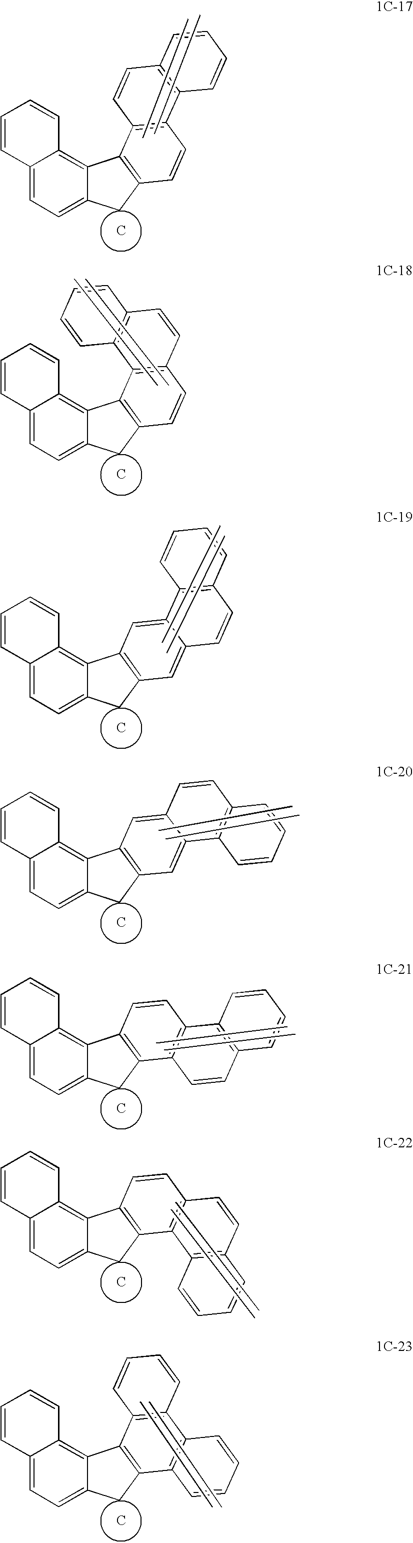

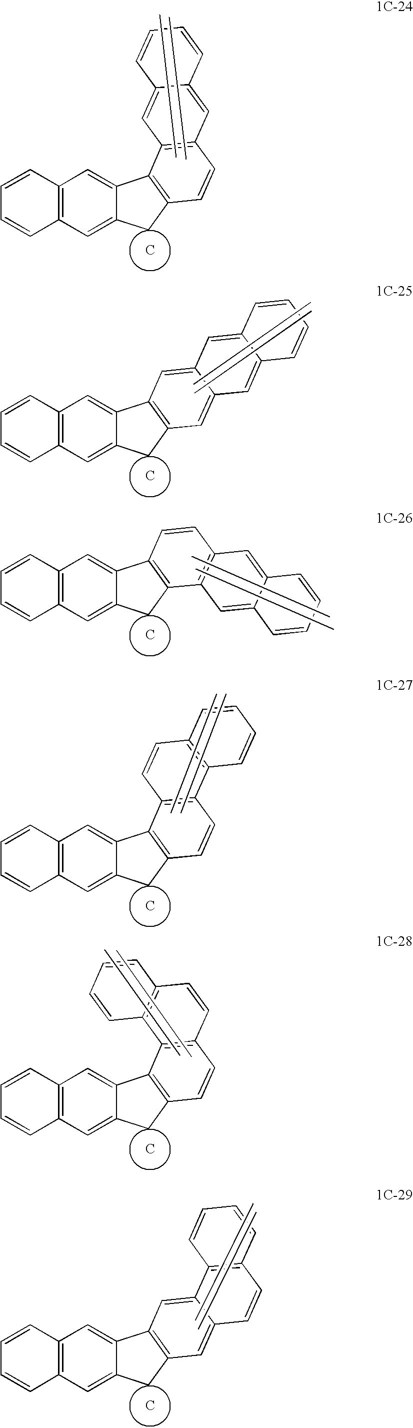

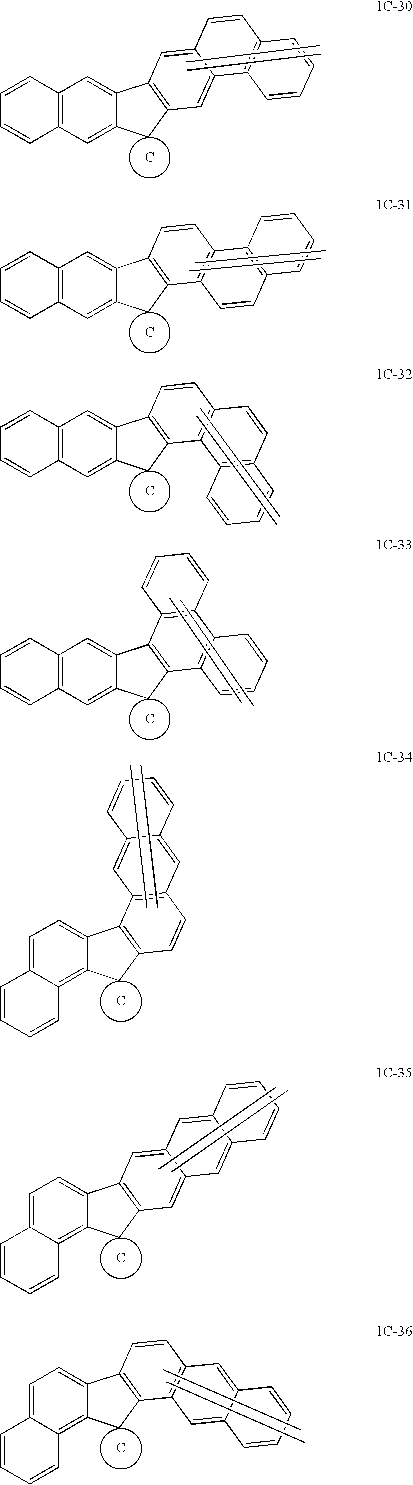

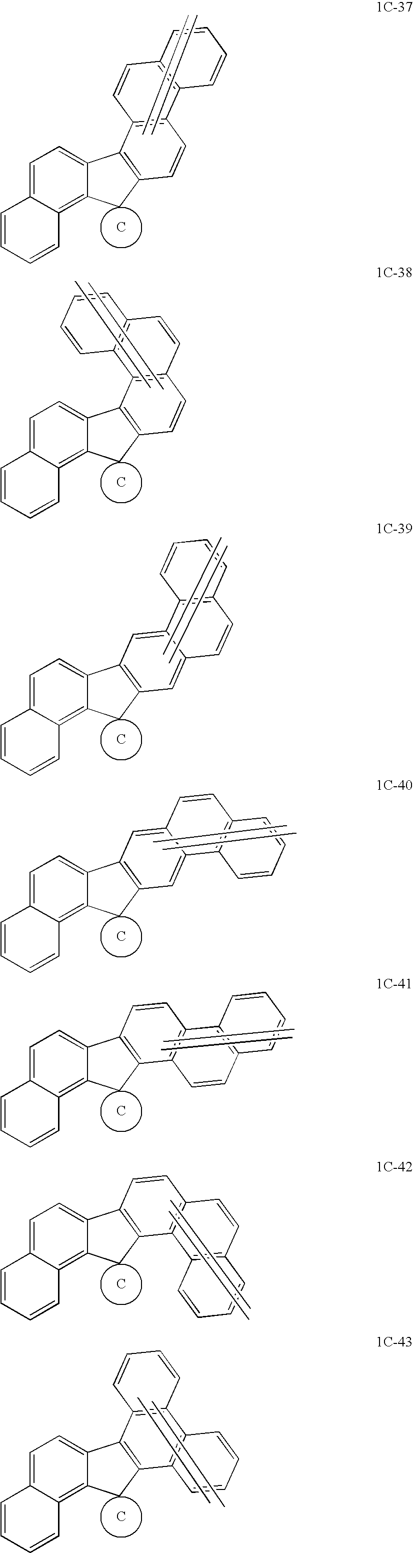

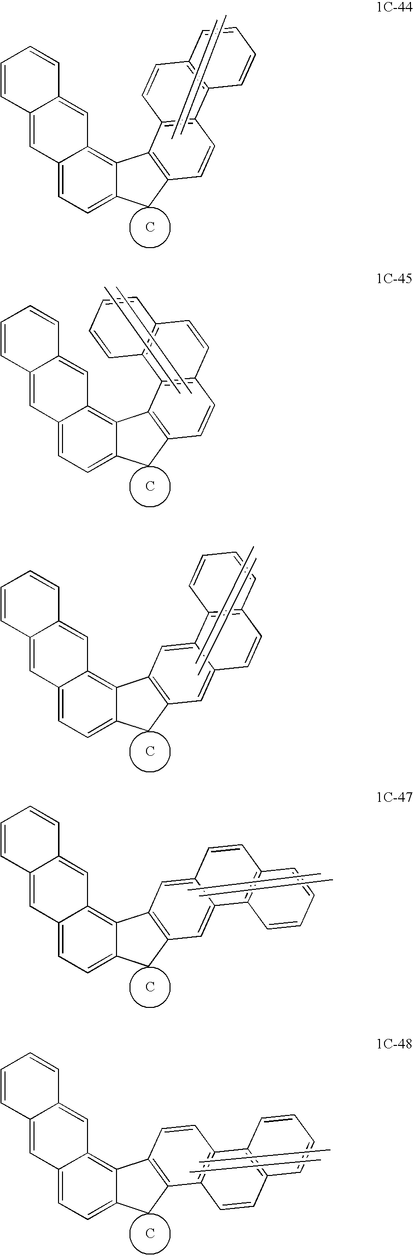

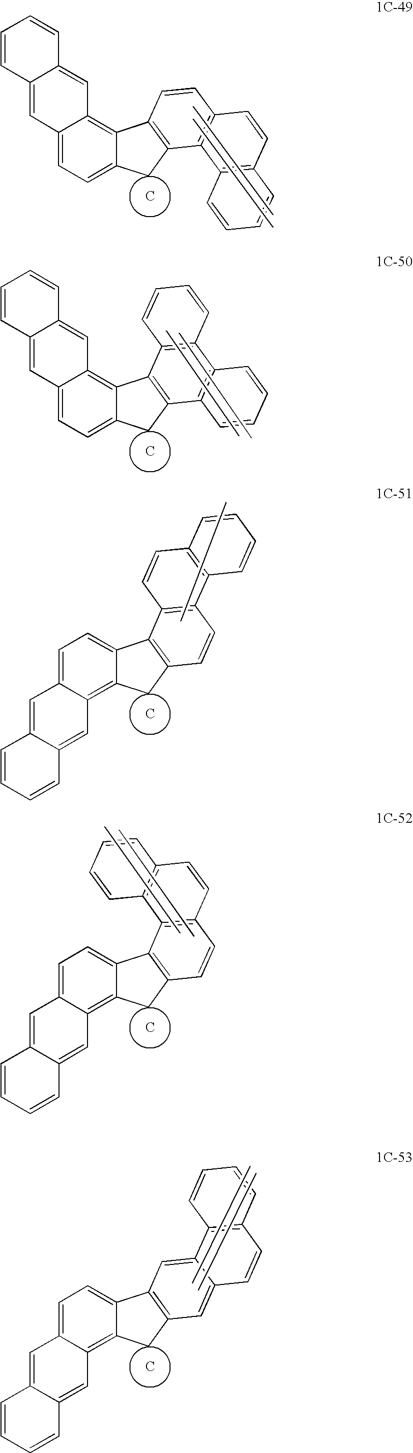

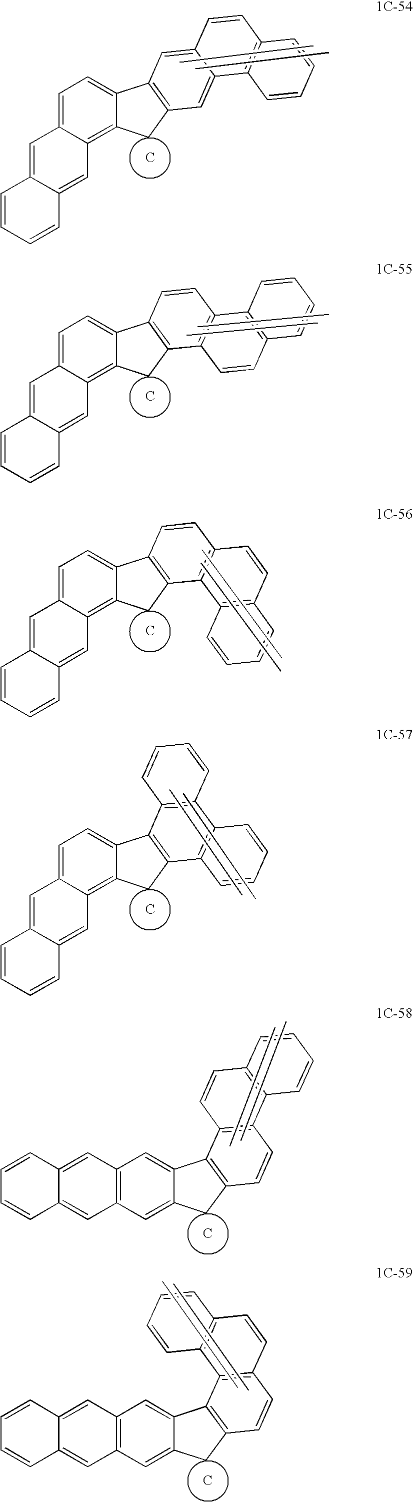

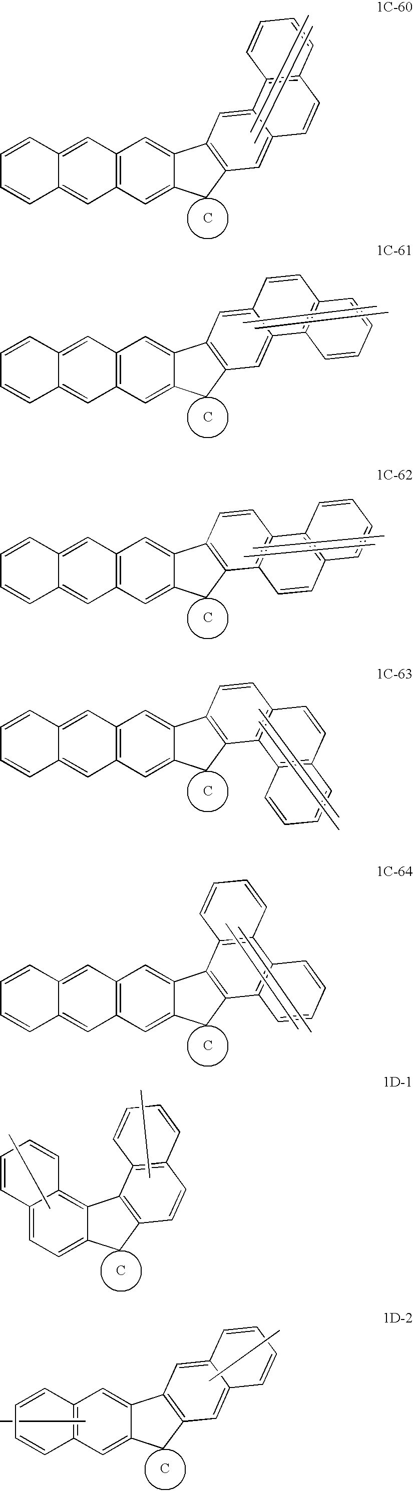

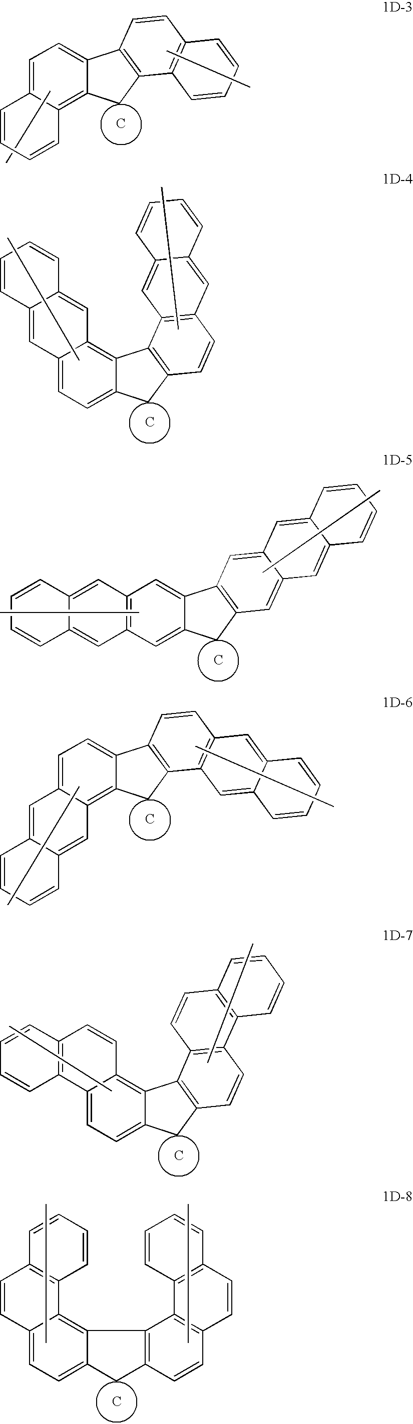

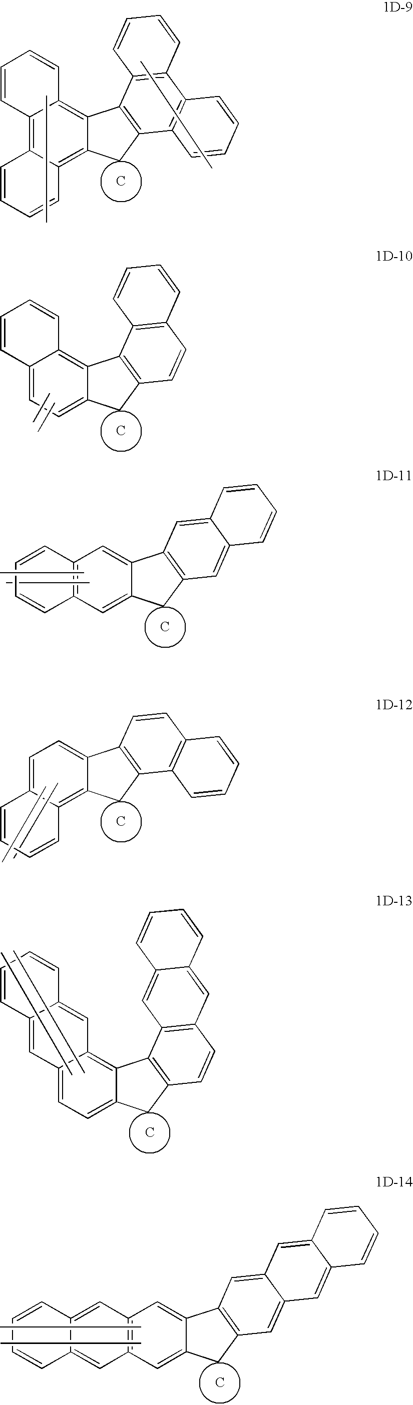

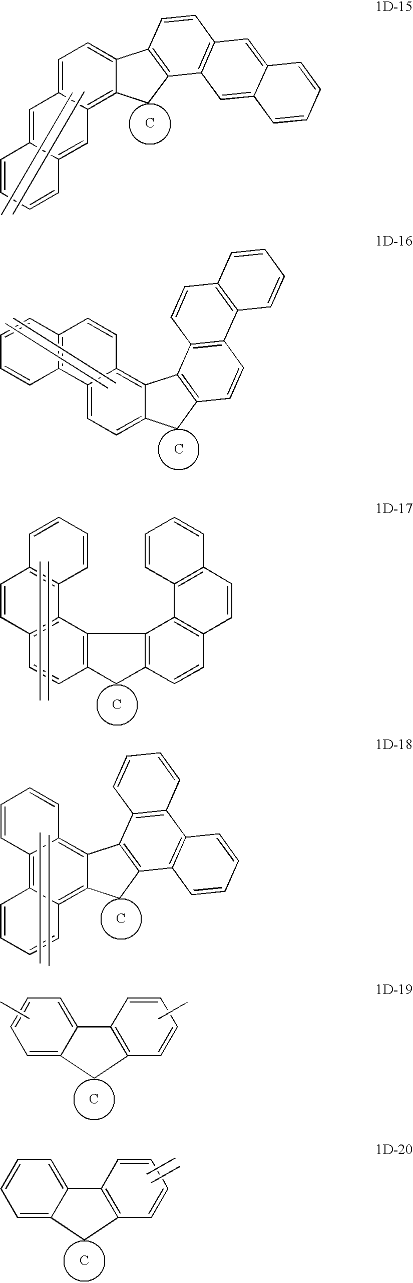

Specific examples of the structure of the above-described formula (1-B) include structures obtained by removing one connecting bond from the above-described structures (1A-1 to 1A-64, 1B-1 to 1B-64, 1C-1 to 1C-64, 1D-1 to 1D-20) and structures having a substituent on the above-described structures. Specific examples of the structure of the above-described formula (1-C) include structures obtained by adding one connecting bond to the above-described structures (1A-1 to 1A-64, 1B-1 to 1B-64, 1C-1 to 1C-64, 1D-1 to 1D-20) and structures having a substituent on the above-described structures.

In the structure of the above-described formula (1-A), preferable from the standpoint of heat resistance, fluorescence intensity and the like are those in which one connecting bond and another connecting bond are present on A ring and B ring respectively, and more preferable are those in which A ring and B ring are composed of a combination of benzene ring and naphthalene ring. In particular, structures of the following formulae (1-1), (1-2), (1-3) and (1-4) are preferable, and structures of the formulae (1-1) and (1-2) are more preferable.

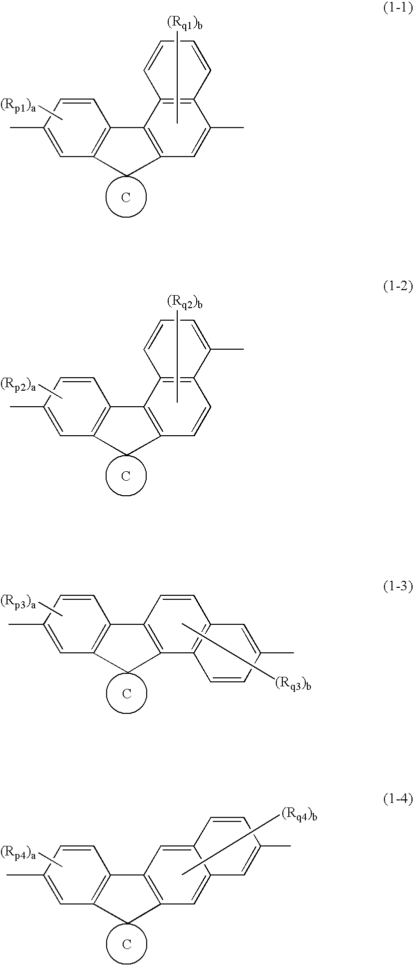

In the formulae, Rₚ₁, R_{q1}, Rₚ₂, R_{q2}, Rₚ₃, R_{q3}, Rₚ₄ and R_{q4} each independently represent a substituent. a represents an integer of 0 to 3, and b represents an integer of 0 to 5. When Rₚ₁, R_{q1}, Rₚ₂, R_{q2}, Rₚ₃, R_{q3}, Rₚ₄ and R_{q4} are present each in plural number, they may be the same or different.

When the aromatic hydrocarbon ring has a substituent, it is preferable, from the standpoint of solubility in organic solvents, device properties, easiness of synthesis, and the like, that the substituent is selected from alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups, nitro group and cyano group. Hydrogen atoms contained in these substituents may be replaced by a fluorine atom.

The alkyl group may be any of linear, branched or cyclic. The number of carbon atoms is usually about 1 to 20, preferably 3 to 20, and specific examples thereof include methyl group, ethyl group, propyl group, i-propyl group, butyl group, i-butyl group, t-butyl group, pentyl group, hexyl group, cyclohexyl group, heptyl group, octyl group, 2-ethylhexyl group, nonyl group, decyl group, 3,7-dimethyloctyl group, lauryl group, trifluoromethyl group, pentafluoroethyl group, perfluorobutyl group, perfluorohexyl group, perfluorooctyl group, etc.; and pentyl group, hexyl group, octyl group, 2-ethylhexyl group, decyl group, and 3,7-dimethyloctyl group are preferable.

The alkoxy group may be any of linear, branched or cyclic. The number of carbon atoms is usually about 1 to 20, preferably 3 to 20, and specific examples thereof include methoxy group, ethoxy group, propyloxy group, i-propyloxy group, butoxy group, i-butoxy group, t-butoxy group, pentyloxy group, hexyloxy group, cyclohexyloxy group, heptyloxy group, octyloxy group, 2-ethyl hexyloxy group, nonyloxy group, decyloxy group, 3,7-dimethyl octyloxy group, lauryloxy group, trifluoromethoxy group, pentafluoroethoxy group, perfluorobutoxy group, perfluorohexyloxy group, perfluorooctyloxy group, methoxymethyloxy group, 2-methoxyethyloxy group, etc.; and pentyloxy group, hexyloxy group, octyloxy group, 2-ethylhexyloxy group, decyloxy group, and 3,7-dimethyl octyloxy group are preferable.

The alkylthio group may be any of linear, branched or cyclic. The number of carbon atoms is usually about 1 to 20, preferably 3 to 20, and specific examples thereof include methylthio group, ethylthio group, propylthio group, i-propylthio group, butylthio group, i-butylthio group, t-butylthio group, pentylthio group, hexylthio group, cyclo hexylthio group, heptylthio group, octylthio group, 2-ethyl hexylthio group, nonylthio group, decylthio group, 3,7-dimethyloctylthio group, laurylthio group, trifluoromethylthio group, etc.; and pentylthio group, hexylthio group, octylthio group, 2-ethyl hexylthio group, decylthio group, and 3,7-dimethyloctylthio group are preferable.

The aryl group is an atomic group in which one hydrogen atom is removed from an aromatic hydrocarbon. The aromatic hydrocarbon includes those having a condensed ring, an independent benzene ring, or two or more condensed rings bonded through groups, such as a direct bond or a vinylene group.

The aryl group has usually about 6 to 60 carbon atoms, preferably 7 to 48, and specific examples thereof include phenyl group, C₁-C₁₂ alkoxyphenyl group (C₁-C₁₂ represents the number of carbon atoms 1-12. Hereafter the same), C₁-C₁₂ alkylphenyl group, 1-naphtyl group, 2-naphtyl group, 1-anthracenyl group, 2-anthracenyl group, 9-anthracenyl group, pentafluorophenyl group, etc., and in view of the solubility in an organic solvent, device characteristic, ease of synthesis, etc., C₁-C₁₂ alkoxyphenyl group and C₁-C₁₂ alkylphenyl group are preferable. Concretely, as C₁-C₁₂ alkoxy, methoxy, ethoxy, propyloxy, i-propyloxy, butoxy, i-butoxy, t-butoxy, pentyloxy, hexyloxy, cyclohexyl oxy, heptyloxy, octyloxy, 2-ethyl hexyloxy, nonyl oxy, decyloxy, 3,7-dimethyl octyloxy, lauryl oxy, etc. are exemplified.

Concrete examples of C₁-C₁₂ alkylphenyl group include methylphenyl group, ethylphenyl group, dimethylphenyl group, propylphenyl group, mesityl group, methylethylphenyl group, i-propylphenyl group, butylphenyl group, i-butylphenyl group, t-butylphenyl group, pentylphenyl group, isoamylphenyl group, hexylphenyl group, heptylphenyl group, octylphenyl group, nonylphenyl group, decylphenyl group, dodecylphenyl group, etc.

The aryloxy group has the number of carbon atoms of usually about 6 to 60, preferably 7 to 48, and concrete examples thereof include phenoxy group, C₁-C₁₂ alkoxyphenoxy group, C₁-C₁₂ alkyl phenoxy group, 1-naphtyloxy group, 2-naphtyloxy group, pentafluorophenyloxy group, etc.; and C₁-C₁₂ alkoxyphenoxy group and C₁-C₁₂ alkylphenoxy group are preferable.

As C₁-C₁₂ alkoxy, concretely, methoxy, ethoxy, propyloxy, i-propyloxy, butoxy, i-butoxy, t-butoxy, pentyloxy, hexyloxy, cyclohexyl oxy, heptyloxy, octyloxy, 2-ethyl hexyloxy, nonyl oxy, decyloxy, 3,7-dimethyl octyloxy, lauryl oxy, etc. are exemplified.

Concrete examples of C₁-C₁₂ alkylphenoxy group include methylphenoxy group, ethylphenoxy group, dimethylphenoxy group, propylphenoxy group, 1,3,5-trimethylphenoxy group, methylethylphenoxy group, i-propylphenoxy group, butyl phenoxy group, i-butylphenoxy group, t-butylphenoxy group, pentylphenoxy group, isoamylphenoxy group, hexylphenoxy group, heptylphenoxy group, octylphenoxy group, nonylphenoxy group, decylphenoxy group, dodecylphenoxy group, etc.

The arylthio group has the number of carbon atoms of usually about 6 to 60, preferably 7 to 48, and concrete examples thereof include phenylthio group, C₁-C₁₂ alkoxyphenylthio group, C₁-C₁₂ alkylphenylthio group, 1-naphthylthio group, 2-naphthylthio group, pentafluorophenylthio group, etc.; C₁-C₁₂ alkoxy phenylthio group and C₁-C₁₂ alkyl phenylthio group are preferable.

The arylalkyl group has the number of carbon atoms of usually about 7 to 60, preferably 7 to 48, and concrete examples thereof include phenyl-C₁-C₁₂alkyl group, C₁-C₁₂alkoxy phenyl-C₁-C₁₂ alkyl group, C₁-C₁₂ alkylphenyl-C₁-C₁₂ alkyl group, 1-naphtyl-C₁-C₁₂ alkyl group, 2-naphtyl-C₁-C₁₂ alkyl group etc.; and C₁-C₁₂ alkoxyphenyl-C₁-C₁₂ alkyl group and C₁-C₁₂ alkyl phenyl-C₁-C₁₂ alkyl group are preferable.

The arylalkoxy group has the number of carbon atoms of usually about 7 to 60, preferably 7 to 48, and concrete examples thereof include: phenyl-C₁-C₁₂alkoxy groups, such as phenylmethoxy group, phenylethoxy group, phenylbutoxy group, phenylpentyloxy group, phenylhexyloxy group, phenylheptyloxy group, and phenyloctyloxy group; C₁-C₁₂alkoxyphenyl-C₁-C₁₂ alkoxy group, C₁-C₁₂alkylphenyl-C₁-C₁₂alkoxy group, 1-naphtyl-C₁-C₁₂ alkoxy group, 2-naphtyl-C₁-C₁₂ alkoxy group etc.; and C₁-C₁₂ alkoxyphenyl-C₁-C₁₂ alkoxy group and C₁-C₁₂ alkylphenyl-C₁-C₁₂ alkoxy group are preferable.

The arylalkylthio group has the number of carbon atoms of usually about 7 to 60, preferably 7 to 48, and concrete examples thereof include: phenyl-C₁-C₁₂ alkylthio group, C₁-C₁₂ alkoxy phenyl-C₁-C₁₂ alkylthio group, C₁-C₁₂ alkylphenyl-C₁-C₁₂ alkylthio group, 1-naphtyl-C₁-C₁₂ alkylthio group, 2-naphtyl-C₁-C₁₂ alkylthio group, etc.; and C₁-C₁₂ alkoxy phenyl-C₁-C₁₂ alkylthio group and C₁-C₁₂ alkylphenyl-C₁-C₁₂ alkylthio group are preferable.

The arylalkenyl group has the number of carbon atoms of usually about 7 to 60, preferably 7 to 48, and concrete examples thereof include: phenyl-C₂-C₁₂ alkenyl group, C₁-C₁₂ alkoxy phenyl-C₂-C₁₂ alkenyl group, C₁-C₁₂ alkyl phenyl-C₂-C₁₂ alkenyl group, 1-naphtyl-C₂-C₁₂ alkenyl group, 2-naphtyl-C₂-C₁₂alkenyl group, etc.; and C₁-C₁₂ alkoxy phenyl-C₂-C₁₂alkenyl group, and C₂-C₁₂alkyl phenyl-C₁-C₁₂ alkenyl group are preferable.

The arylalkynyl group has the number of carbon atoms of usually about 7 to 60, preferably 7 to 48, and concrete examples thereof include: phenyl-C₂-C₁₂ alkynyl group, C₁-C₁₂ alkoxy phenyl-C₂-C₁₂ alkynyl group, C₁-C₁₂ alkylphenyl-C₂-C₁₂ alkynyl group, 1-naphtyl-C₂-C₁₂ alkynyl group, 2-naphtyl-C₂-C₁₂ alkynyl group, etc.; and C₁-C₁₂ alkoxyphenyl-C₂-C₁₂ alkynyl group, and C₁-C₁₂ alkylphenyl-C₂-C₁₂ alkynyl group are preferable.

The substituted amino group means a amino group substituted by 1 or 2 groups selected from an alkyl group, aryl group, arylalkyl group, or monovalent heterocyclic group, and said alkyl group, aryl group, arylalkyl group, or monovalent heterocyclic group may have substituent. The substituted amino groups has usually about 1 to 60, preferably 2 to 48 carbon atoms, without including the number of carbon atoms of said substituent.

Concrete examples thereof include methylamino group, dimethylamino group, ethylamino group, diethylamino group, propylamino group, dipropylamino group, i-propylamino group, diisopropylamino group, butylamino group, i-butyl amino group, t-butylamino group, pentylamino group, hexyl amino group, cyclohexylamino group, heptylamino group, octyl amino group, 2-ethylhexylamino group, nonylamino group, decyl amino group, 3,7-dimethyloctylamino group, laurylamino group, cyclopentylamino group, dicyclopentyl amino group, cyclohexyl amino group, dicyclohexylamino group, pyrrolidyl group, piperidyl group, ditrifluoromethylamino group, phenylamino group, diphenylamino group, C₁-C₁₂ alkoxyphenylamino group, di(C₁-C₁₂ alkoxyphenyl)amino group, di(C₁-C₁₂ alkylphenyl)amino group, 1-naphtylamino group, 2-naphtylamino group, pentafluorophenylamino group, pyridylamino group, pyridazinylamino group, pyrimidylamino group, pyrazylamino group, triazylamino group phenyl-C₁-C₁₂ alkylamino group, C₁-C₁₂ alkoxyphenyl-C₁-C₁₂alkylamino group, C₁-C₁₂ alkyl phenyl-C₁-C₁₂ alkylamino group, di(C₁-C₁₂ alkoxyphenyl-C₁-C₁₂ alkyl)amino group, di(C₁-C₁₂ alkylphenyl-C₁-C₁₂ alkyl)amino group, 1-naphtyl-C₁-C₁₂ alkylamino group, 2-naphtyl-C₁-C₁₂ alkylamino group, etc.

The substituted silyl group means a silyl group substituted by 1, 2 or 3 groups selected from an alkyl group, aryl group, arylalkyl group, or monovalent heterocyclic group. The substituted silyl group has usually about 1 to 60, preferably 3 to 48 carbon atoms. Said alkyl group, aryl group, arylalkyl group, or monovalent heterocyclic group may have substituent.

Concrete examples of the substituted silyl group include trimethylsilyl group, triethylsilyl group, tripropylsilyl group, tri-1-propylsilyl group, dimethyl-1-propylsilyl group, diethyl-1-propylsilyl group, t-butylsilyldimethylsilyl group, pentyldimethylsilyl group, hexyldimethylsilyl group, heptyl dimethylsilyl group, octyldimethylsilyl group, 2-ethyl hexyl-dimethylsilyl group, nonyldimethylsilyl group, decyl dimethylsilyl group, 3,7-dimethyloctyl-dimethylsilyl group, lauryldimethylsilyl group, phenyl-C₁-C₁₂ alkylsilyl group, C₁-C₁₂ alkoxyphenyl-C₁-C₁₂ alkylsilyl group, C₁-C₁₂ alkyl phenyl-C₁-C₁₂ alkylsilyl group, 1-naphtyl-C₁-C₁₂ alkylsilyl group, 2-naphtyl-C₁-C₁₂ alkylsilyl group, phenyl-C₁-C₁₂ alkyl dimethylsilyl group, triphenylsilyl group, tri-p-xylylsilyl group, tribenzylsilyl group, diphenylmethylsilyl group, t-butyldiphenylsilyl group, dimethylphenylsilyl group, etc.

As the halogen atom, a fluorine atom, a chlorine atom, a bromine atom, and an iodine atom are exemplified.

The acyl group has usually about 2 to 20 carbon atoms, preferably 2 to 18 carbon atoms, and concrete examples thereof include acetyl group, propionyl group, butyryl group, isobutyryl group, pivaloyl group, benzoyl group, trifluoroacetyl group, pentafluorobenzoyl group, etc.

The acyloxy group has usually about 2 to 20 carbon atoms, preferably 2 to 18 carbon atoms, and concrete examples thereof include acetoxy group, propionyloxy group, butyryloxy group, isobutyryloxy group, pivaloyloxy group, benzoyloxy group, trifluoroacetyloxy group, pentafluorobenzoyl oxy group, etc.

Imine residue is a residue in which a hydrogen atom is removed from an imine compound (an organic compound having —N═C— is in the molecule. Examples thereof include aldimine, ketimine, and compounds whose hydrogen atom on N is substituted with an alkyl group etc.), and usually has about 2 to 20 carbon atoms, preferably 2 to 18 carbon atoms. As the concrete examples, groups represented by below structural formulas are exemplified.

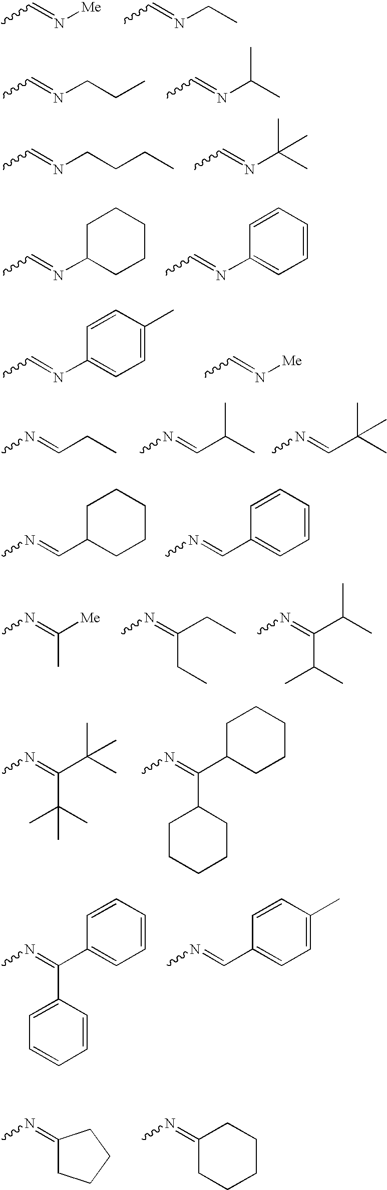

The amide group has usually about 2 to 20 carbon atoms, preferably 2 to 18 carbon atoms, and specific examples thereof include formamide group, acetamide group, propioamide group, butyroamide group, benzamide group, trifluoroacetamide group, pentafluoro benzamide group, diformamide group, diacetoamide group, dipropioamide group, dibutyroamide group, dibenzamide group, ditrifluoro acetamide group, dipentafluorobenzamide group, etc.

Examples of the acid imide group include residual groups in which a hydrogen atom connected with nitrogen atom is removed, and have usually about 2 to 60 carbon atoms, preferably 2 to 48 carbon atoms. As the concrete examples of acid imide group, the following groups are exemplified.

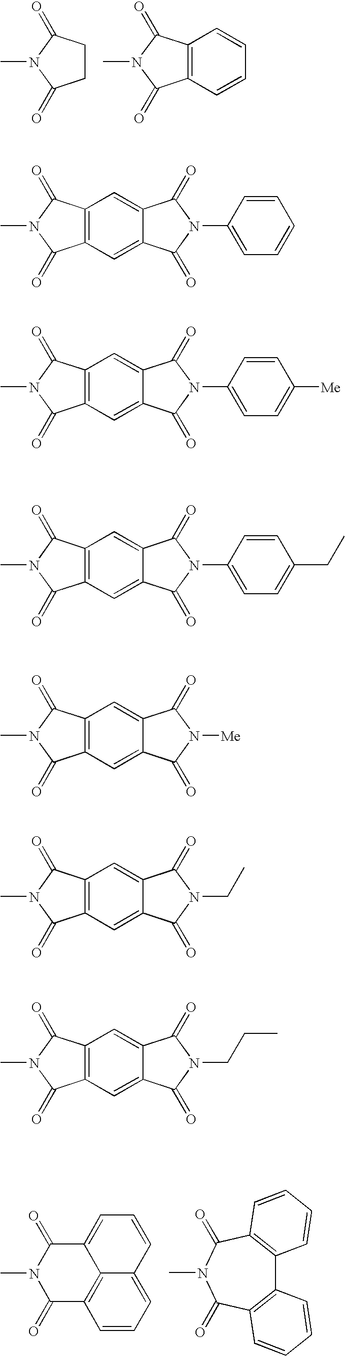

The monovalent heterocyclic group means an atomic group in which a hydrogen atom is removed from a heterocyclic compound, and the number of carbon atoms is usually about 4 to 60, preferably 4 to 20. The number of carbon atoms of the substituent is not contained in the number of carbon atoms of a heterocyclic group. The heterocyclic compound means an organic compound having a cyclic structure in which at least one heteroatom such as oxygen, sulfur, nitrogen, phosphorus, boron, etc. is contained in the cyclic structure as the element other than carbon atoms. Concrete examples thereof include thienyl group, C₁-C₁₂ alkylthienyl group, pyroryl group, furyl group, pyridyl group, C₁-C₁₂ alkylpyridyl group, piperidyl group, quinolyl group, isoquinolyl group, etc.; and thienyl group, C₁-C₁₂ alkylthienyl group, pyridyl group, and C₁-C₁₂ alkylpyridyl group are preferable.

As the substituted carboxyl group, mentioned are carboxyl groups substituted with an alkyl group, aryl group, arylalkyl group or monovalent heterocyclic group, the carbon number thereof is usually about 2 to 60, preferably 2 to 48, and specific examples thereof include a methoxycarbonyl group, ethoxycarbonyl group, propoxycarbonyl group, i-propoxycarbonyl group, butoxycarbonyl group, i-butoxycarbonyl group, t-butoxycarbonyl group, pentyloxycarbonyl group, hexyloxycarbonyl group, cyclohexyloxycarbonyl group, heptyloxycarbonyl group, octyloxycarbonyl group, 2-ethylhexyloxycarbonyl group, nonyloxycarbonyl group, decyloxycarbonyl group, 3,7-dimethyoctyloxycarbonyl group, dodecyloxycarbonyl group, trifluoromethoxycarbonyl group, pentafluoroethoxycarbonyl group, perfluorobutoxycarbonyl group, perfluorohexyloxycarbonyl group, perfluorooctyloxycarbonyl group, phenoxycarbonyl group, naphthoxycarbonyl group, pyridyloxycarbonyl group and the like. The alkyl group, aryl group, arylalkyl group or monovalent heterocyclic group may have a substituent. The carbon number of the substituted carboxyl group does not include the carbon number of the substituent.

From the standpoint of increase in molecular weight and from the standpoint of improvement in heat resistance, it is preferable that the aromatic hydrocarbon ring has no substituent.

Since the aromatic hydrocarbon ring has a substituent such as an alkyl group or the like, the chemical stability of a polymer compound can be enhanced. When an atom near a connecting bond has a substituent, the reaction is sterically suppressed in polymerization in some cases, thus, it is preferable that substitution occurs at a position remote from a connecting bond by two or more aromatic carbon atoms.

From the standpoint of balance between chemical stability and little influence to suppress a polymerization reaction, it is preferable that a=0 and b=1 in the structure of the above-described formula (1-1), (1-2), (1-3) or (1-4), more preferable is a structure of the following formula (1-1-1) or (1-1-2), and it is more preferable that R_{q1} is an alkyl group.

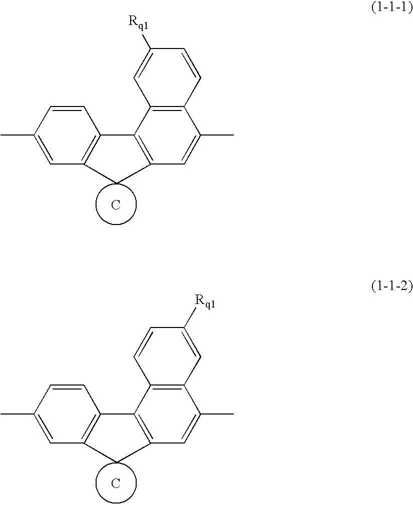

(wherein, C represents the same meaning as described above).

Here, the alkyl group R_{q1} has a carbon number of usually 1 to 30, preferably 3 to 30. As the kind of the alkyl group, there are mentioned linear alkyl groups such as a methyl group, ethyl group, propyl group, butyl group, hexyl group, heptyl group, octyl group, nonyl group, decyl group, lauryl group, trifluoromethyl group, pentafluoroethyl group, perfluorobutyl group, perfluorohexyl group, perfluorooctyl group and the like, branched alkyl groups such as an i-propyl group, i-butyl group, t-butyl group, pentyl group, isoamyl group, 2-ethylhexyl group, 3,7-dimethyloctyl group, 1,1-dimethylpropyl group and the like, and alkyl groups having a cyclic structure such as a 1-adamantyl group, 1-adamantylmethyl group, 2-adamantyl group, neopentyl group, cyclopentyl group, cyclopentylmethyl group, cyclohexyl group, cyclohexylmethyl group, cyclohexylethyl group, cyclooctyl group, cyclododecyl group, cyclopentadecyl group, cyclopentylmethyl group and the like.

Among alkyl groups, alkyl groups having a branched structure or cyclic structure are preferable, alkyl groups having a cyclic structure are more preferable, and further preferable is a 1-adamantyl group or 2-adamantyl group, from the standpoint of chemical stability.

In the above-described formula (1), C ring represents an alicyclic hydrocarbon ring having at least one substituent. The alicyclic hydrocarbon ring may contain a hetero atom. As the hetero atom, there are mentioned nitrogen, oxygen, sulfur, boron, silicon, phosphorus, selenium and the like. Here, the alicyclic hydrocarbon ring means a hydrocarbon ring not containing a condensed aromatic ring, and includes also a case of single ring and a case of polycyclic ring. The polycyclic ring includes also those connected to spiro, in addition to those obtained by mutual condensation of single rings. Since C ring has at least one substituent in the alicyclic hydrocarbon ring, device properties such as solubility, luminance half-lifetime and the like are excellent in addition to heat resistance.

As the structure of C ring, preferable are cyclopropane, cyclobutane, cyclopentane, cyclohexane, cycloheptane, cyclooctane, cyclononane, cyclodecane, cycloundecane, cyclododecane, cyclotridecane, cyclotetradecane, cyclopentadecane, cyclohexadecane, cycloheptadecane, cyclooctadecane, cyclononadecane, bicyclo ring, cyclohexene ring, cyclohexadiene ring, cycloheptene ring, cyclohexadecene ring, cyclooctatriene ring and the like, and more preferable are cyclopropane, cyclobutane, cyclopentane, cyclohexane, cycloheptane and cyclooctane, from the standpoint of easiness of synthesis and the like.

Carbon atoms in the alicyclic hydrocarbon C ring may be replaced by a hetero atom. The hetero atom is, from the standpoint of easiness of synthesis and device properties and the like, preferably nitrogen, oxygen, sulfur, silicon, boron, phosphorus or selenium, more preferably nitrogen, oxygen, sulfur or silicon. The number of carbon atoms to be substituted is preferably two or less.

Specific examples thereof include a tetrahydrofuran ring, tetrahydrothiophene ring, tetrahydroindole ring, tetrahydropyran ring, tetrahydropyridine ring, tetrahydrothiopyran ring, tetrahydroquinoline ring, tetrahydroisoquinoline ring, crown ethers and the like.

As specific examples of C ring (represented as a structure of the above-described formula (1)), mentioned are structures obtained by connecting at least one substituent to an alicyclic hydrocarbon corresponding to C ring of the following structures.

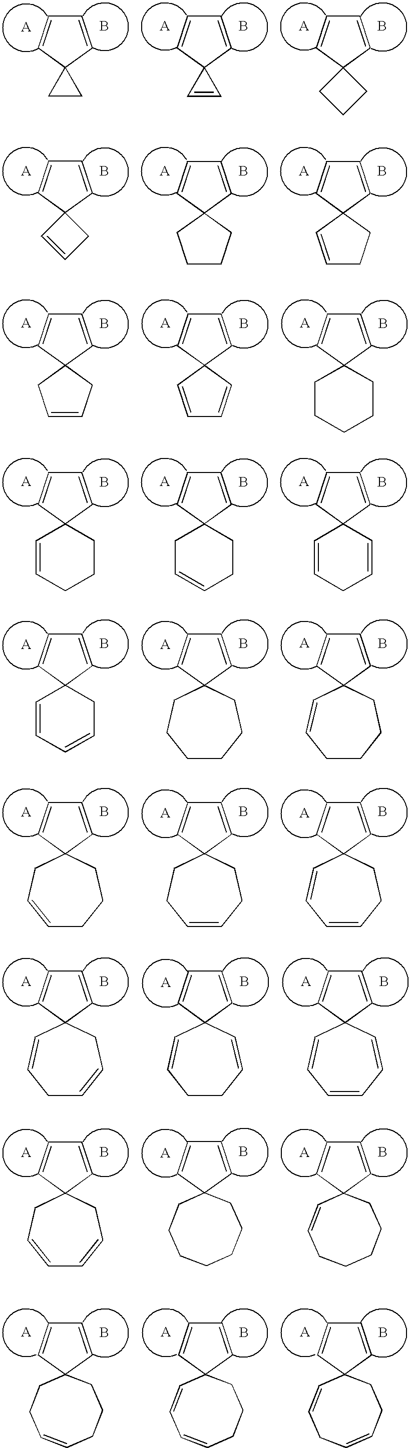

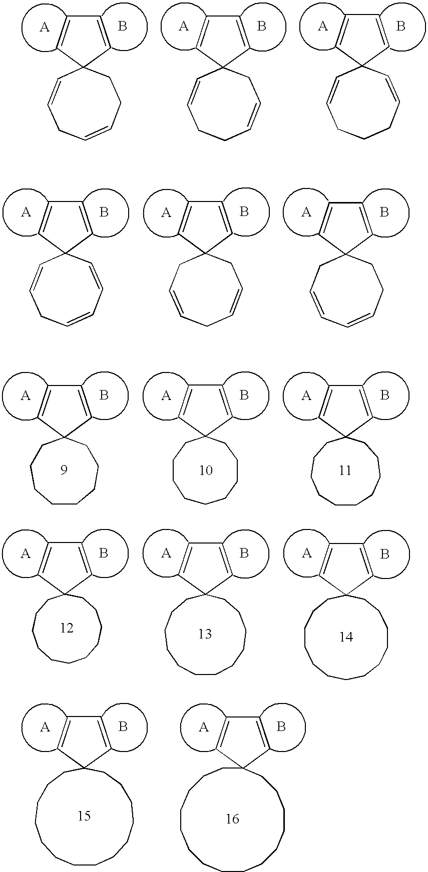

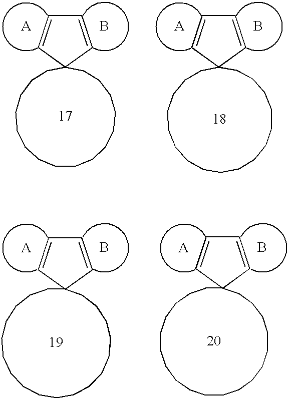

In the above descriptions, numerical character in C ring represents the number of carbon atoms constituting the ring of C ring. For example, when the numerical character is 9, C ring is a cyclononane ring.

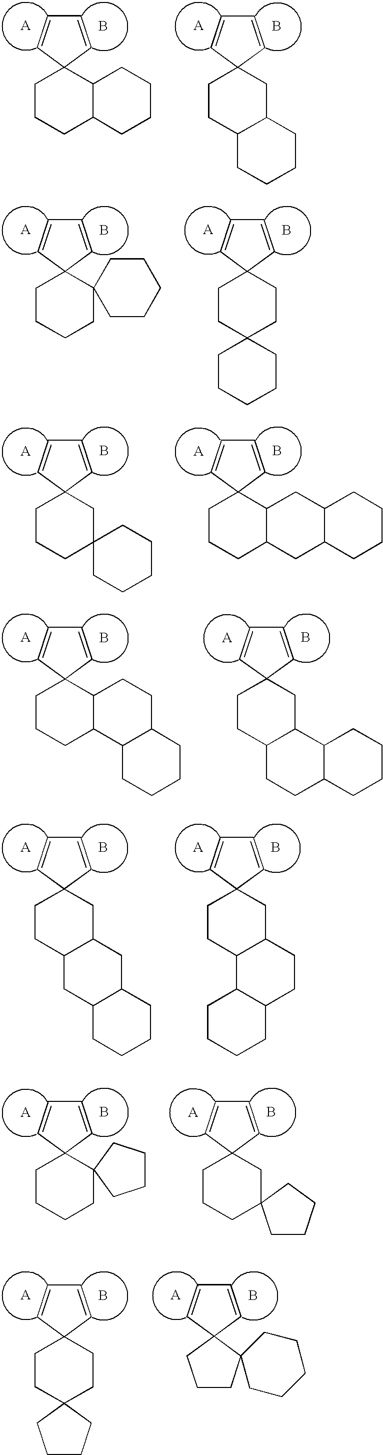

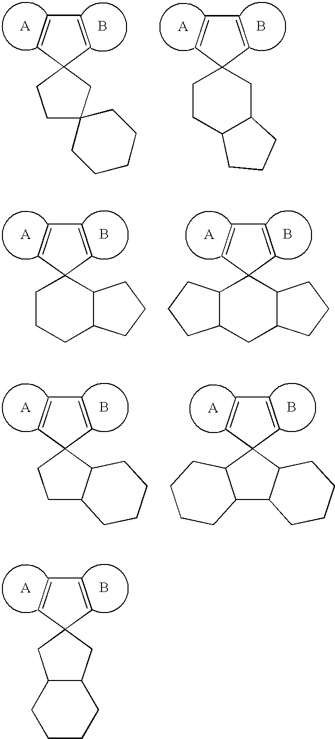

In the formulae, A ring and B ring represent the same meanings as described above. At least one substituent is connected to a portion of C ring. Carbon atoms in C ring may be replaced by a hetero ring.

As the substituent on C ring, exemplified are alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, silyl group, halogen atoms, acyl groups, acyloxy groups, amide groups, monovalent heterocyclic groups, carboxyl group, nitro group and cyano group, and preferable, from the standpoint of solubility, device properties, easiness of synthesis and the like, are alkyl groups, alkoxy groups, alkylthio groups, amino group, silyl group, nitro group, cyano group and halogen atoms, further preferable are alkyl groups, alkoxy group, alkylthio groups and halogen atoms, and further preferable are alkyl groups. From the standpoint of solubility, it is preferable that C ring contains no structure showing an aromatic property.

Here, exemplified as the alkyl group are the same groups as the alkyl groups on A ring and B ring, and preferable are a methyl group, ethyl group, propyl group, i-propyl group, butyl group, i-butyl group, t-butyl group, pentyl group, isoamyl group, hexyl group, cyclohexyl group, heptyl group, octyl group and the like from the standpoint of solubility, easiness of synthesis and the like.

As the alkoxy group, the above-mentioned groups are exemplified, and preferable from the standpoint of solubility, easiness of synthesis and the like are a methylthio group, ethylthio group, propylthio group, i-propylthio group, butylthio group, i-butylthio group, t-butylthio group, pentylthio group, hexylthio group, cyclohexylthio group, heptylthio group and octylthio group.

As the arylthio group, the above-mentioned groups are exemplified, and preferable from the standpoint of solubility, easiness of synthesis and the like are a methylthio group, ethylthio group, propylthio group, i-propylthio group, butylthio group, i-butylthio group, t-butylthio group, pentylthio group, hexylthio group, cyclohexylthio group, heptylthio group and octylthio group.

As the aryl group, mentioned are a phenyl group, C₁-C₁₂ alkoxyphenyl groups and C₁-C₁₂ alkylphenyl groups. As specific examples of the C₁-C₁₂ alkoxyphenyl groups and C₁-C₁₂ alkylphenyl groups, the above-mentioned groups are exemplified.

As the aryloxy group, mentioned are a phenoxy group, C₁-C₁₂ alkoxyphenoxy groups and C₁-C₁₂ alkylphenoxy groups. As specific examples of the C₁-C₁₂ alkoxyphenoxy groups and C₁-C₁₂ alkylphenoxy groups, the above-mentioned groups are exemplified.

As the arylthio group, mentioned are a phenylthio group, C₁-C₁₂ alkoxyphenylthio groups and C₁-C₁₂ alkylphenylthio groups.

As the arylalkyl group, mentioned are phenyl-C₁-C₁₂ alkyl groups, C₁-C₁₂ alkoxyphenyl-C₁-C₁₂ alkyl groups and C₁-C₁₂ alkylphenyl-C₁-C₁₂ alkyl groups.

As the arylalkoxy group, mentioned are phenyl-C₁-C₁₂ alkoxy groups, C₁-C₁₂ alkoxyphenyl-C₁-C₁₂ alkoxy groups and C₁-C₁₂ alkylphenyl-C₁-C₁₂ alkoxy groups.

As the arylalkylthio group, mentioned are phenyl-C₁-C₁₂ alkylthio groups, C₁-C₁₂ alkoxyphenyl-C₁-C₁₂ alkylthio groups and C₁-C₁₂ alkylphenyl-C₁-C₁₂ alkylthio groups.

As the arylalkenyl group, mentioned are phenyl-C₂-C₁₂ alkenyl groups, C₁-C₁₂ alkoxyphenyl-C₂-C₁₂ alkenyl groups and C₁-C₁₂ alkylphenyl-C₂-C₁₂ alkenyl groups.

As the arylalkynyl group, mentioned are phenyl-C₂-C₁₂ alkynyl groups, C₁-C₁₂ alkoxyphenyl-C₂-C₁₂ alkynyl groups and C₁-C₁₂ alkylphenyl-C₂-C₁₂ alkynyl groups.

As the monovalent heterocyclic group, mentioned are a thienyl group, C₁-C₁₂ alkylthienyl groups, pyrrolyl group, furyl group, pyridyl group and C₁-C₁₂ alkylpyridyl groups.

As the halogen atom, acyl group, acyloxy group and amide group, the above-described groups are exemplified.

From the standpoint of solubility, device properties and the like of the polymer compound, the sum of carbon numbers of all substituents on C ring is preferably 2 or more, more preferably 3 or more, further preferably 4 or more.

From the standpoint of solubility, device properties and the like of the polymer compound, it is preferable that a substituent is connected to at least one of atoms on C ring adjacent to a carbon atom (spiro atom) shared by a 5-membered ring to which A ring and B ring are condensed and by C ring, and this substituent has at least one carbon atom. As the atoms on C ring adjacent to a carbon atom shared by a 5-membered ring to which A ring and B ring are condensed and by C ring, for example, atoms denoted by * marks in the following structure are mentioned when C ring is a cyclohexyl ring.

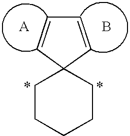

From the standpoint of solubility, easiness of synthesis and the like of the polymer compound, it is preferable that the atoms on C ring adjacent to a spiro atom are a carbon atom, silicon atom or nitrogen atom, it is preferable that at least one of the atoms is a carbon atom, and it is more preferable both of the atoms are carbon atoms.

From the standpoint of solubility, device properties and the like of the polymer compound, the sum of numbers of substituents on two atoms of C ring adjacent to a spiro atom is preferably 2 to 4, more preferably 3 to 4, further preferably 4. It is preferable that two atoms of C ring adjacent to a spiro atom have each at least one substituent. Specifically, when C ring is a cyclohexane ring, preferable among the following structures (1E-1 to 1E-5) are structures of (1E-2) to (1E-5), and more preferable are structures of (1E-3) to (1E-5), further preferable are structures of (1E-4) to (1E-5), furthermore preferable is a structure of (1E-5). In the following structures, Rₛₚ represents a substituent. It is applicable even if C ring is a cycloalkane ring other than a cyclohexane ring.

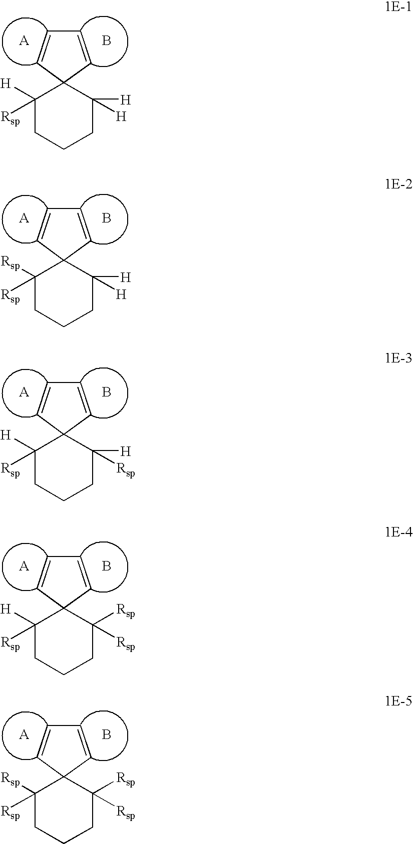

From the standpoint of solubility, device properties, easiness of synthesis and the like of the polymer compound, the substituent on atoms of C ring adjacent to a spiro atom is preferably an alkyl group, more preferably an alkyl group having 1 to 20 carbon atoms, further preferably a methyl group, ethyl group, n-propyl group, n-butyl group, n-pentyl group, n-hexyl group, n-heptyl group, n-octyl group, n-nonyl group or n-decyl group.

Of the polymer compounds of the present invention, the polymer compound composed of a repeating unit of the above-described formula (1-A) means a polymer compound composed substantially only of a repeating unit of the above-described formula (1-A) as a repeating unit, and this polymer compound may contain structures attributable to impurities contained in raw material monomers. This is applicable also to “composed of a repeating unit of (1-1), (1-2), (1-3) and (1-4)”, and the like. Among polymer compounds composed of a repeating unit of the above-described formula (1-A), preferable are polymer compounds composed of a repeating unit of the above-described formula (1-1), (1-2), (1-3), (1-4), more preferable are polymer compounds composed of a repeating unit of (1-1), (1-2), and further preferable are polymer compounds composed of a repeating unit of (1-1), from the standpoint of heat resistance, fluorescence intensity and the like.

Among the polymer compounds of the present invention, mentioned as the polymer compound composed of two repeating units of the above-described formula (1-A) are copolymers composed of two repeating units in which ring structures excepting C ring and substituents on the repeating units are identical and any one of the presence or absence of a substituent on an aromatic ring, the kind of a substituent and the kind of C ring varies (the two repeating units are called repeating units (a) and (b)). This copolymer can be excellent in solubility in organic solvents as compared with homopolymers composed only of a repeating unit (a) and homopolymers composed only of a repeating unit (b). Specifically, there are mentioned copolymers composed of two structures selected from the above-described formula (1-1), copolymers composed of two structures selected from the above-described formula (1-2), copolymers composed of two structures selected from the above-described formula (1-3), copolymers composed of two structures selected from the above-described formula (1-4), and the like. Among polymer compounds composed of two repeating units of the above-described formula (1-A), preferable are polymer compounds composed of two repeating units of the above-described formula (1-1), (1-2), (1-3), (1-4), more preferable are polymer compounds composed of two repeating units of (1-1), (1-2), further preferable are polymer compounds composed of two repeating units of (1-1), from the standpoint of heat resistance, fluorescence intensity and the like.

Particularly, preferable as (a)(b) from the standpoint of easiness for controlling reactivity in production of a polymer compound are copolymers in which an aromatic ring carries no substituent or substituents on an aromatic ring are identical and the kinds of C rings are different.

As the polymer compound of the present invention, preferable are copolymers having a repeating unit (1-A) and containing at least one repeating unit other than the repeating unit (1-A) from the standpoint of changing of light emitting wavelength, from the standpoint of enhancement of light emitting efficiency, from the standpoint of improvement of heat resistance, and the like. As the repeating unit other than the repeating unit (1-A), preferable are repeating units of the following formula (3), (4), (5) or (6).

—Ar₁— (3)

—(Ar₂—X₁)_{ff}—Ar₃— (4)

—Ar₄—X₂— (5)

—X₃— (6)

In the formulae, Ar₁, Ar₂, Ar₃ and Ar₄ each independently represent an arylene group, divalent heterocyclic group or divalent group having a metal complex structure. X₁, X₂ and X₃ each independently represent —CR₉═CR₁₀—, —C≡C—, —N(R₁₁)— or —(SiR₁₂R₁₃)ₘ—. R₉ and R₁₀ each independently represent a hydrogen atom, alkyl group, aryl group, monovalent heterocyclic group, carboxyl group, substituted carboxyl group or cyano group. R₁₁, R₁₂ and R₁₃ each independently represent a hydrogen atom, alkyl group, aryl group, monovalent heterocyclic group, arylalkyl group or substituted amino group. ff represents 1 or 2. m represents an integer of 1 to 12. When R₉, R₁₀, R₁₁, R₁₂ and R₁₃ are present each in plural number, they each may be the same or different.

Here, the arylene group is an atom group obtained by removing two hydrogen atoms from an aromatic hydrocarbon, and includes also those having a condensed ring and those in which two or more independent benzene rings or condensed rings are connected directly or via a group such as vinylene and the like. The arylene group may have a substituent.

Mentioned as the substituent are alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups and cyano group.

The number of carbon atoms in a portion obtained by removing substituents on the arylene group is usually about 6 to 60, preferably 6 to 20. The total number of carbon atoms including carbon atoms in substituents on the arylene group is usually about 6 to 100.

Examples of the arylene group include phenylene group (for example, following formulas 1-3), naphthalenediyl group (following formulas 4-13), anthracenylene group (following formulas 14-19), biphenylene group (following formulas 20-25), terphenyl-diyl group (following formulas 26-28), condensed ring compound group (following formulas 29-35), fluorene-diyl group (following formulas 36-38), stilbene-diyl (following formulas A-D), distilbene-diyl (following formulas E,F), etc. Among them, phenylene group, biphenylene group, and stilbene-diyl group are preferable.

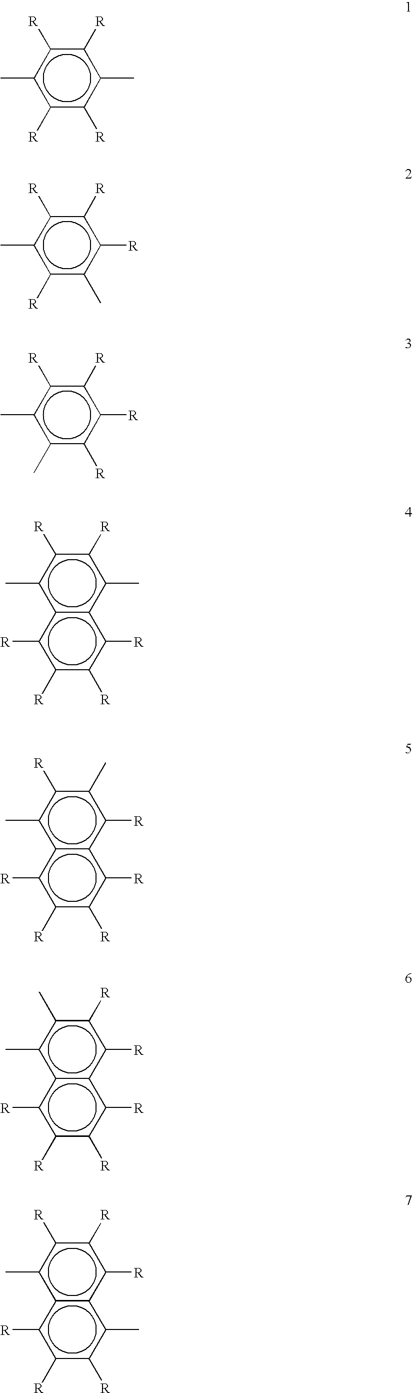

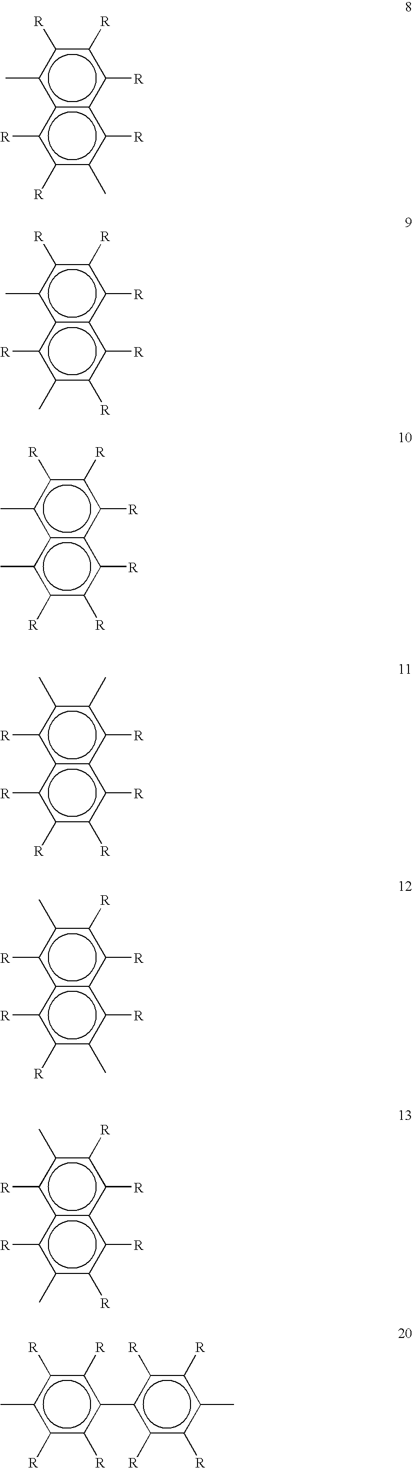

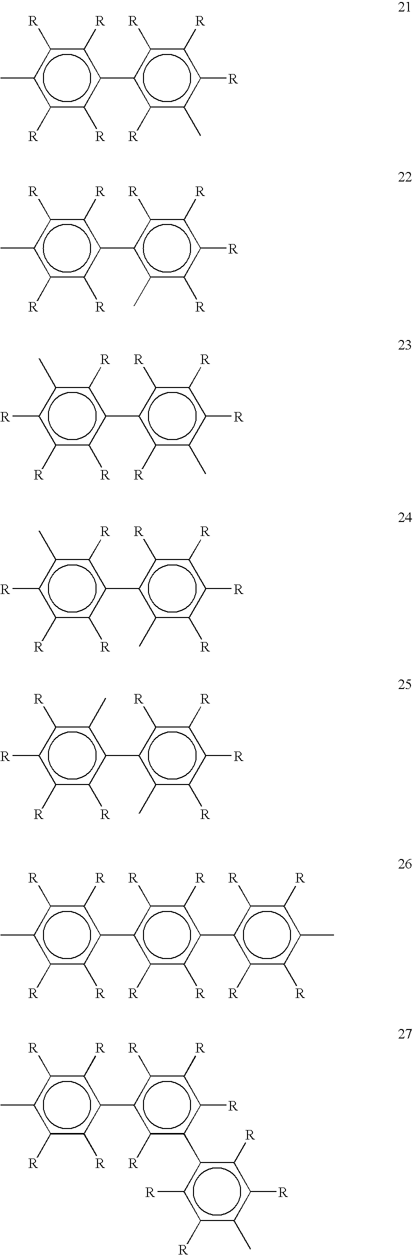

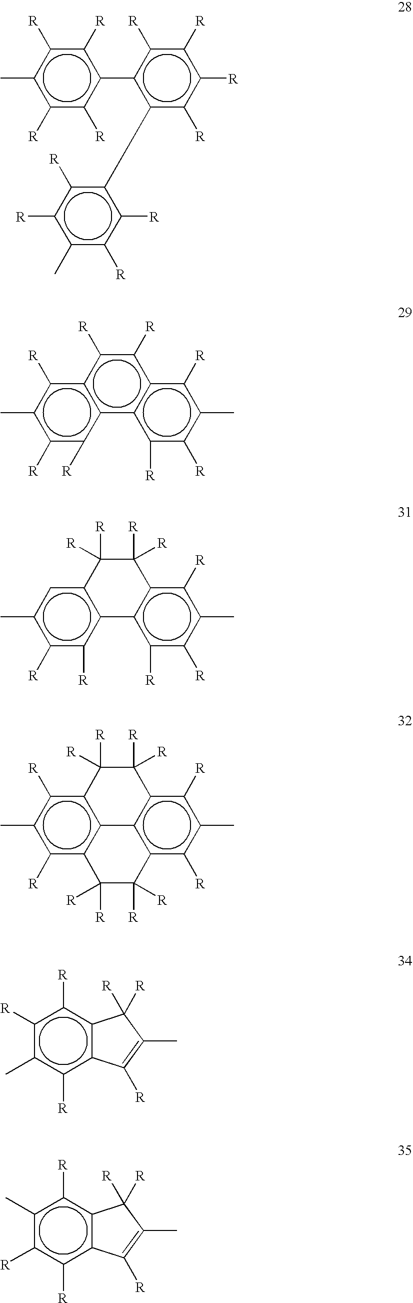

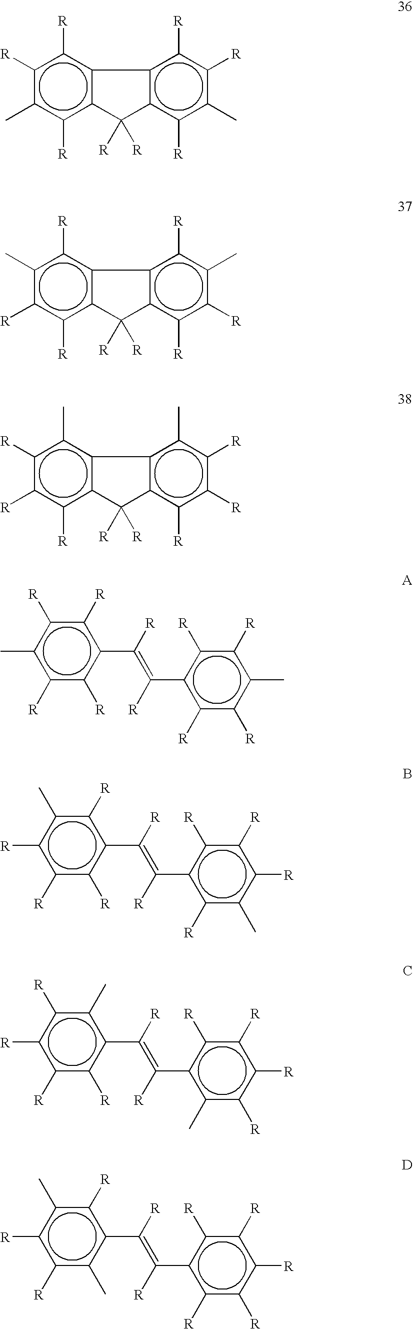

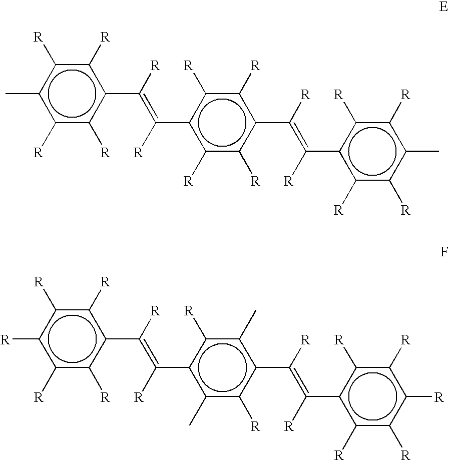

The divalent heterocyclic group represented by Ar₁, Ar₂, Ar₃ and Ar₄ means an atom group remaining after removal of two hydrogen atoms from a heterocyclic compound.

The heterocyclic compound means an organic compound having a cyclic structure in which at least one heteroatom such as oxygen, sulfur, nitrogen, phosphorus, boron, etc. is contained in the cyclic structure as the element other than carbon atoms.

Mentioned as the substituent are alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups and cyano group

The number of carbon atoms in a portion obtained by removing substituents on the divalent heterocyclic group is usually about 3 to 60. The total number of carbon atoms including carbon atoms in substituents on the divalent heterocyclic group is usually about 3 to 100.

Examples of the divalent heterocyclic groups include the followings.

Divalent heterocyclic groups containing nitrogen as a hetero atom; pyridine-diyl group (following formulas 39-44), diaza phenylene group (following formulas 45-48), quinolinediyl group (following formulas 49-63), quinoxalinediyl group (following formulas 64-68), acridinediyl group (following formulas 69-72), bipyridyldiyl group (following formulas 73-75), phenanthrolinediyl group (following formulas 76-78), etc.

Groups having a fluorene structure containing silicon, nitrogen, selenium, etc. as a hetero atom (following formulas 79-93).

5 membered heterocyclic groups containing silicon, nitrogen, sulfur, selenium, etc. as a hetero atom: (following formulas 94-98).

Condensed 5 membered heterocyclic groups containing silicon, nitrogen, selenium, etc. as a hetero atom: (following formulas 99-110),

5 membered heterocyclic groups containing silicon, nitrogen, sulfur, selenium, etc. as a hetero atom, which are connected at the a position of the hetero atom to form a dimer or an oligomer (following formulas 111-112);

5 membered ring heterocyclic groups containing silicon, nitrogen, sulfur, selenium, as a hetero atom is connected with a phenyl group at the a position of the hetero atom (following formulas 113-119); and

Groups of 5 membered ring heterocyclic groups containing nitrogen, oxygen, sulfur, as a hetero atom ono which a phenyl group, furyl group, or thienyl group is substituted (following formulas 120-125).

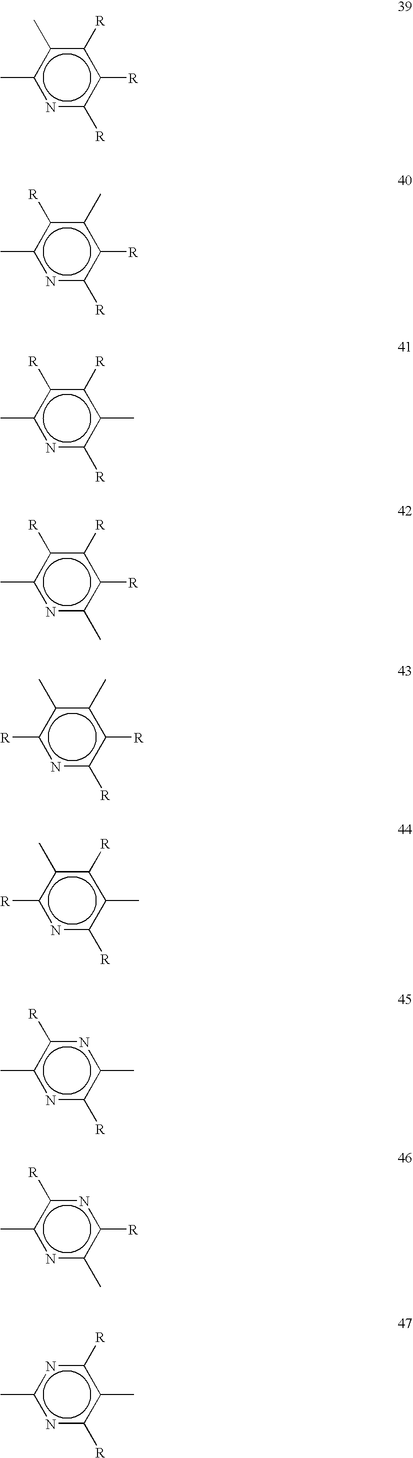

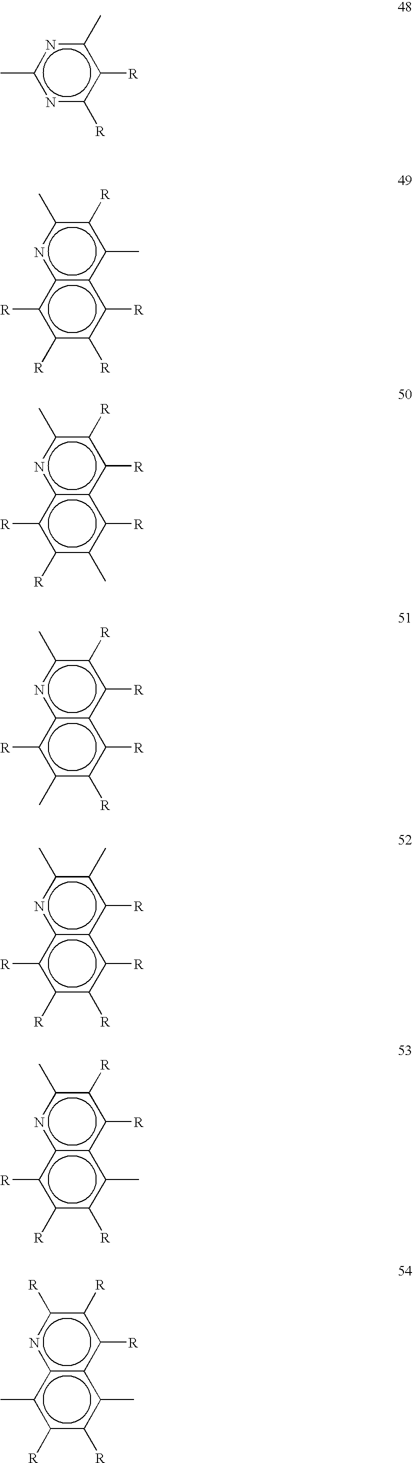

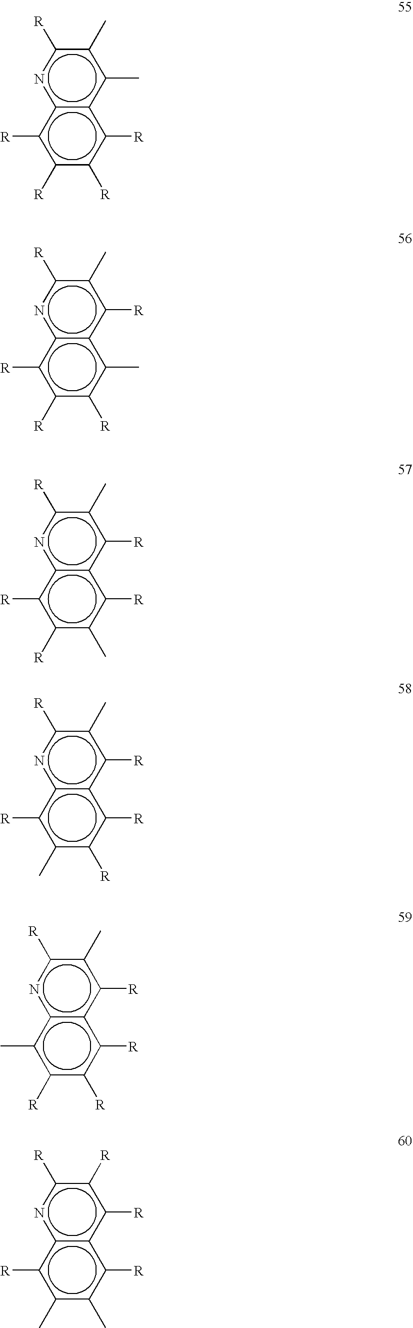

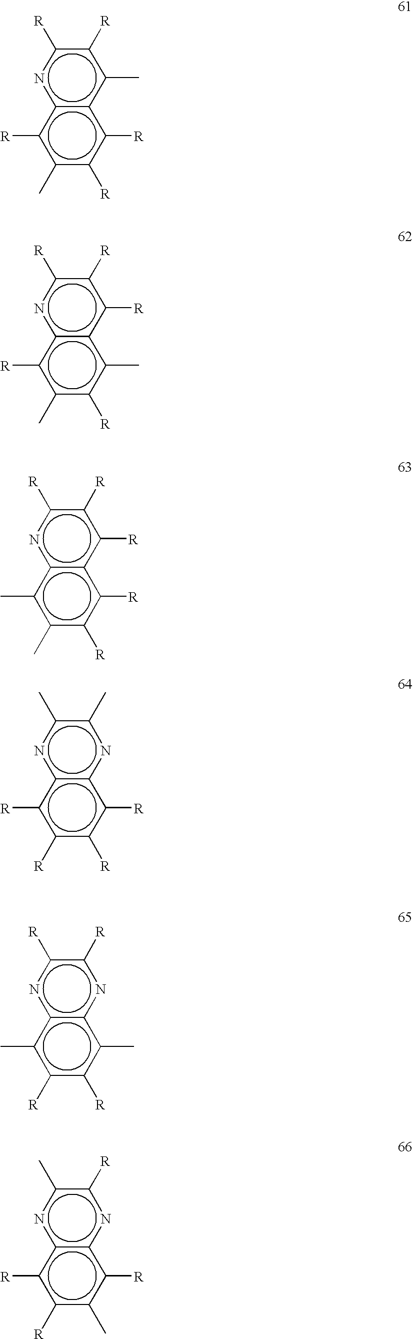

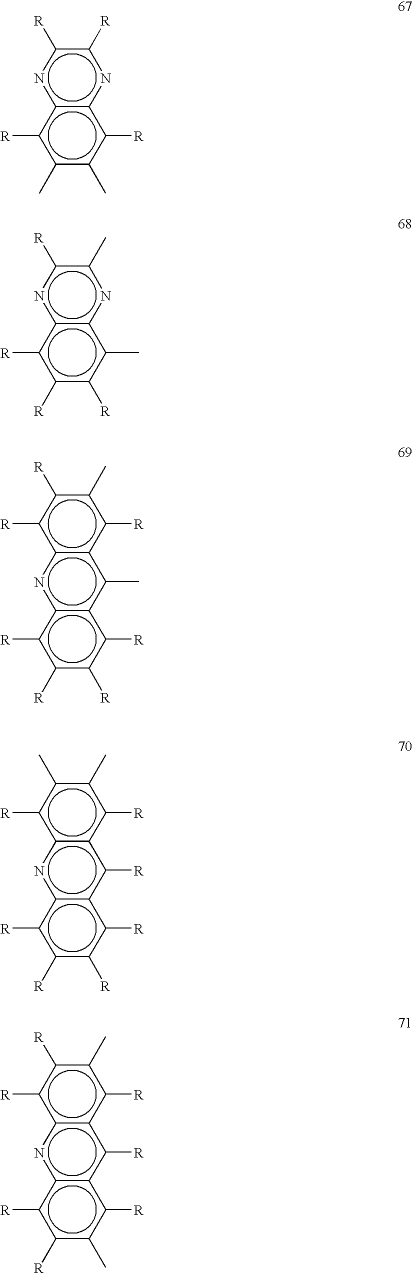

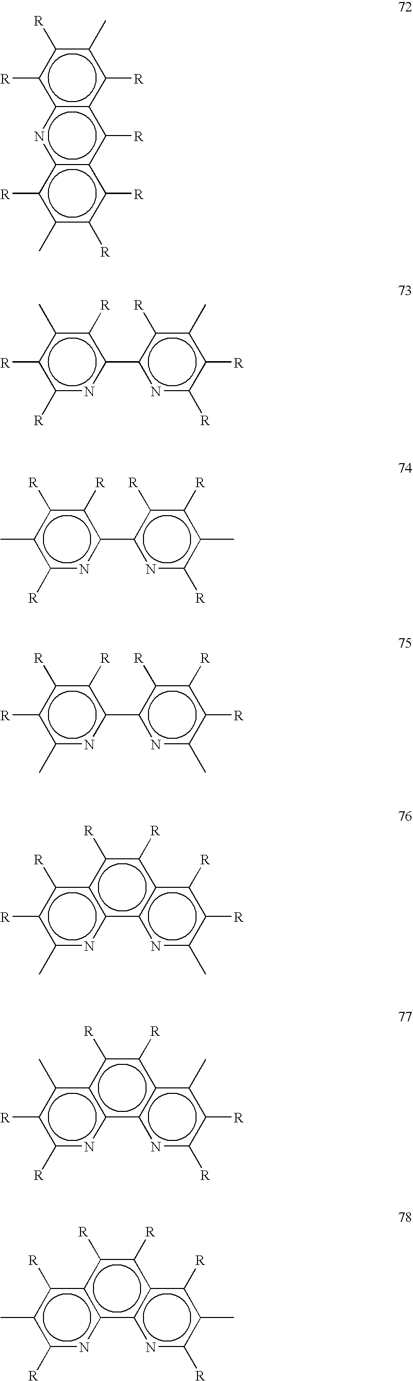

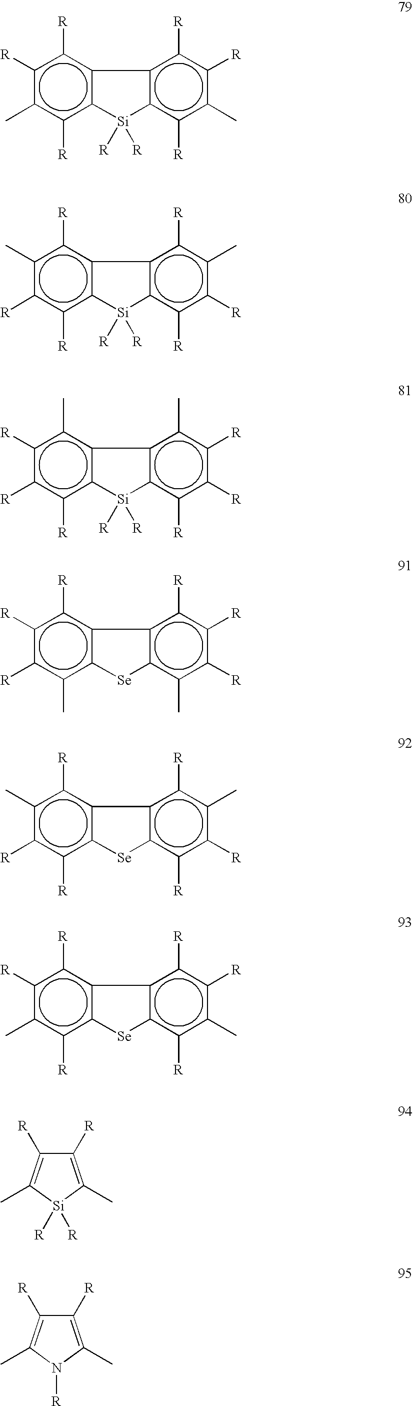

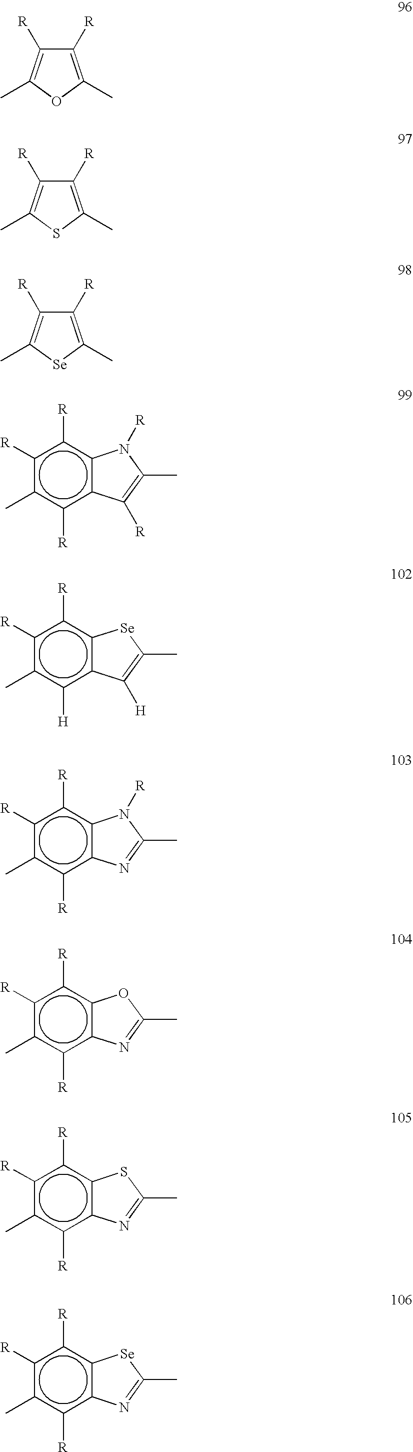

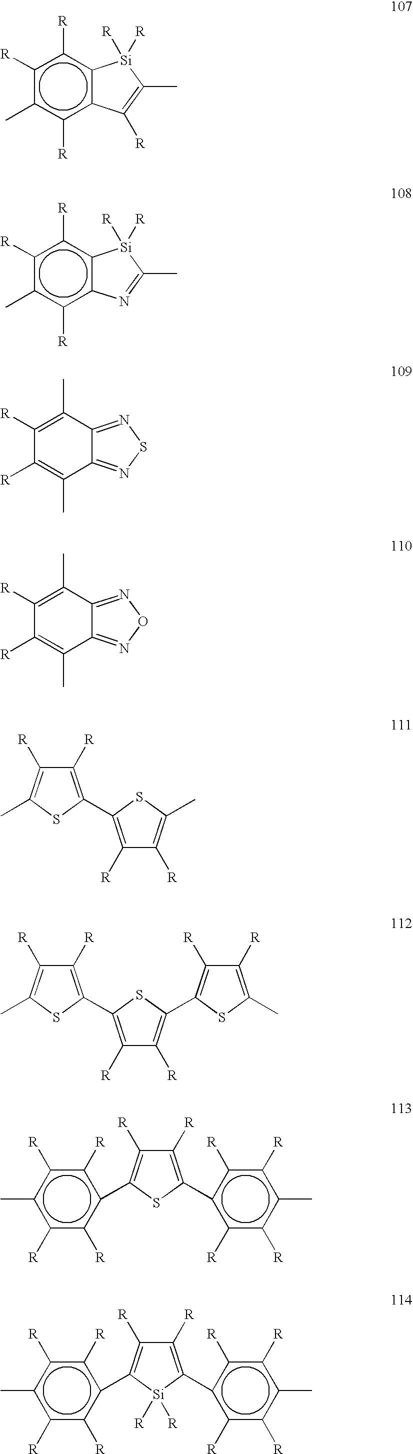

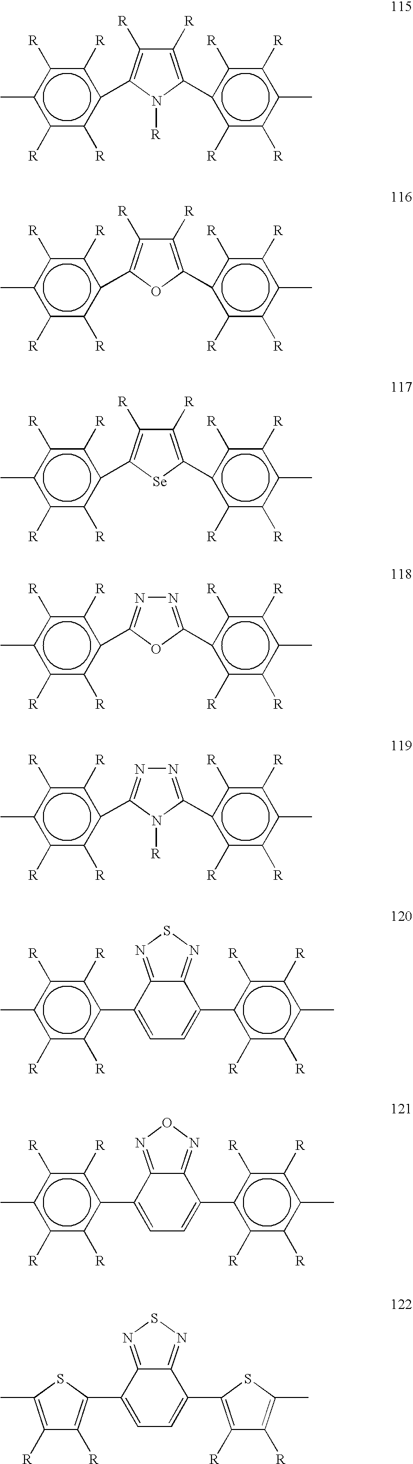

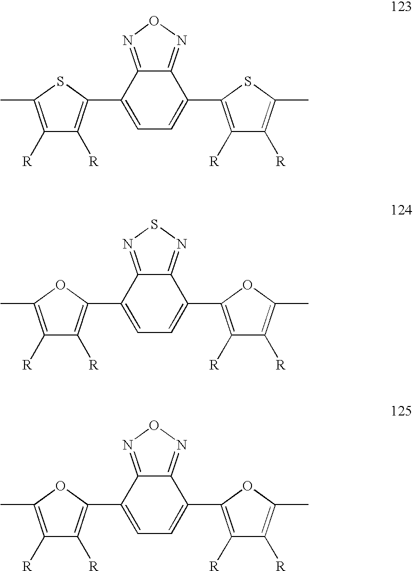

The divalent group having a metal complex structure represented by Ar₁, Ar₂, Ar₃ and Ar₄ means a divalent group remaining after removal of two hydrogen atoms from an organic ligand of a metal complex having an organic ligand. The carbon number of the organic ligand is usually about 4 to 60, and examples thereof include 8-quinolinol and derivatives thereof, benzoquinolinol and derivatives thereof, 2-phenylpyridine and derivatives thereof, 2-phenyl-benzothiazole and derivatives thereof, 2-phenyl-benzoxazole and derivatives thereof, porphyrin and derivatives thereof, and the like.

Mentioned as the center metal of the complex are, for example, aluminum, zinc, beryllium, iridium, platinum, gold, europium, terbium and the like.

As the metal complex having an organic ligand, mentioned are metal complexes, triplet light emitting complexes and the like known as fluorescent materials and phosphorescent materials of lower molecular weight.

As the divalent group having a metal complex structure, the following groups (126 to 132) are specifically exemplified.

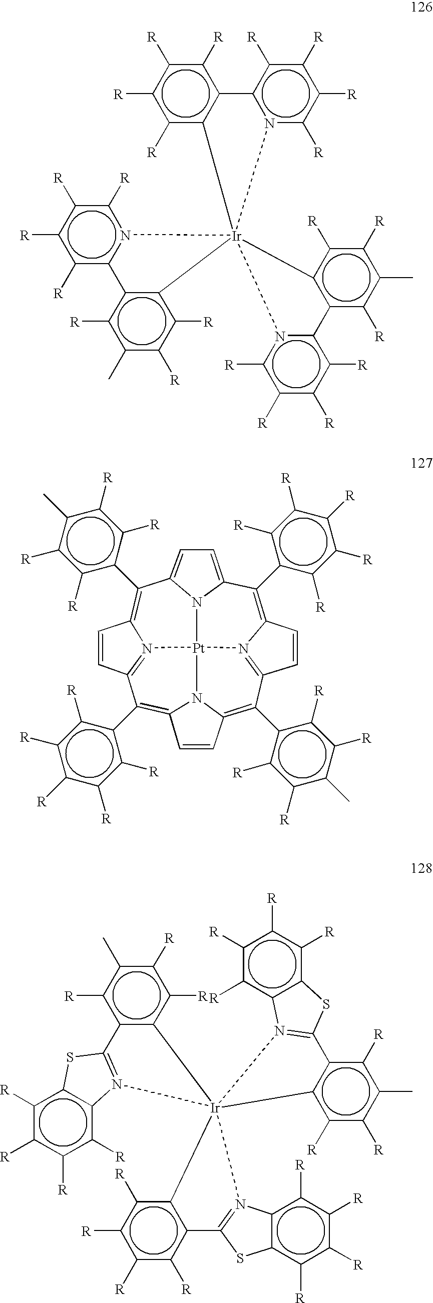

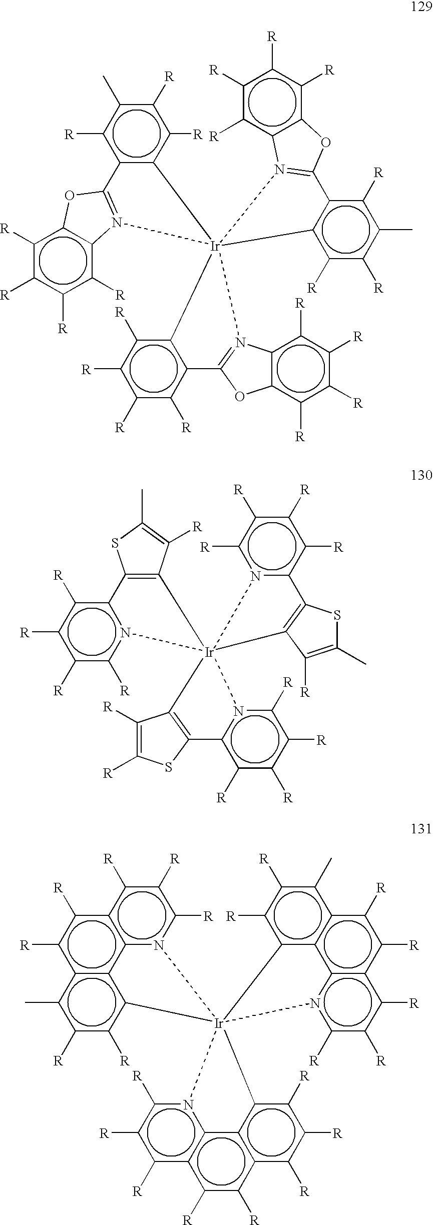

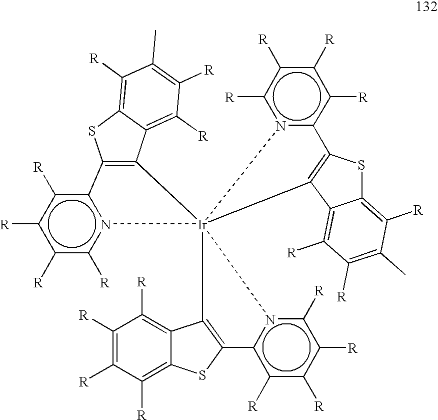

In the above-described formulae 1 to 132, Rs each independently represent a hydrogen atom, alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, nitro group or cyano group. Carbon atoms in the groups 1 to 132 may be replaced by a nitrogen atom, oxygen atom or sulfur atom, and hydrogen atoms in these groups may be replaced by a fluorine atom.

Here, the definitions, specific examples and preferable examples of the alkyl group, alkoxy group, alkylthio group, aryl group, aryloxy group, arylthio group, arylalkyl group, arylalkoxy group, arylalkylthio group, arylalkenyl group, arylalkynyl group, substituted amino group, substituted silyl group, halogen atom, acyl group, acyloxy group, imine residue, amide group, acid imide group, monovalent heterocyclic group and substituted carboxyl group are the same as in the case of the above-described aromatic hydrocarbon ring having a substituent.

From the standpoint of solubility, device properties and the like, preferable as the arylene group which is a preferred repeating unit of the above-described formula (3) are repeating units of the following formula (1-D) and the following formula (1-E).

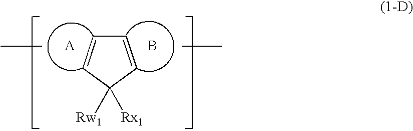

(wherein, A ring and B ring are the same as described above, two connecting bonds are present each on A ring and/or B ring, and Rw₁ and Rx₁ each independently represent a substituent).

As Rw₁ and Rx₁, preferable are a hydrogen atom, alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups, nitro group or cyano group, and the same groups as the above-mentioned substituents on A ring and B ring are exemplified. Rw₁ and Rx₁ are not mutually connected to form a ring.

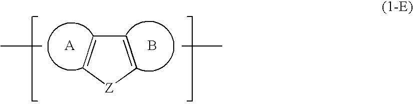

(wherein, A ring and B ring are the same as described above, two connecting bonds are present each on A ring and/or B ring, and Z represents —O—, —S—, —S(═O)—, —S(═O)(═O)—, —N(Rw₂)-, —Si(Rw₂)(Rx₂)-, —P(═O)(Rw₂)-, —P(Rw₂)-, —B(Rw₂)-, —C(Rw₂)(Rx₂)—O—, —C(Rw₂)═N— or —Se—. Rw₂ and Rx₂ each independently represent a substituent).

As Rw₂ and Rx₂, preferable are a hydrogen atom, alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups, nitro group or cyano group, and the same groups as the substituents on A ring and B ring are exemplified.

As the specific structure of a repeating unit of the above-described formula (1-D), exemplified are the following structures (1F-1 to 1F-73) and structures having a substituent on the following structures. As the kind of the substituent, the same groups as the above-mentioned substituents on A ring and B ring are exemplified.

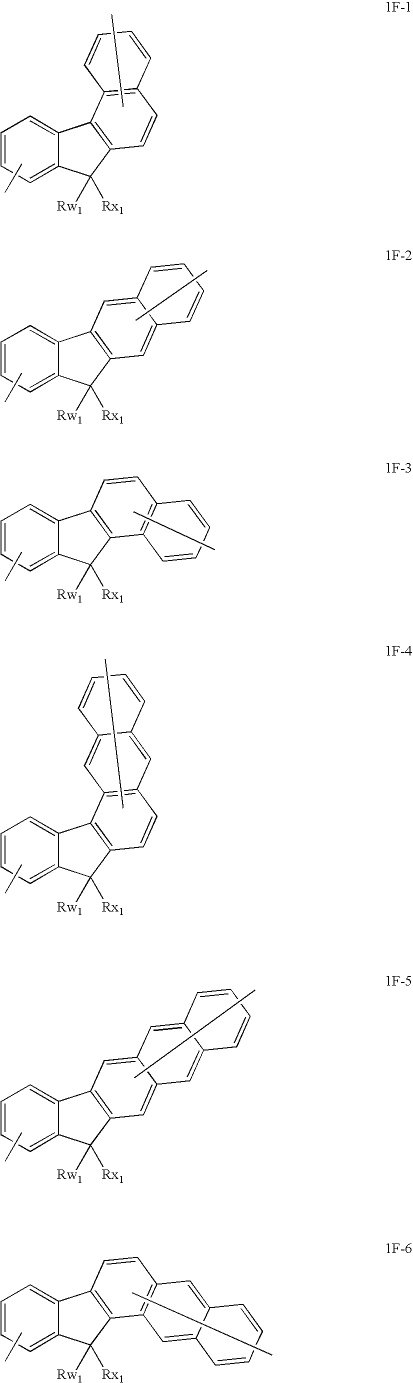

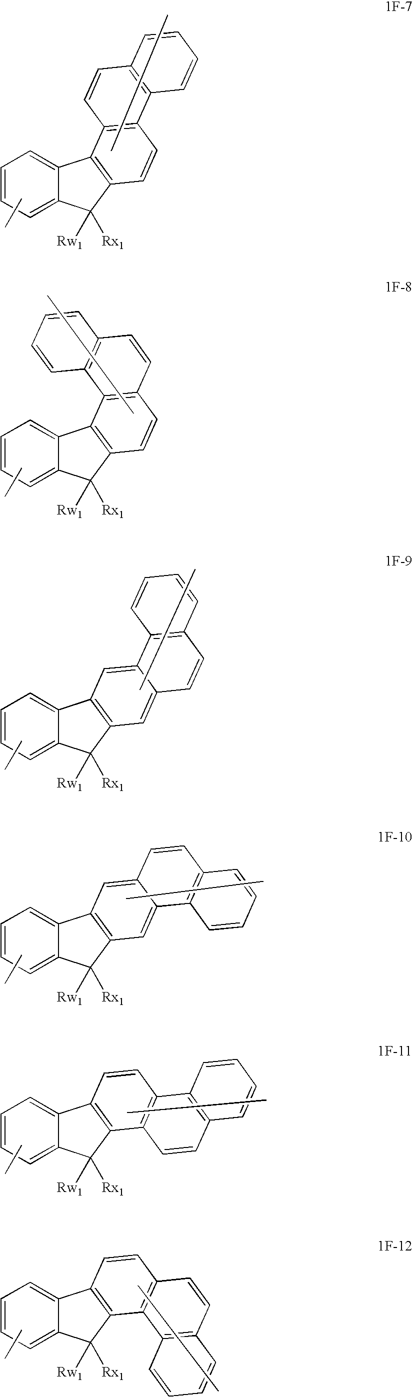

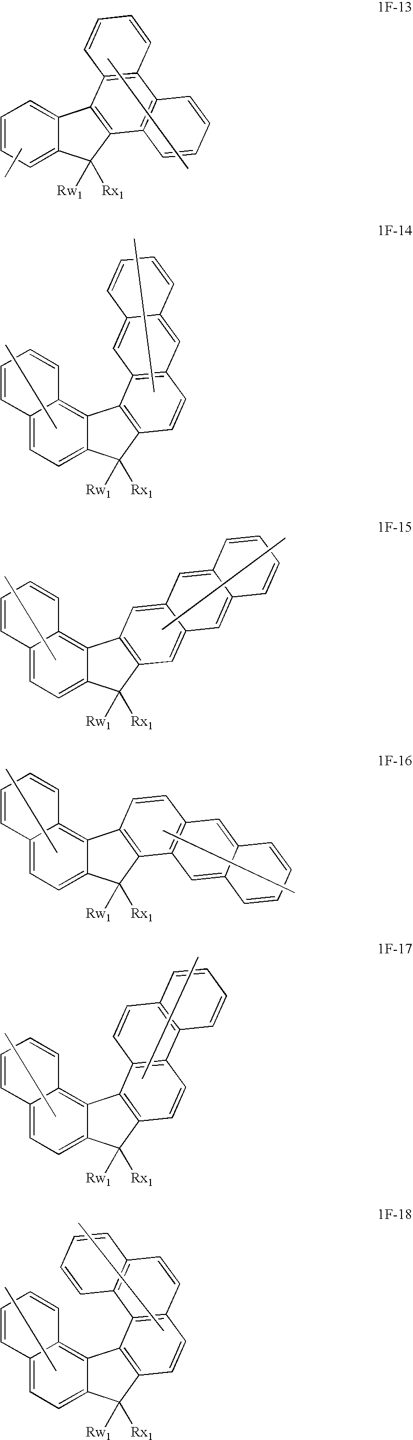

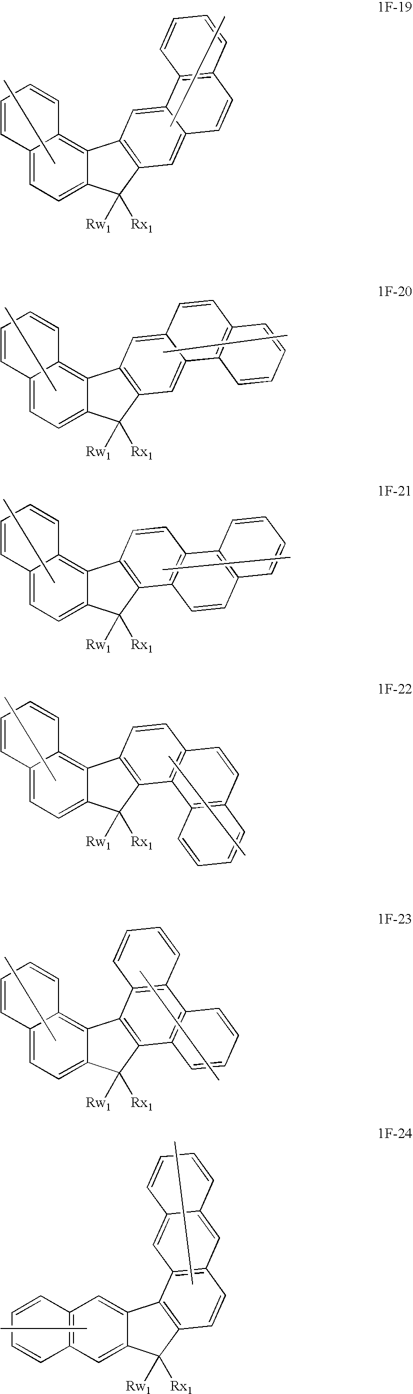

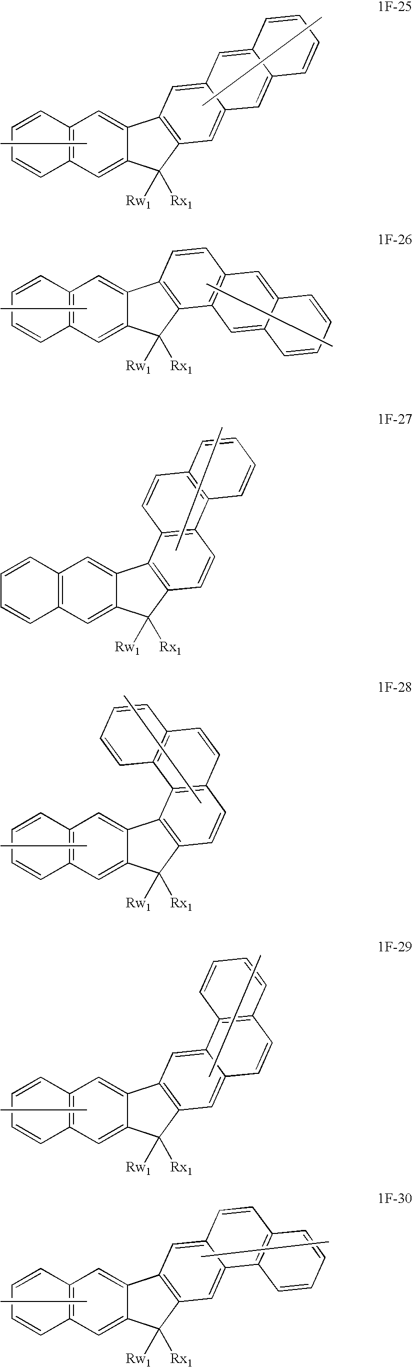

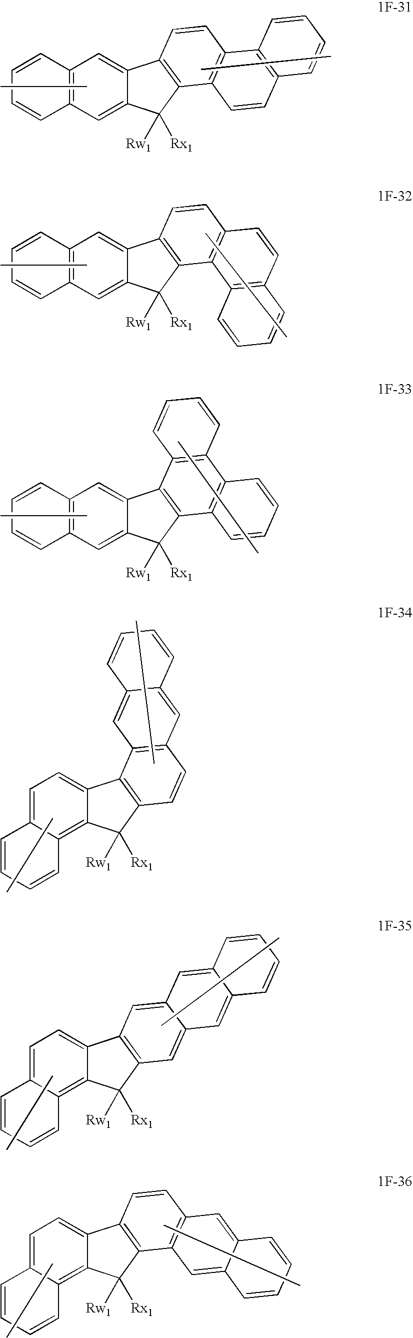

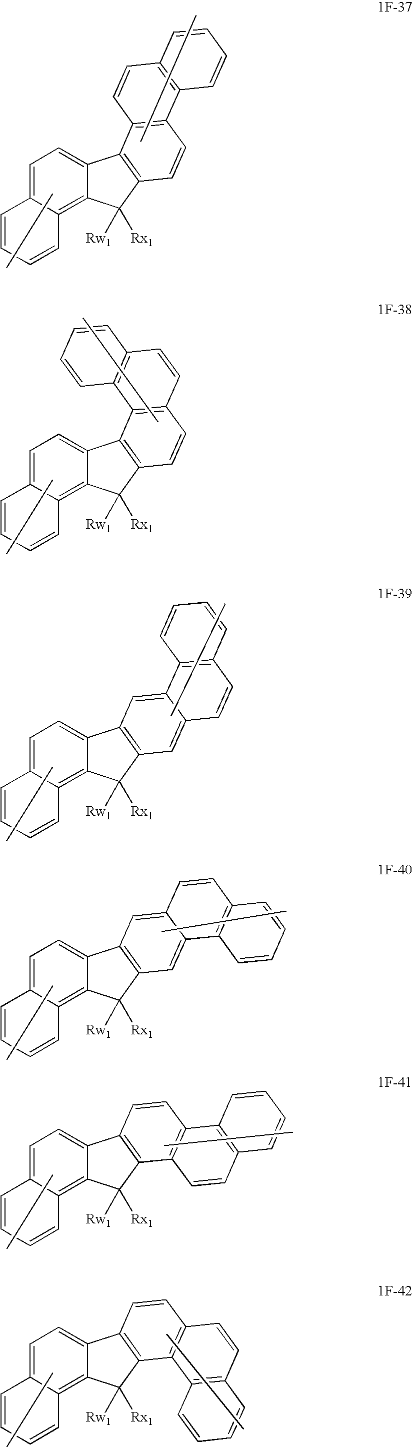

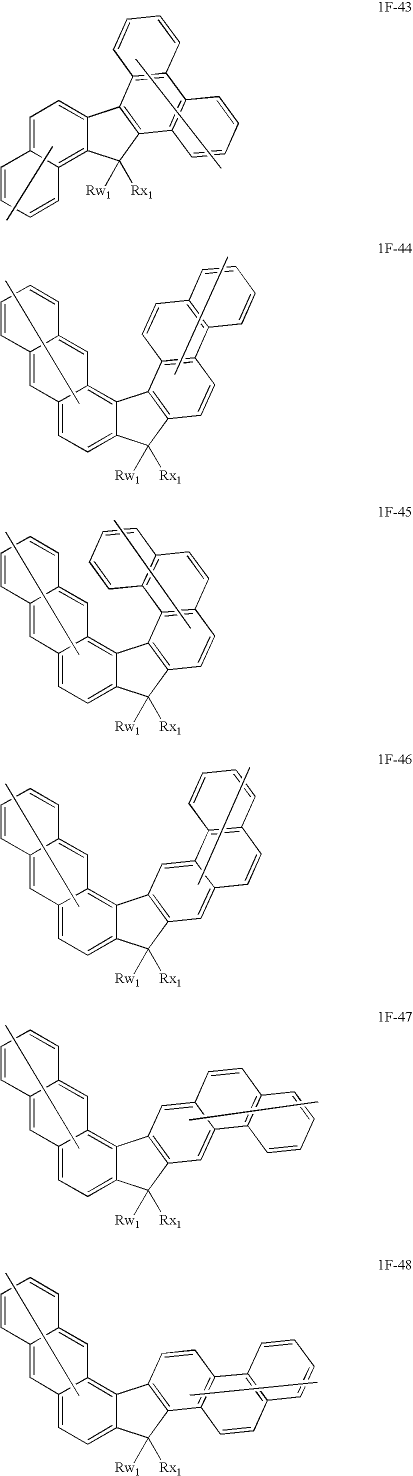

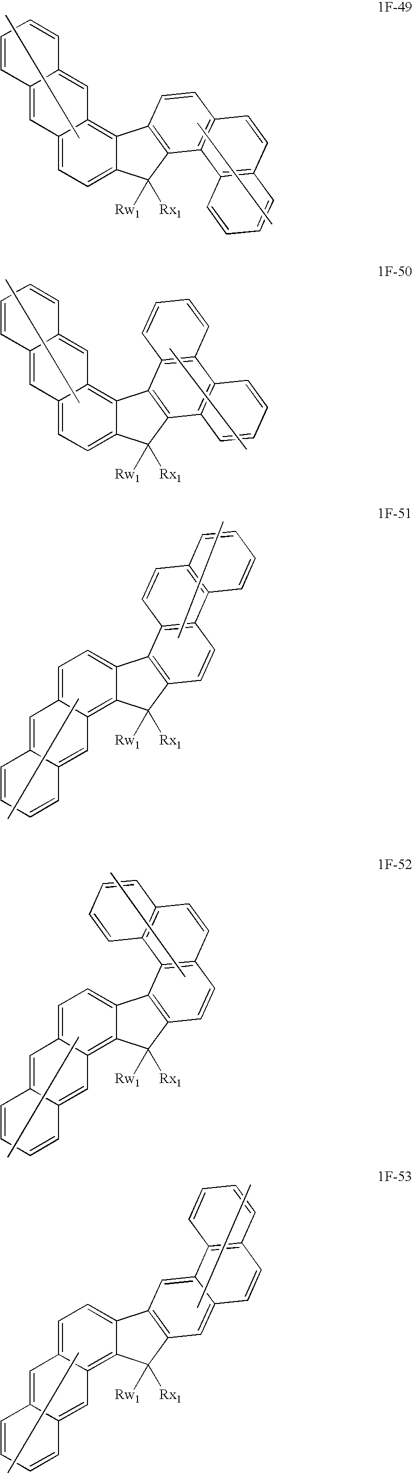

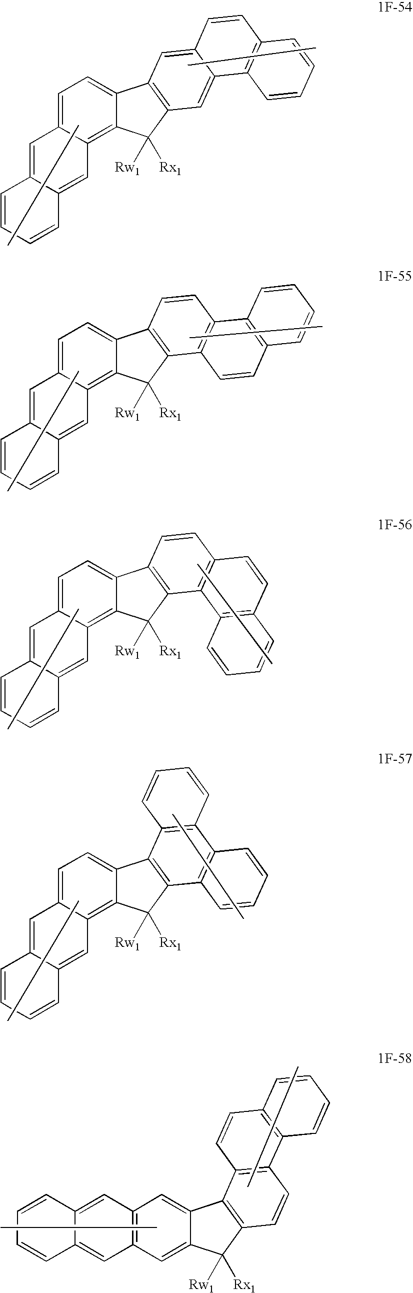

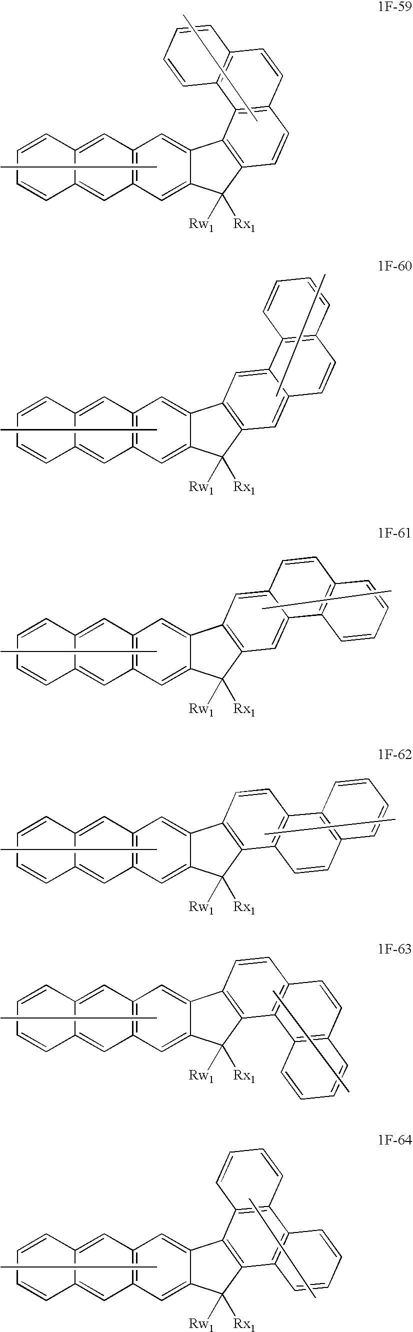

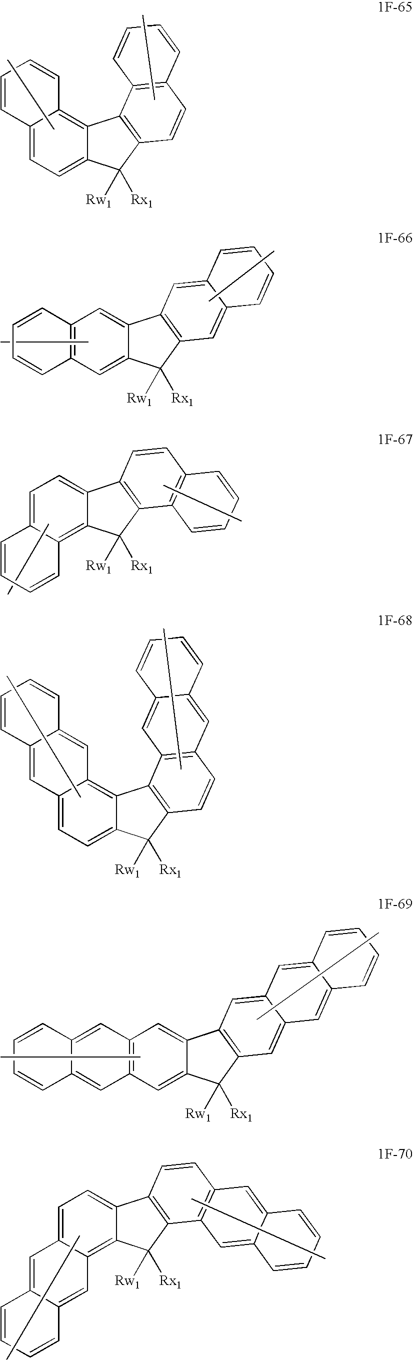

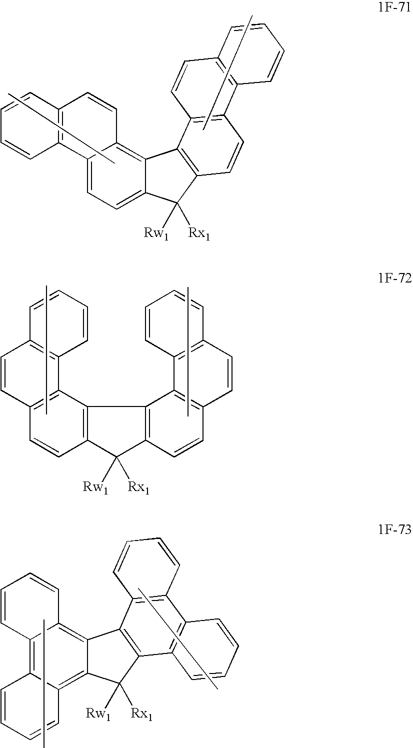

As the specific structure of a repeating unit of the above-described formula (1-E), exemplified are the following structures (1G-1 to 1G-12) and structures having a substituent on the following structures. As the kind of the substituent, the same groups as the above-mentioned substituents on A ring and B ring are exemplified.

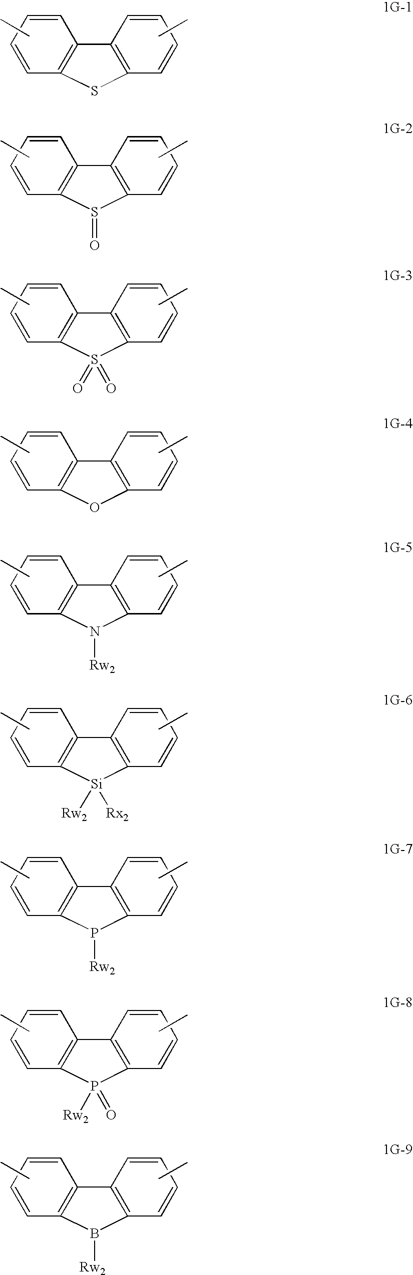

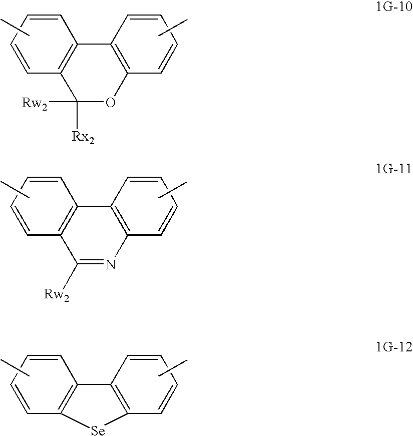

As the arylene group which is a preferred repeating unit of the above-described formula (3), preferable are repeating units of the following formula (7), (8), (9), (10), (11) or (12), in addition to repeating units of the above-described formulae (1-D), (1-E).

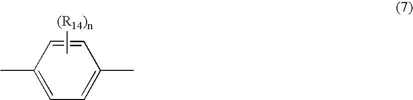

(wherein, R₁₄ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. n represents an integer of 0 to 4. When a plurality of R₁₄s are present, they may be the same or different.)

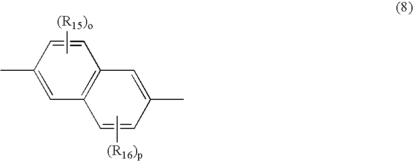

(wherein, R₁₅ and R₁₆ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. o and p each independently represent an integer of 0 to 3. When R₁₅ and R₁₆ are present each in plural number, they may be the same or different.)

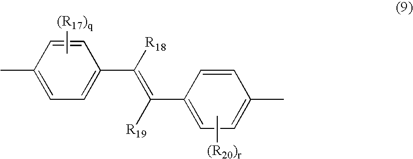

(wherein, R₁₇ and R₂₀ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. q and reach independently represent an integer of 0 to 4. R₁₈ and R₁₉ each independently represent a hydrogen atom, alkyl group, aryl group, monovalent heterocyclic group, carboxyl group, substituted carboxyl group or cyano group. When R₁₇ and R₂₀ are present in plural number, they may be the same or different.)

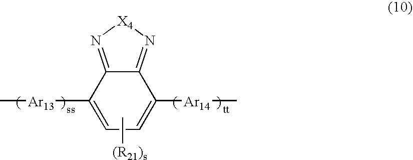

(wherein, R₂₁ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. s represents an integer of 0 to 2. Ar₁₃ and Ar₁₄ each independently represent an arylene group, divalent heterocyclic group or divalent group having a metal complex structure. ss and tt each independently represent 0 or 1. X₄ represents O, S, SO, SO₂, Se or Te. When a plurality of R₂₁s are present, they may be the same or different.)

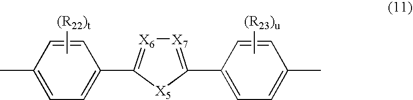

(wherein, R₂₂ and R₂₅ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. t and u each independently represent an integer of 0 to 4. X₅ represents O, S, SO₂, Se, Te, N—R₂₄ or SiR₂₅R₂₆. X₆ and X₇ each independently represent N or C—R₂₇. R₂₄, R₂₅, R₂₆ and R₂₇ each independently represent a hydrogen atom, alkyl group, aryl group, arylalkyl group or monovalent heterocyclic group. When R₂₂, R₂₃ and R₂₇ are present in plural number, they may be the same or different.)

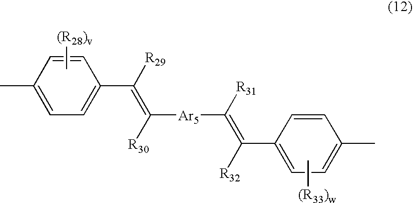

(wherein, R₂₈ and R₃₃ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. v and w each independently represent an integer of 0 to 4. R₂₉, R₃₀, R₃₁ and R₃₆ each independently represent a hydrogen atom, alkyl group, aryl group, monovalent heterocyclic group, carboxyl group, substituted carboxyl group or cyano group. Ar₅ represents an arylene group, divalent heterocyclic group or divalent group having a metal complex structure. When R₂₈ and R₃₃ are present in plural number, they may be the same or different).

Among repeating units of the above-described formula (4), repeating units of the following formula (13) are preferable also from the standpoint of changing of light emitting wavelength, from the standpoint of enhancement of light emitting efficiency and from the standpoint of improvement of heat resistance.

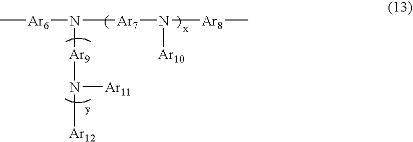

(wherein, Ar₆, Ar₇, Ar₈ and Ar₉ each independently represent an arylene group or divalent heterocyclic group. Ar₁₀, Ar₁₁, and Ar₁₂ each independently represent an aryl group or monovalent heterocyclic group. Ar₆, Ar₇, Ar₈, Ar₉, Ar₁₀, Ar₁₁, and Ar₁₂ may have a substituent. x and y each independently represent 0 or positive integer).

From the standpoint of stability of a light emitting layer and easiness of synthesis thereof, one or more and three or less repeating units of the above-described formula (13) are preferably contained, and one or more repeating units are more preferably contained. Further preferable is a case of containing one repeating unit of the formula (13).

When two repeating units of the above-described formula (13) are contained as a repeating unit in the polymer compound of the present invention, it is preferable that a repeating unit in which x=y=0 and a repeating unit in which x=1 and y=0 are combined, or two repeating units in which x=1 and y=0 are combined, from the standpoint of regulation of light emitting wavelength and from the standpoint of device properties and the like.

In the present invention, when a repeating unit of the above-described formula (1-A) and a repeating unit of the above-described formula (13) are contained, the molar ratio thereof is preferably 98:2 to 60:40.

From the standpoint of fluorescence intensity, device properties and the like, it is more preferable that the proportion of a repeating unit of the above-described formula (13) is 30 mol % or less based on the sum of a repeating unit of the above-described formula (1-A) and a repeating unit of the above-described formula (13). When only one polymer compound of the present invention is used to produce a device for EL, the ratio of a repeating unit of the above-described formula (1-A) to a repeating unit of the above-described formula (13) is preferably 95:5 to 70:30, from the standpoint of device properties and the like.

In the present invention, when a repeating unit of the above-described formula (1-A) and a repeating unit of the above-described formulae (1-D), (1-E) are contained, the molar ratio thereof is preferably 90:10 to 10:90.

In the present invention, when a repeating unit of the above-described formula (1-A) and a repeating unit of the above-described formulae (3) to (12) (excepting when the above-described formula (3) is the above-described formula (1-D) or (1-E) and when the above-described formula (4) is the above-described formula (13)) are contained, the molar ratio thereof is preferably 99:1 to 60:40, more preferably 99:1 to 70:30.

As specific examples of the repeating unit of the above-described formula (13), units of the following (formulae 133 to 140) are mentioned.

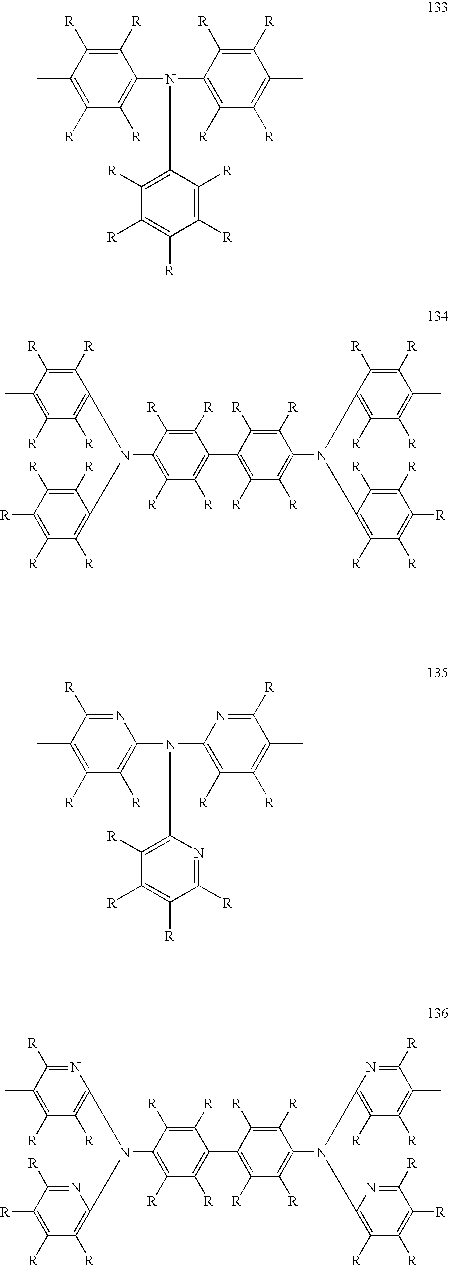

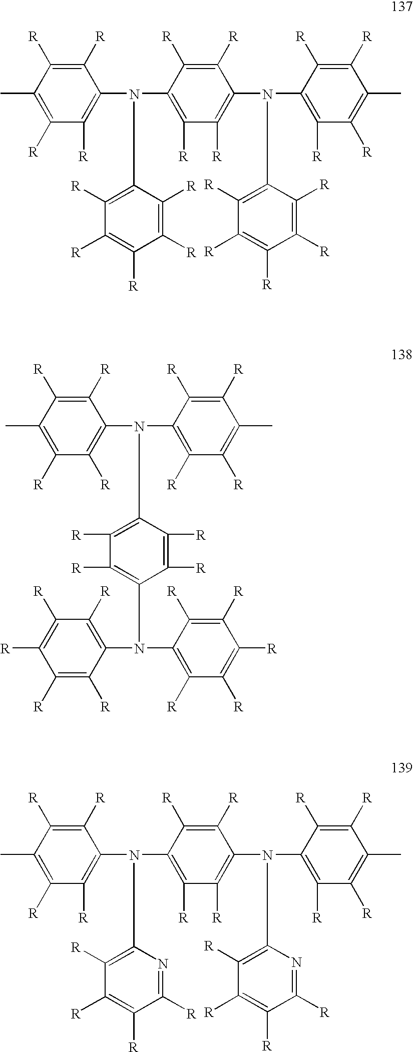

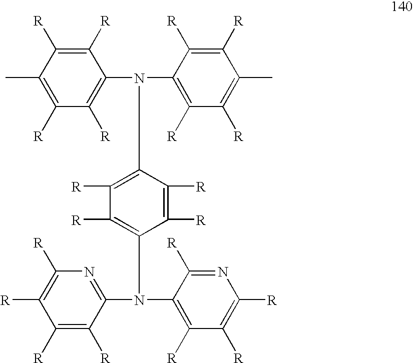

In the above-described formulae, R represents the same meaning as in the above-described formulae 1 to 132.

For enhancing solubility in organic solvents, it is preferable that one or more substituents other than a hydrogen atom are contained and it is preferable that symmetry of the shape of a repeating unit containing substituents is poor.

When Rs contain an alkyl in the above-mentioned formulae, it is preferable, for enhancing solubility of the polymer compound in organic solvents, that one or more Rs contain a cyclic or branched alkyl. Further, when Rs contain partially an aryl group and/or heterocyclic group in the above-mentioned formulae, these groups may further contain at least one substituent. Of structures of the above-described formulae 133 to 140, preferable are structures of the above-described formula 134 and the above-described formula 137 from the standpoint of regulation of light emitting wavelength.

Of repeating units of the above-described formula (13), preferable are those in which Ar₆, Ar₇, Ar₈ and Ar₉ each independently represent an arylene group and Ar₁₀, Ar₁₁ and Ar₁₂ each independently represent an aryl group from the standpoint of regulation of light emitting wavelength and from the standpoint of device properties and the like.

It is preferable that Ar₆, Ar₇ and Ar₈ each independently represent an unsubstituted phenylene group, unsubstituted biphenyl group, unsubstituted naphthylene group or unsubstituted anthracenediyl group.

From the standpoint of solubility in organic solvents, device properties and the like, Ar₁₀, Ar₁₁ and Ar₁₂ each independently represent preferably an aryl group having three or more substituents, more preferably a phenyl group having three or more substituents, naphthyl group having three or more substituents or anthranyl group having three or more substituents, further preferably a phenyl group having three or more substituents.

Particularly, it is preferable that Ar₁₀, Ar₁₁, and Ar₁₂ each independently represent the following formula (13-1) and x+y=3, and more preferably, x+y=1, further preferably, x=1 and y=0.

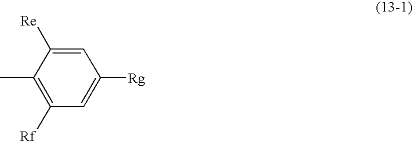

(wherein, Re, Rf and Rg each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, silyloxy group, substituted silyloxy group, monovalent heterocyclic group or halogen atom. Hydrogen atoms contained in Re, Rf and Rg may be replaced by a fluorine atom).

More preferably, Re and Rf each independently represent an alkyl group having 3 or less carbon atoms, alkoxy group having 3 or less carbon atoms or alkylthio group having 3 or less carbon atoms and Rg represents an alkyl group having 3 to 20 carbon atoms, alkoxy group having 3 to 20 carbon atoms or alkylthio group having 3 to 20 carbon atoms in the above-described formula (13-1).

In the repeating unit of the above-described formula (13), Ar₇ preferably represents the following formula (19-1) or (19-2).

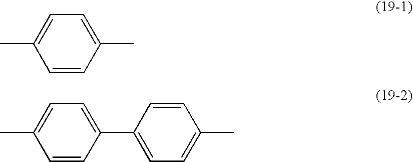

(wherein, benzene rings contained in the structures of (19-1) and (19-2) may have each independently 1 or more and 4 or less substituents. These substituents may be mutually the same or different. A plurality of substituents may be connected to form a ring. Further, another aromatic hydrocarbon ring or heterocyclic ring may be connected adjacent to the benzene ring).

As particularly preferable specific examples of the repeating unit of the above-described formula (13), repeating units of the following (formulae 141-142) are mentioned.

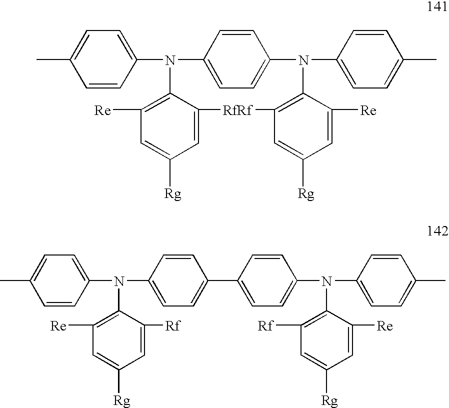

As specific examples of the formula (13), repeating units of the following formulae (17), (19) and (20) are preferable from the standpoint of regulation of light emitting wavelength. Further preferable are repeating units of the following formula (17) from the standpoint of fluorescence intensity. In this case, heat resistance can be enhanced.

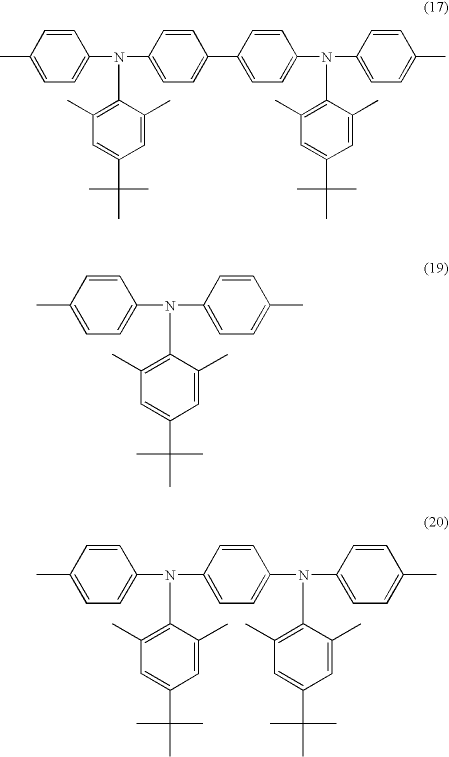

The polymer compound of the present invention may contain repeating units other than the repeating units of the above-described formulae (1-A), (3) to (13) in a range not deteriorating light emitting property and charge transporting property. Further, these repeating units and other repeating units may be connected via a nonconjugated unit, or the repeating units may contain nonconjugated parts thereof. As the connected structure, those shown below and combinations of two or more of those shown below, and the like, are exemplified. Here, R represents a group selected from the same substituents as described above, and Ar represents a hydrocarbon group having 6 to 60 carbon atoms optionally containing a hetero atom (oxygen, sulfur, nitrogen, silicon, boron, phosphorus, selenium).

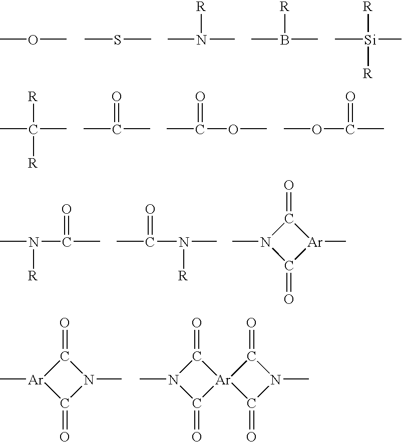

As the polymer compound containing repeating units other than the repeating units of the above-described formula (1-A), those composed of at least one repeating unit selected from repeating units of the above-described formulae (1-1), (1-2), (1-3) and (1-4) and at least one repeating unit of the above-described formulae (1-D), (1-E), (3) to (13) are preferable, those composed of any one of repeating units of the formulae 133, 134 and 137 and a repeating unit of the formula (1-1) are more preferable, those composed of any one of repeating units of the formulae 134 and 137 and a repeating unit of the formula (1-1) are further preferable, and those composed of a repeating units of the formula (1-1) and a repeating unit of the formula (17) and those composed of a repeating units of the formula (1-1) and a repeating unit of the formula (20) are furthermore preferable, from the standpoint of fluorescence property and device properties and the like.

The polymer compound of the present invention may be a random, block or graft copolymer, or a polymer having an intermediate structure of them, for example, a random copolymer taking on a blocking property. From the standpoint of obtaining a polymer light emitter having high fluorescent or phosphorescent quantum yield, a random copolymer taking on a blocking property, and a block or graft copolymer are more preferable than complete random copolymers. Those having branching in the main chain and having three or more ends, and dendrimers are also included.

When A ring and B ring have different structures in the structure of the above-described formula (1), the adjacent structure of the formula (1) is a structure of any one of the following formulae (31), (32) and (33). From the standpoint of an electron injection property and transportability, it is preferable that the polymer compound contains at least one of (31) to (33).

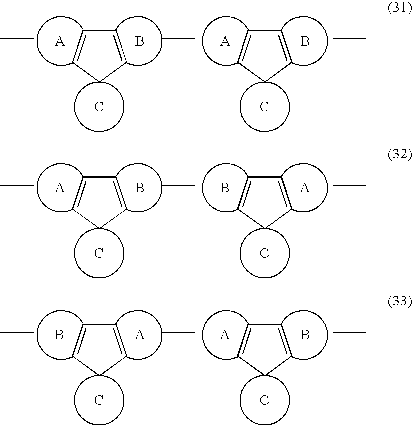

(wherein, A ring and B ring each independently represent an aromatic hydrocarbon ring optionally having a substituent, and the aromatic hydrocarbon ring A and the aromatic hydrocarbon ring B have mutually different ring structures, and connecting bonds are present each on A ring and B ring. C ring is the same as described above).

When B ring is an aromatic hydrocarbon ring obtained by condensation of two or more benzene rings, it is preferable to contain at least (31), among the above-described formulae (31) to (33).

When a polymer compound in which B ring is an aromatic hydrocarbon ring obtained by condensation of two or more benzene rings is used as a material for polymer LED, the proportion of a B ring-B ring linkage of the above-described formula (32) is preferably 0.4 or less, more preferably 0.3 or less, further preferably 0.2 or less, furthermore preferably substantially 0, based on all linkages containing B ring in the polymer compound, from the standpoint of suppression of change in light emitting wavelength during driving of a device. From the standpoint of suppression of change in light emitting wavelength during driving of a device, A ring is preferably a benzene ring.

The linkage containing B ring includes not only a B ring-A ring linkage in the above-mentioned formula (31) and a B ring-B ring linkage in the above-mentioned formula (32), but also linkages in which a repeating unit other than the structure of the above-described formula (1-A) is adjacent to B ring. When the repeating unit other than the structure of the above-described formula (1-A) contains B ring, if there is a linkage between B ring in the above-mentioned formula (1-A) and B ring in the repeating unit other than the structure of the above-described formula (1-A), then, this linkage is also included in the B ring-B ring linkage.

In polymer compounds containing a lot of mutual linkages of aromatic hydrocarbon rings obtained by condensation of two or more benzene rings, when a device is driven for a long period of time, light emission of longer wavelength as compared with light emitting wavelength in the beginning of driving is observed in some cases. Specifically, when a repeating unit of the above-described formula (1-1) is contained, if there are a lot of naphthalene ring-naphthalene ring linkages, then, light emission of longer wavelength as compared with light emitting wavelength in the beginning of driving is observed in some cases when a device is driven for a long period of time. The proportion of a naphthalene ring-naphthalene ring linkage is preferably 0.4 or less, more preferably 0.3 or less, further preferably 0.2 or less, furthermore preferably substantially 0, based on all linkages containing a naphthalene ring in the polymer compound.

As the structure containing few mutual linkages of aromatic hydrocarbon rings obtained by condensation of two or more benzene rings, preferable is a structure in which two adjacent structures of the above-described formula (1-A) are connected at the head (H) and the tail (T) as in the above-described formula (31). As the polymer compound, preferable are polymer compounds in which substantially all adjacent formulae (1-A) described above are H-T connected. In particular, in the case of the above-described formulae (1-1) and (1-2), H-T connection is preferable.

In a polymer compound containing a repeating unit of the above-described formula (1-A) in an amount of 50 mol % or more based on all repeating units, if the proportion that a repeating unit of the formula (1-A) is adjacent to a repeating unit of the formula (1-A) is represented by Q₁₁, Q₁₁ is preferably 25% or more, from the standpoint of fluorescence intensity, device properties and the like.

For obtaining a polymer compound of the present invention by polymerizing monomers, that containing two or more structures of the above-described formula (1-A) can also be used as the monomer. As the monomer, exemplified are those having a structure in which two or more polymerization active groups are added to a di- to penta-mer, and for example, there are mentioned monomers in which polymerization active groups are connected to connecting bonds in the above-described formulae (31) to (33).

As one of methods for obtaining polymer compounds containing the above-described formula (31) in significant amount and polymer compounds containing few B ring-B ring linkages, there is a method for polymerization using a compound in which a substituent correlating with polymerization connected to A ring and a substituent correlating with polymerization connected to B ring are different. For example, if polymerization is performed using a compound in which a borate is connected to A ring and a halogen atom is connected to B ring, a polymer compound containing few B ring-B ring linkages is obtained.

The polymer compound of the present invention is preferably a random copolymer taking on a blocking property or a block or graft copolymer, and those containing a linkage of repeating units of the above-described formula (1-A) have higher fluorescence intensity and more excellent device properties. When repeating units of the above-described formula (1-A) contained in a polymer compound of the present invention are contained in the same proportion, those containing a longer linkage of repeating units of the above-described formula (1-A) have more excellent fluorescence intensity and device properties.

In a copolymer containing a repeating unit of the above-described formula (1-A) and a repeating unit of the above-described formula (13) wherein the proportion of the repeating unit of the above-described formula (13) is 15 to 50 mol % based on all repeating units, if the proportion that a repeating unit of the formula (13) is adjacent to a repeating unit of the formula (13) is represented by Q₂₂, Q₂₂ is preferably 15 to 50% or more, and more preferably 20 to 40%, from the standpoint of fluorescence intensity, device properties and the like.

As the polymer compound showing increase in fluorescence intensity, device properties and the like when a specific linkage is contained and its composition, preferable are polymer compounds containing a repeating unit of the above-described formula (13) and a repeating unit of the following formula (1-1) or (1-2) and their compositions.

In the polymer compound of the present invention and its composition, when a repeating unit of the above-described formula (13) and a repeating unit of the following formula (1-1) or (1-2) are contained, if the proportion of repeating units of the formula (13) connected to mark * in the formula (1-1) or the formula (1-2) in all repeating units of the formula (13) is represented by Q₂₁N, then, Q₂₂ is preferably 15 to 50%, further preferably 20 to 40%. When Q₂₂ is 15 to 50%, Q₂₁N is preferably 20 to 40%.

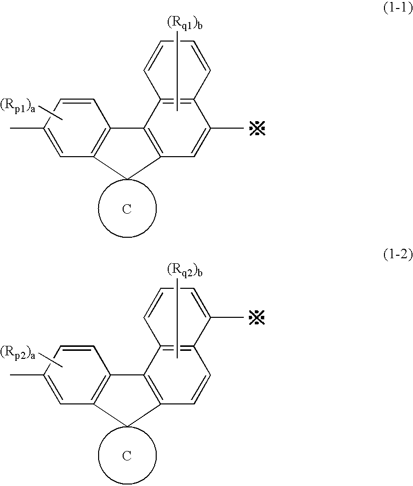

(wherein, Rₚ₁, R_{q1}, Rₚ₂, R_{q2}, a, b, C ring represent the same meanings as described above).

As the means for checking a linkage in a polymer compound, an NMR measurement method can be used.

For being able to stand various processes for producing a light emitting device and the like, the glass transition temperature of the polymer compound is preferably about 100° C. or higher, more preferably 130° C. or higher, further preferably 150° C. or higher.

The polystyrene reduced number average molecular weight of the polymer compound of the present invention is usually about 10³ to 10⁸, preferably 10⁴ to 10⁶. The polystyrene reduced weight average molecular weight is usually about 10³ to 10⁸, and from the standpoint of film formability and from the standpoint of efficiency in manufacturing a device, preferably 5×10⁴ or more, further preferably 10⁵ or more. From the standpoint of solubility, it is preferably 10⁵ to 5×10⁶. Polymer compounds in the preferable range show high efficiency even if used alone in a device or even if used in admixture of two or more to manufacture a device. Likewise from the standpoint of enhancement of film formability of the polymer compound, the dispersity (weight average molecular weight/number average molecular weight) is preferably 1.5 or more.

When the polymer compound of the present invention is a conjugated polymer, the weight average molecular weight is preferably 4×10⁴ to 5×10⁶, more preferably 5×10⁴ to 5×10⁶, further preferably 10⁵ to 5×10⁶, from the standpoint of film formability and efficiency when manufacturing a device.

In the case of a polymer compound composed of a repeating unit of the above-described formula (1-A), the elution curve of GPC may be substantially unimodal or substantially bimodal. A unimodal polymer compound and a bimodal polymer compound show different light emitting properties and device properties, and can be used properly depending on uses.

The bimodal referred to in the present invention includes not only a case showing two peaks of a curve, but also a case in which, in a process of increase in a curve, time of very gentle degree of increase lasts for long period after steep increase, then, steep increase occurs again, and a case in which, in a process of decrease in a curve, time of very gentle degree of decrease lasts for long period after steep decrease, then, steep increase occurs again.

In the case of a polymer compound composed of a repeating unit of the above-described formula (1-A) and a repeating unit of the above-described formula (13), the elution curve of GPC may be substantially unimodal or substantially bimodal.

The elution curve of GPC is in general measured by GPC (gel permeation chromatography). For measurement of the elution curve of GPC in the present invention, tetrahydrofuran was used as a mobile phase of GPC and flowed at a flow rate of 0.6 mL/min. Regarding columns, two columns of TSKgel Super HM-H (manufactured by Tosoh Corporation) and one column of TSKgel Super H2000 (manufactured by Tosoh Corporation) were joined serially and a differential refractive index detector was used as a detector. GPC is also called SEC (size exclusion chromatography) in some cases. The elution curve of GPC varies depending on the kind of the polymer compound, and includes a substantially unimodal curve, a substantially bimodal curve and a curve having three or more peaks.

The polymer compound of the present invention may have a branched structure in the main chain, and as the branched structure, preferable is a case in which at least one connecting bond is contained in A ring and at least one connecting bond is contained in B ring, though there is a case in which a structure of the above-described formula (1-C) is contained.

As the branched structure, a case of the following formula (41) is further preferable.

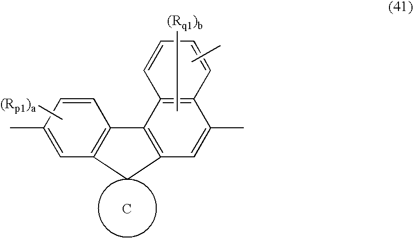

(wherein, Rₚ₁, R_{q1}, a, b and C ring represent the same meanings as described above).

Furthermore, the end group of polymer compound of the present invention may also be protected with a stable group, since light emitting property and life time when made into a device may be deteriorated if a polymerizable group remains intact. Those having a conjugated bond continuing to a conjugated structure of the main chain are preferable, and there are exemplified structures connected to an aryl group or heterocyclic compound group via a carbon-carbon bond. Specifically, substituents described as Chemical Formula 10 in JP-A-9-45478 are exemplified.

In the polymer compound of the present invention, it is preferable that at least one of molecular chain ends thereof has an aromatic end group selected from monovalent heterocyclic groups, monovalent aromatic amine groups, monovalent groups derived from heterocyclic coordinated metal complexes or aryl groups having a formula weight of 90 or more. As this aromatic end group, one group may be used or two or more groups may be used. The proportion of end groups other than aromatic end groups is preferably 30% or less, more preferably 20% or less, further preferably 10% or less, and furthermore preferably substantially zero based on all end groups from the standpoint of fluorescence property and device properties. Here, the molecular chain end means an aromatic end group present at the end of a polymer compound by the production method of the present invention, a leaving group of a monomer used for polymerization which has not left in polymerization and is present at the end of a polymer compound, or a proton connected instead of connecting of an aromatic end group to a monomer present at the end of a polymer compound though a leaving group of a polymer has left. Of these molecular chain ends, in the case of the leaving group of a monomer used for polymerization which has not left in polymerization and is present at the end of a polymer compound, for example, when a polymer compound of the present invention is produced using as a raw material a monomer having a halogen atom, if a halogen atom remains at the end of a polymer compound, there is a tendency of decrease in fluorescence property and the like, thus, it is preferable that substantially no leaving groups of a monomer remain at the end.

In the polymer compound of the present invention, at least one of molecular chain ends thereof can be blocked with an aromatic end group selected from monovalent heterocyclic groups, monovalent aromatic amine groups, monovalent groups derived from heterocyclic coordinated metal complexes and aryl groups having a formula weight of 90 or more, thereby expecting various properties imparted to the polymer compound. Specifically, there are mentioned an effect of elongating time necessary for decrease in brilliance of a device, an effect of enhancing charge injectability, charge transportability, light emitting property and the like, an effect of enhancing compatibility and mutual action between copolymers, an anchor-like effect, and the like.

As the monovalent heterocyclic group, groups described above are mentioned, and specifically, the following structures are exemplified.

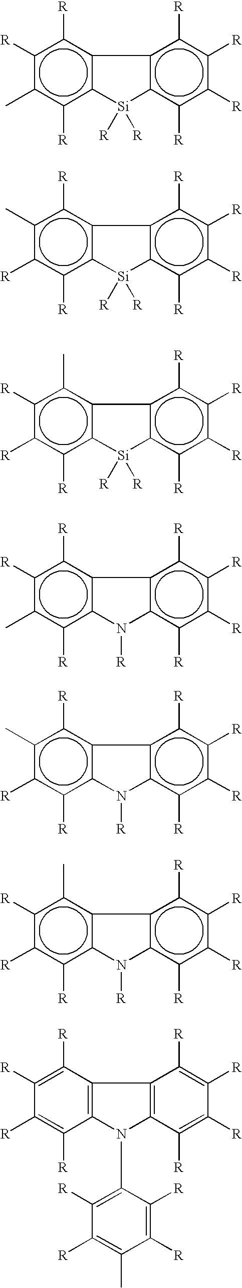

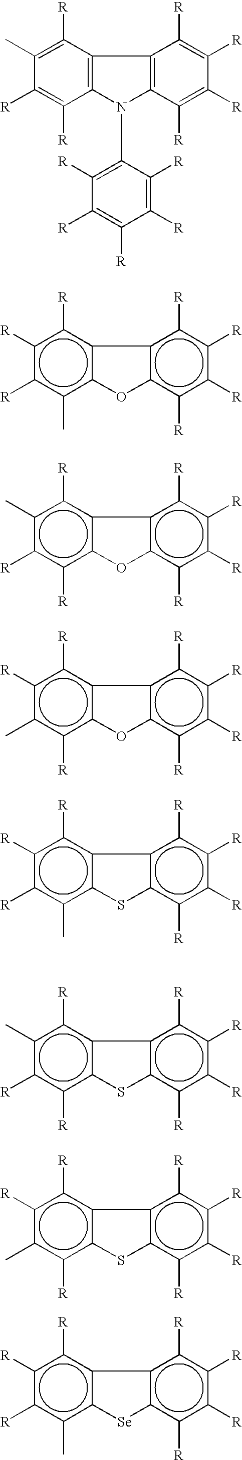

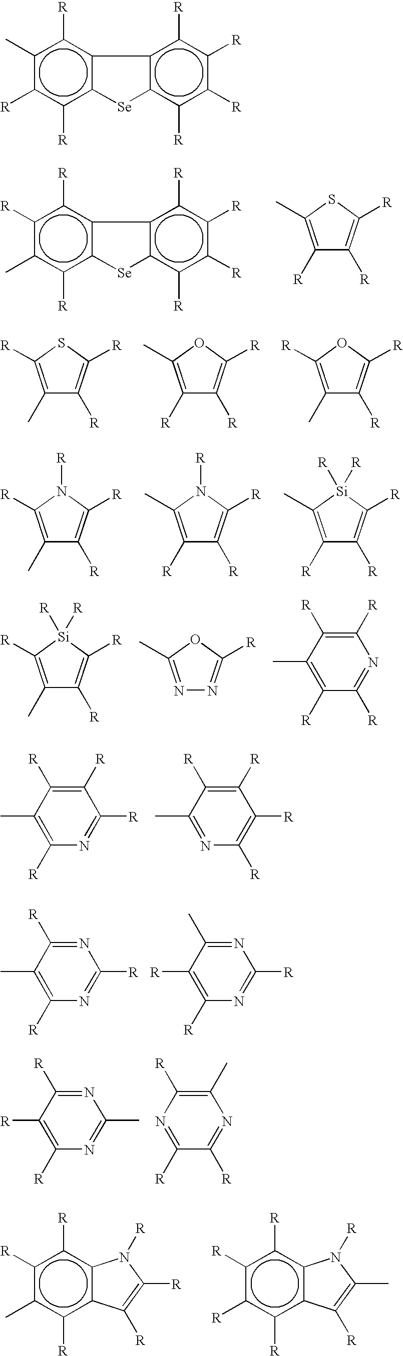

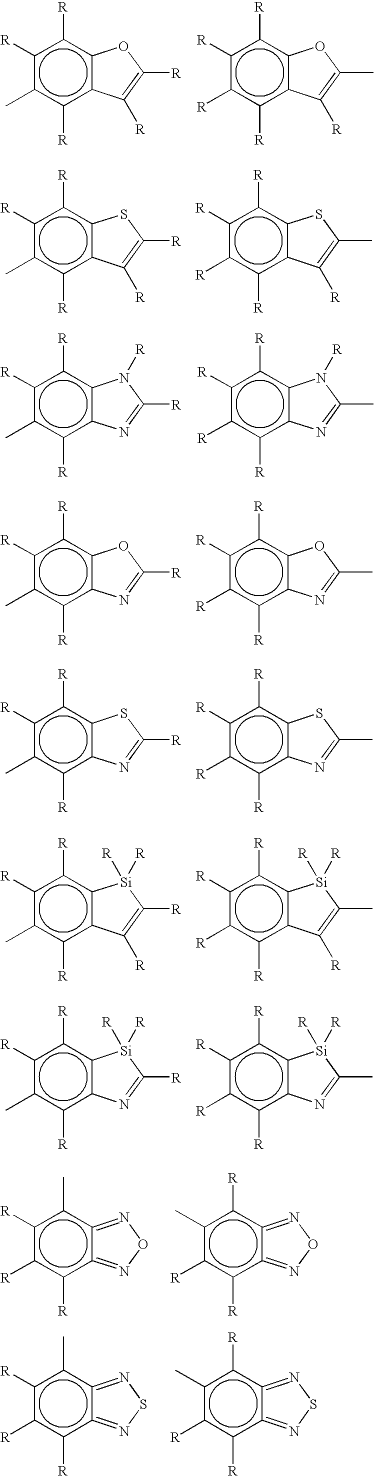

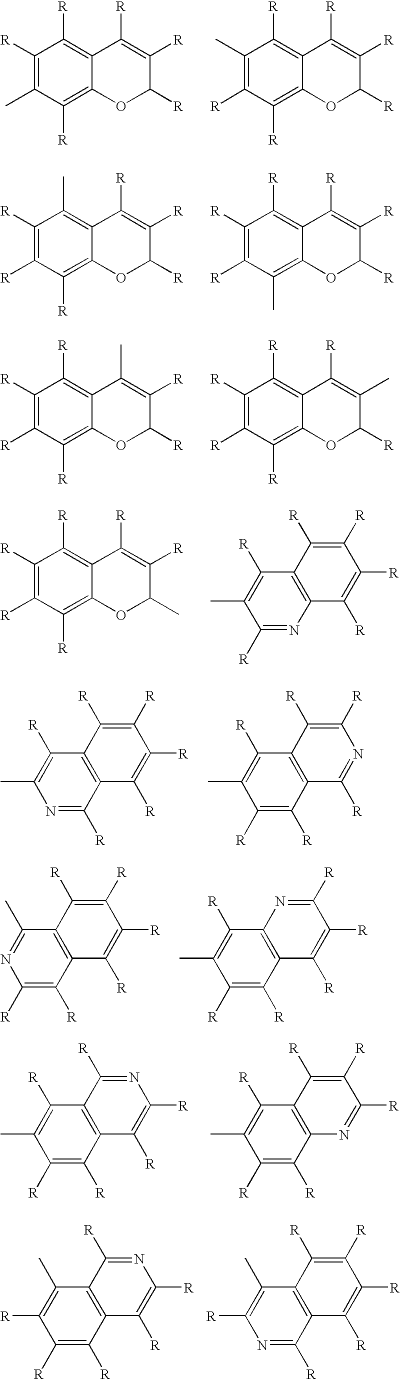

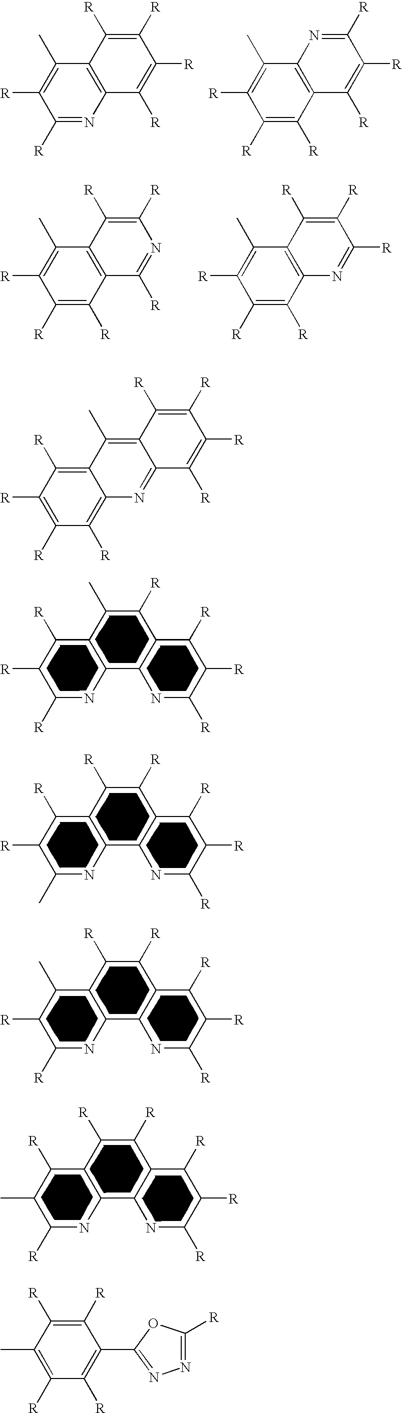

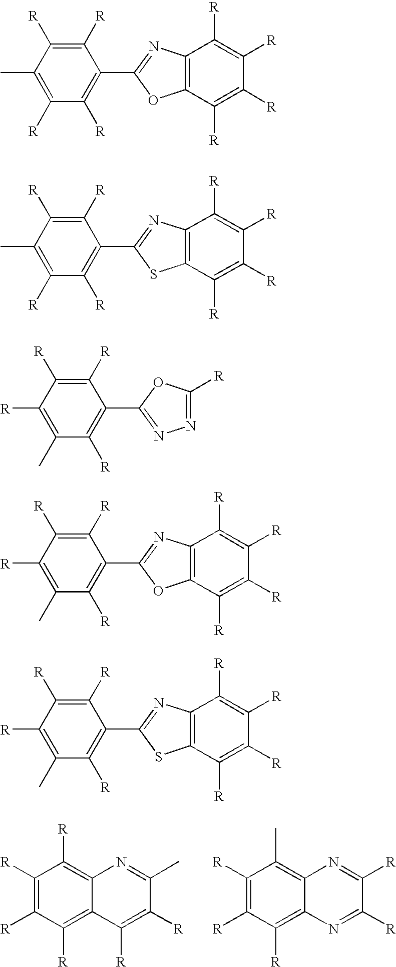

As the monovalent aromatic amine group, exemplified are structures in which one of two connecting bonds in a structure of the above-described formula (13) is sealed with R.

As the monovalent group derived from a heterocyclic coordinated metal complex, exemplified are structures in which one of two connecting bonds in the above-mentioned divalent group having a metal complex structure is sealed with R.

Of end groups, the aryl group having a formula weight of 90 or more has a carbon number of usually about 6 to 60. Here, with respect to the formula weight of the aryl group, when the aryl group is represented by a chemical formula, the sum of products obtained by multiplying atomicity by atomic weight of elements in the chemical formula is the formula weight.

As the aryl group, mentioned are a phenyl group, naphthyl group, anthracenyl group, group having a fluorene structure, condensed ring compound group and the like.

As the phenyl group for sealing the end, for example,

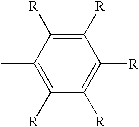

is mentioned.

As the naphthyl group for sealing the end, for example,

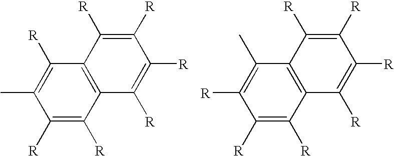

are mentioned.

As the anthracenyl group, for example,

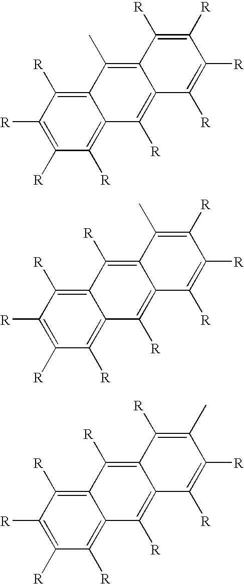

are mentioned.

As the group containing a fluorene structure, for example,

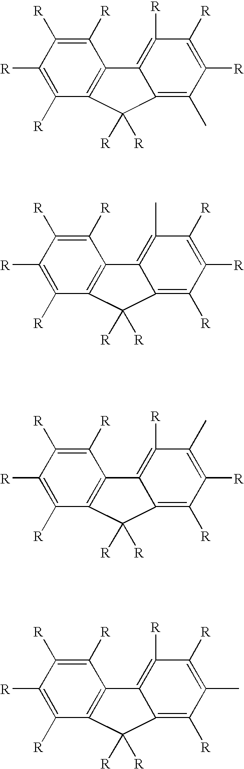

are mentioned.

As the condensed ring compound group, for example,

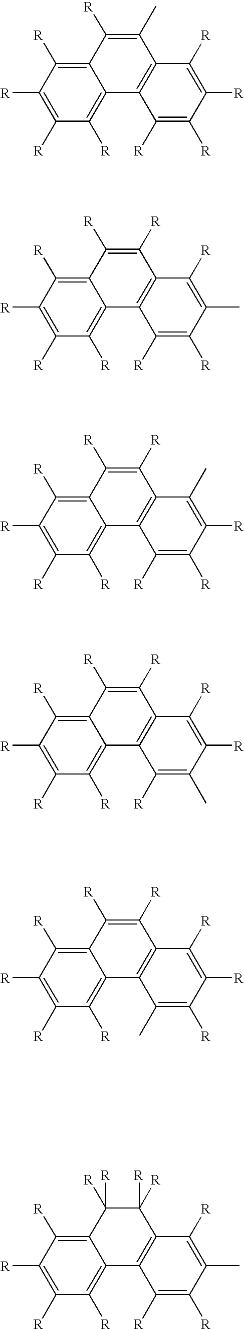

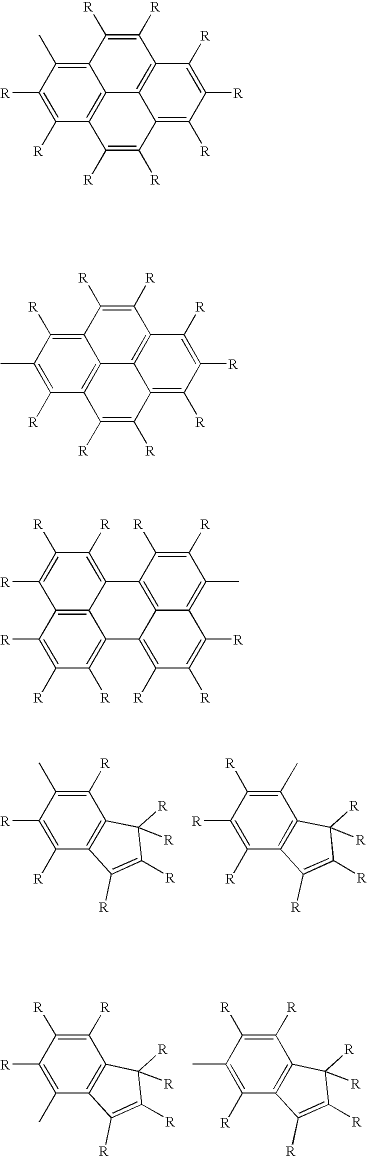

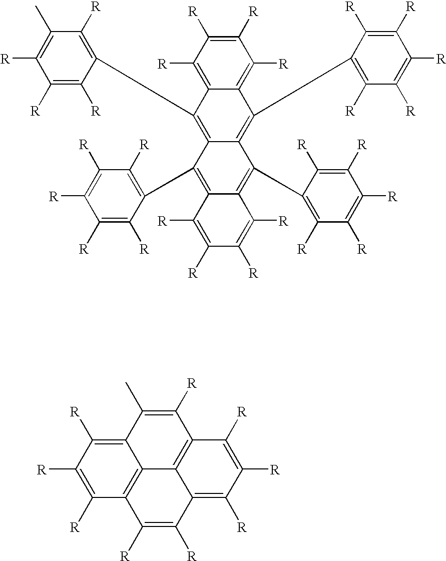

are mentioned.

As the end group for enhancing charge injectability and charge transportability, preferable are monovalent heterocyclic groups, monovalent aromatic amine groups and condensed ring compound groups, more preferable are monovalent heterocyclic groups and condensed ring compound groups.

As the end group for enhancing a light emitting property, preferable are a naphthyl group, anthracenyl group, condensed ring compound groups and monovalent groups derived from heterocyclic coordinated metal complexes.

As the end group having an effect of elongating time necessary for decrease in brilliance of a device, aryl groups having a substituent are preferable and phenyl groups having 1 to 3 alkyl groups are preferable.

As the end group having an effect of enhancing compatibility and mutual action between polymer compounds, aryl groups having a substituent are preferable. By using a phenyl group carrying a substituted alkyl group having 6 or more carbon atoms, an anchor-like effect can be performed. The anchor effect means an effect by which an end group plays an anchor-like role on a coagulated body of a polymer to enhance an mutual action.

As the group for enhancing device properties, the following structures are preferable.

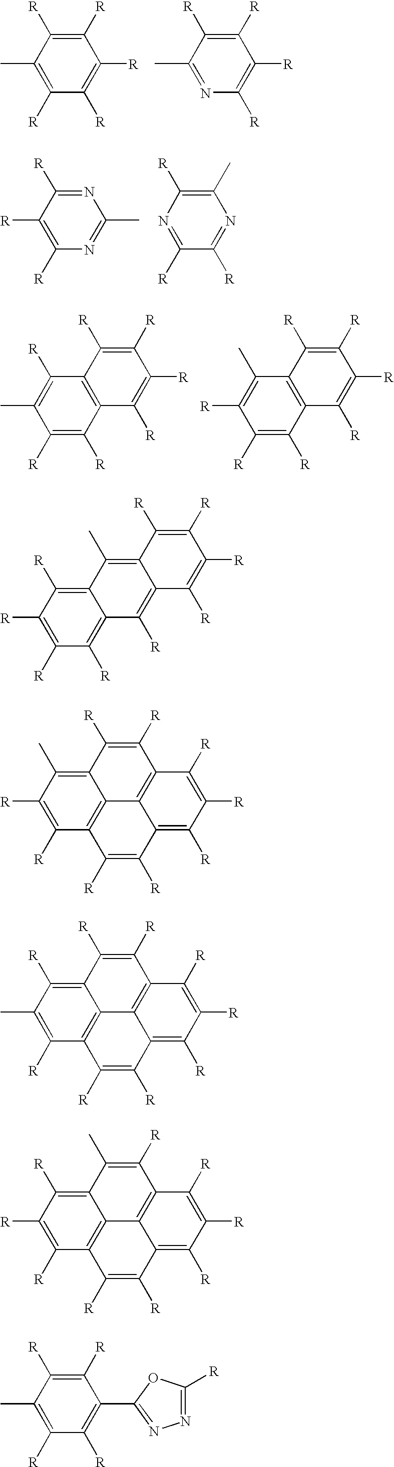

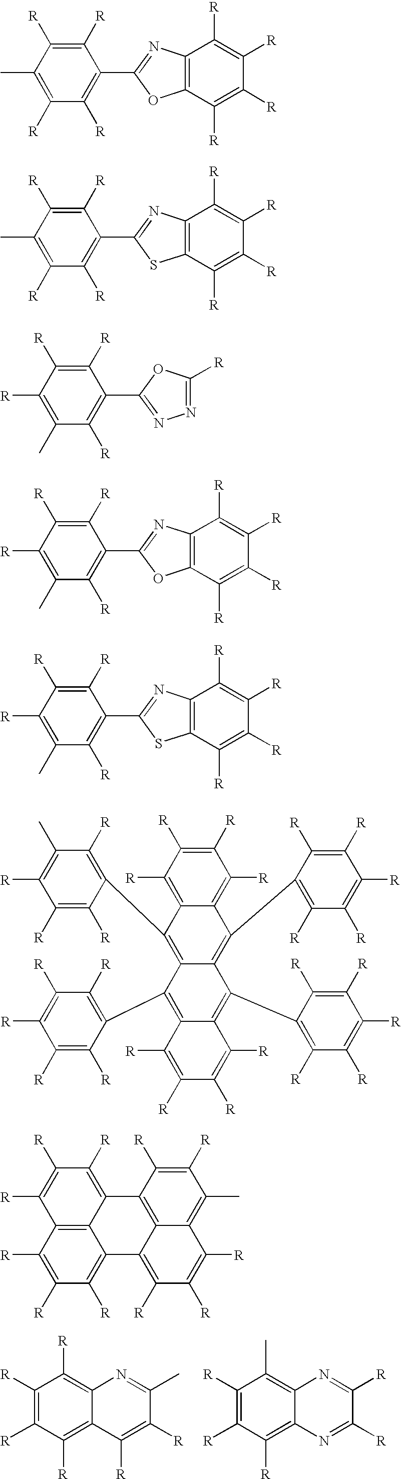

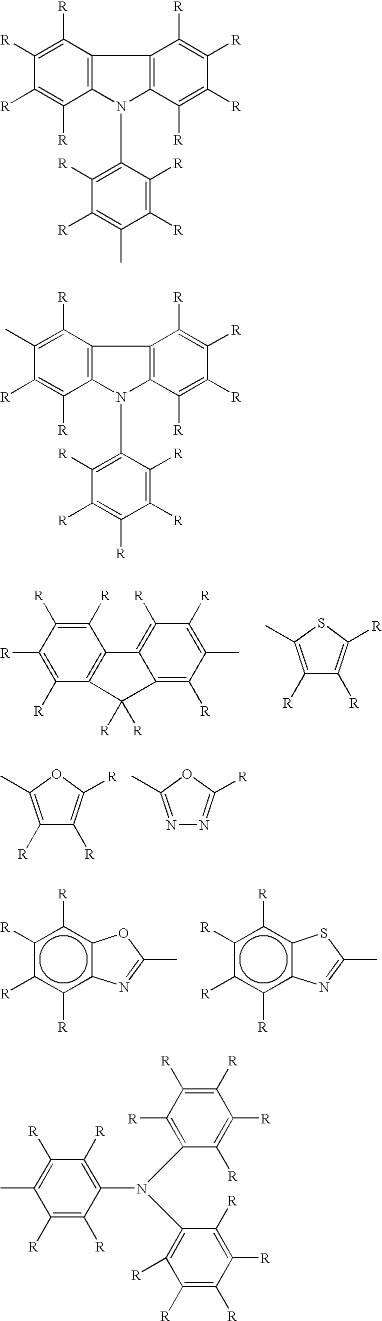

As Rs in the formulae, Rs described above are exemplified, and preferable are hydrogen, cyano group, alkyl groups having 1 to 20 carbon atoms, alkoxy groups, alkylthio groups, aryl groups having 6 to 18 carbon atoms, aryloxy groups and heterocyclic groups having 4 to 14 carbon atoms.

As the group for enhancing device properties, the following structures are more preferable.

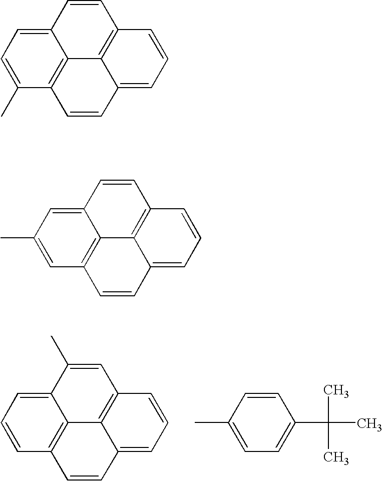

As the good solvent for the polymer compound of the present invention, chloroform, methylene chloride, dichloroethane, tetrahydrofuran, toluene, xylene, mesitylene, tetralin, decalin, n-butylbenzene and the like are exemplified. Depending on the structure and molecular weight of the polymer compound, the polymer compound can be dissolved in these solvents usually in an amount of 0.1 wt % or more.

The polymer compound of the present invention has a fluorescence quantum yield of preferably 50% or more, more preferably 60% or more, further preferably 70% or more from the standpoint of fluorescence intensity, device properties and the like.

A polymer compound having a repeating unit of the formula (1-A) can be produced, by example, by polymerizing a compound of the formula (14) as one of raw materials.

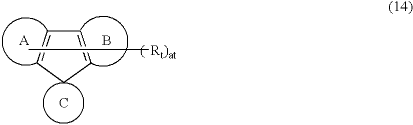

(wherein, R₁ represents a substituent, and is connected to A ring and/or B ring. at represents an integer of 0 or more. A ring, B ring and C ring are the same as described above).

As Rt, preferable are alkyl groups, alkoxy groups, alkylthio groups, aryl groups, aryloxy groups, arylthio groups, arylalkyl groups, arylalkoxy groups, arylalkylthio groups, arylalkenyl groups, arylalkynyl groups, amino group, substituted amino groups, silyl group, substituted silyl groups, halogen atoms, acyl groups, acyloxy groups, imine residues, amide groups, acid imide groups, monovalent heterocyclic groups, carboxyl group, substituted carboxyl groups, nitro group and cyano group, and the same groups as substituents on A ring and B ring described above are exemplified. at represents an integer of 0 or more, and preferably 0 to 3.

Of compounds of the above-described formula (14), compounds of the following formula (14-A) are preferably used in performing polymerization from the standpoint of tendency of increase in degree of polymerization and easiness of control of polymerization.

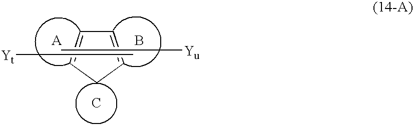

(wherein, Yₜ and Yᵤ each independently represent a substituent correlating with polymerization, and are each connected to A ring and/or B ring. A ring, B ring and C ring are the same as described above).

Regarding raw materials of a polymer compound having a repeating unit of the formula (1-1), (1-2), (1-3), (1-4), mentioned as (14-A) are compounds of the formula (14-1), (14-2), (14-3) or (14-4).

A compound of

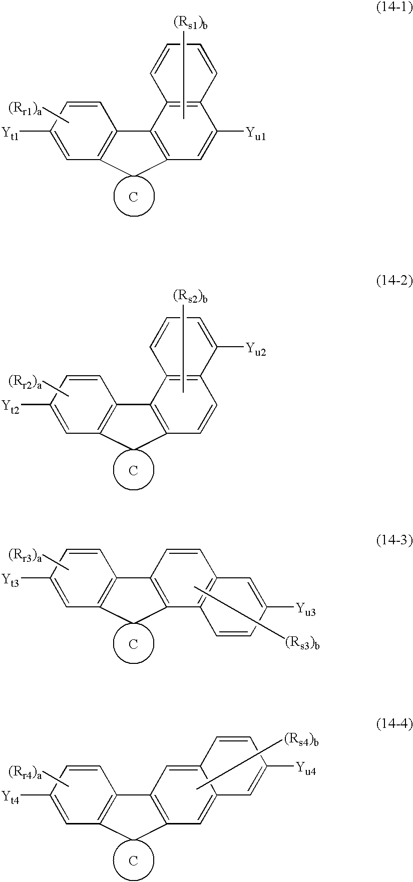

(wherein, Rᵣ₁, Rₛ₁, Rᵣ₂, Rₛ₂, Rᵣ₃, Rₛ₃, Rᵣ₄ and Rₛ₄ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, nitro group or cyano group. a represents an integer of 0 to 3, and b represents an integer of 0 to 5. When Rᵣ₁, Rₛ₁, Rᵣ₂, Rₛ₂, Rᵣ₃, Rₛ₃, Rᵣ₄ and Rₛ₄ are present each in plural number, they may be the same or different. C ring is the same as described above. Yₜ₁, Yᵤ₁, Yₜ₂, Yᵤ₂, Yₜ₃, Yᵤ₃, Yₜ₄ and Yᵤ₄ each independently represent a substituent correlating with polymerization.)
can be polymerized as one of raw materials in carrying out production.

The definitions and specific examples of the alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group and substituted carboxyl group represented by Rᵣ₁, Rₛ₁, Rᵣ₂, R₁₂, Rᵣ₃, Rₛ₃, Rᵣ₄ and Rₛ₄ are the same as the definitions and specific examples thereof of a substituent when A ring and B ring in the above-described formula (1) has a substituent.

It is preferable that the substituents correlating with polymerization represented by Yₜ₁, Yᵤ₁, Yₜ₂, Yᵤ₂, Yₜ₃, Yᵤ₃, Yₜ₄ and Yᵤ₄ are selected each independently from halogen atoms, alkyl sulfonate groups, aryl sulfonate groups and aryl alkyl sulfonate groups, since synthesis thereof is easy and they can be used as raw materials of various polymerization reactions.

It is preferable that Yₜ₁, Yᵤ₁, Yₜ₃, Yᵤ₃, Yₜ₄ and Yᵤ₄ represent a bromine atom in (14-1), (14-2), (14-3) or (14-4), since synthesis thereof is easy, conversion of a functional group is easy and they can be used as raw materials of various polymerization reactions.

It is preferable that a=b=0 in (14-1), (14-2), (14-3) or (14-4) from the standpoint of improving heat resistance.

When polymer compounds having branching in the main chain and having three or more end portions, or dendrimers are produced, a compound of the following formula (14-B) can be polymerized as one of raw materials, for production thereof.

A compound of

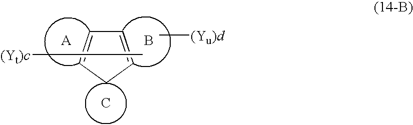

(wherein, C ring, Yₜ and Yᵤ represent the same meanings as described above. c represents 0 or a positive integer and d represents 0 or a positive integer, satisfying 3=c+d=6, preferably 3=c+d=4. When Yₜ and Yᵤ are present each in plural number, they may be the same or different).
can be polymerized as one of raw materials to carry out production.

As the raw material of the formula (14-B), preferably mentioned are compounds of the following formula (14-5), (14-6) or (14-7).

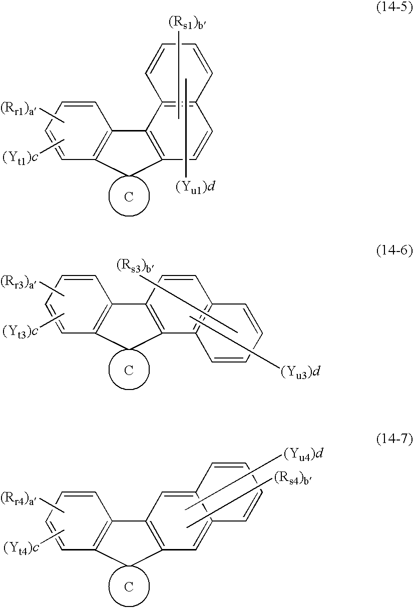

(wherein, Rᵣ₁, Rₛ₁, Rᵣ₂, Rₛ₂, Rᵣ₃, Rₛ₃, Rᵣ₄, Rₛ₄, Yₜ₁, Yᵤ₁, Yₜ₃, Yᵤ₃, Yₜ₄ and Yᵤ₄ represent the same meanings as described above, a′ represents an integer of 0 to 4, b′ represents an integer of 0 to 5, c represents an integer of 0 to 3, d represents an integer of 0 to 5, satisfying a′+c=4, b′+d=6 and 3=c+d=6. When Rᵣ₁, Rₛ₁, Rᵣ₂, Rₛ₂, Rᵣ₃, Rₛ₃, Rᵣ₄, Rₛ₄, Yₜ₁, Yᵤ₁, Yₜ₃, Yᵤ₃, Yₜ₄ and Yᵤ₄ are present each in plural number, they may be the same or different).

It is preferable that a′=b′=0 in (14-5), (14-6) or (14-7) from the standpoint of improving heat resistance.

In production of a polymer compound of the present invention, a polymer compound of higher molecular weight is obtained when a compound of the above-described formula (14-B) or (14-5) to (14-7) is contained in raw material monomers. In this case, a compound of the above-described formula (14-B) or (14-5) to (14-7) is contained in an amount of preferably 10 mol % or less, further preferably 1 mol % or less in raw material monomers, based on 100 mol % of a compound of the above-described formula (14).

When the polymer compound of the present invention has a repeating unit other than the formula (1-A), a compound having two substituents correlating with polymerization as the repeating unit other than the formula (1-A) is advantageously allowed to coexist in polymerization.

As the compound having two polymerizable substituents as the repeating unit other than a repeating unit of the above-described formula (1-A), compounds of the following formulae (21) to (24) are exemplified.

By polymerizing a compound of any one of the following formulae (21) to (24) in addition to a compound of the above-described formula (14), a polymer compound having at least one unit of (3), (4), (5) or (6) in turn in addition to a unit of the above-described formula (1-A) can be produced.

Y₅—Ar₁—Y₆ (21)

Y₇—(Ar₂—X₁)_{ff}—Ar₃—Y₈ (22)

Y₉—Ar₄—X₂—Y₁₀ (23)

Y₁₁—X₃—Y₁₂ (24)

(wherein, Ar₁, Ar₂, Ar₃, Ar₄, ff, X₁, X₂ and X₃ are the same as described above. Y₅, Y₆, Y₇, Y₈, Y₉, Y₁₀, Y₁₁, and Y₁₂ each independently represent a polymerizable substituent).

A polymer compound having a sealed end can be produced by polymerizing a compound of the following formula (25), (27) in addition to the above-described formulae (14), (14-A), (14-B), (14-1) to (14-7) and the above-described formulae (21) to (24), as raw material.

E₁-Y₁₅ (25)

E₂-Y₁₆ (27)

(wherein, E₁ and E₂ represent a monovalent heterocyclic group, aryl group having a substituent, monovalent aromatic amine group or monovalent group derived from a heterocyclic coordinated metal complex, and Y₁₅ and Y₁₆ each independently represent a substituent correlating with polymerization).

As the compound having two substituent correlating with condensation corresponding to the above-described formula (13) as the repeating unit other than a repeating unit of the above-described formula (1-A), compounds of the following formula (15-1) are mentioned.

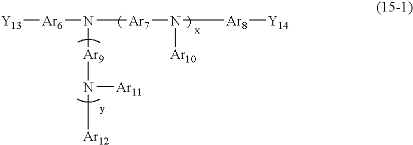

(wherein, the definitions and preferable examples of Ar₆, Ar₇, Ar₈, Ar₉, Ar₁₀, Ar₁₁, Ar₁₂, x and y are the same as described above. Y₁₃ and Y₁₄ each independently represent a substituent correlating with polymerization).

In the production method of the present invention, among substituents correlating with polymerization are halogen atoms, alkyl sulfonate groups, aryl sulfonate groups, aryl alkyl sulfonate groups, borate groups, sulfoniummethyl group, phosphoniummethyl group, phosphonatemethyl group, methyl monohalide groups, —B(OH)₂, formyl group, cyano group, vinyl group and the like.

Here, the halogen atom includes a fluorine atom, chlorine atom, bromine atom and iodine atom.

Examples of the alkyl sulfonate group include a methane sulfonate group, ethane sulfonate group, trifluoromethane sulfonate group and the like. Examples of the aryl sulfonate group include a benzene sulfonate group, p-toluene sulfonate group and the like, and examples of the aryl sulfonate group include a benzyl sulfonate group and the like.

As the borate group, groups of the following formulae are exemplified.

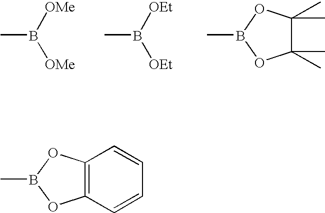

In the formulae, Me represents a methyl group and Et represents an ethyl group.

As the sulfoniummethyl group, groups of the following formulae are exemplified.

—CH₂S⁺Me₂X⁻, —CH₂S⁺Ph₂X⁻

(wherein, X represents a halogen atom and Ph represents a phenyl group).

As the phosphoniummethyl group, groups of the following formula are exemplified.

—CH₂P⁺Ph₃X⁻

(wherein, X represents a halogen atom).

As the phosphonatemethyl group, groups of the following formula are exemplified.

—CH₂PO(OR′)₂

(wherein, X represents a halogen atom and R′ represents an alkyl group, aryl group or arylalkyl group).

Examples of the methyl monohalide group include a methyl fluoride group, methyl chloride group, methyl bromide group and methyl iodide group.

Preferable substituents as the substituent correlating with condensation polymerization vary depending on the kind of the polymerization reaction, and when, for example, a zerovalent nickel complex is used such as in the Yamato coupling reaction and the like, mentioned are halogen atoms, alkyl sulfonate groups, aryl sulfonate groups and aryl alkyl sulfonate groups. When a nickel catalyst or palladium catalyst is used such as in the Suzuki coupling reaction and the like, mentioned are alkyl sulfonate groups, halogen atoms, borate groups, —B(OH)₂ and the like.

The production method of the present invention can be carried out, specifically, by dissolving a compound having several substituents correlating with polymerization in an organic solvent depending on demands, and using, for example, an alkali and suitable catalyst, at temperatures of the melting point or higher and the boiling point or lower of the organic solvent.

For example, known methods which can be used are described in: Organic Reactions, volume 14, page 270-490, John Wiley & Sons, Inc., 1965; Organic Syntheses, Collective Volume VI, page 407-411, John Wiley & Sons, Inc., 1988; Chemical Review (Chem. Rev.), Volume 95, page 2457 (1995); Journal of Organometallic Chemistry (J. Organomet. Chem.), Volume 576, page 147 (1999); and Macromolecular Chemistry, Macromolecular Symposium (Makromol. Chem., Macromol. Symp.), Volume 12th, page 229 (1987).

In the method for producing a polymer compound of the present invention, the condensation polymerization method can be performed by using a known condensation reaction depending on substituents correlating with condensation polymerization of a compound of the above-described formula (14), (14-A), (14-B), (14-1), (14-2), (14-3), (14-4), (14-5), (14-6), (14-7), (21), (22), (23), (24), (25), (27) or (15-1).

In the manufacture method of the polymer compound of the present invention, known condensation reactions can be used as the method of carrying out condensation polymerization. As the method of condensation polymerization, in case of producing double bond, for example, a method described in JP-A-5-202355 is exemplified.

That is, exemplified are: polymerization by Wittig reaction of a compound having formyl group and a compound having phosphonium-methyl group, or a compound having formyl group and phosphonium-methyl group; polymerization by Heck reaction of a compound having vinyl group and a compound having halogen atom; polycondensation by dehydrohalogenation method of a compound having two or more monohalogenated-methyl groups; polycondensation by sulfonium-salt decomposition method of a compound having two or more sulfonium-methyl groups; polymerization by Knoevenagel reaction of a compound having formyl group and a compound having cyano group; and polymerization by McMurry reaction of a compound having two or more formyl groups.

Of these methods, preferable are the methods of polymerization by the Wittig reaction, polymerization by the Heck reaction, polymerization by the Knoevenagel reaction, polymerization by the Suzuki coupling reaction, polymerization by the Grignard reaction and polymerization with a nickel zerovalent complex because of easy control of structures. Among them, the method of polymerization with a nickel zerovalent complex is preferable from the standpoint of easy control of molecular weight and from the standpoint of device properties such as life of polymer LED, light emission initiation voltage, current density, increase in voltage in driving and the like and heat resistance.

Since the polymer compound of the present invention has an asymmetrical skeleton as shown in the formula (1-A) in its repeating unit, there exist orientations of repeating units in the polymer compound. In the case of control of these orientations of repeating units, there are exemplified a method of performing polymerization while controlling the orientation of a repeating unit by selecting a combination of a substituent correlating with condensation polymerization of the corresponding monomer with a polymerization reaction to be used, and other methods.

In the case of control of a linkage of two or more repeating units in a polymer compound of the present invention, there are exemplified a method in which an oligomer having a part or all of repeating units in the intended linkage is synthesized before polymerization, a method for performing polymerization while controlling a linkage of repeating units by selecting substituents correlating with condensation polymerization and polymerization reactions to be used for respective monomers to be used, and other methods.

In the production method of the present invention, it is preferable that substituents correlating with condensation polymerization (Yₜ, Yᵤ, Yₜ₁, Yᵤ₁, Yₜ₂, Yᵤ₂, Yₜ₃, Yᵤ₃, Yₜ₄ and Yᵤ₄ and Y₅, Y₆, Y₇, Y₈, Y₉, Y₁₀, Y₁₁, Y₁₂, Y₁₃, Y₁₄, Y₁₅ and Y₁₆) are selected each independently from halogen atoms, alkyl sulfonate groups, aryl sulfonate groups and aryl alkyl sulfonate groups and condensation polymerization is performed in the presence of a nickel zerovalent complex.

As the raw material compound, mentioned are dihalide compounds, bis(alkyl sulfonate) compounds, bis(aryl sulfonate) compounds, bis(aryl alkyl sulfonate) compounds, or halogen-alkyl sulfonate compounds, halogen-aryl sulfonate compounds, halogen-aryl alkyl sulfonate compounds, alky sulfonate-aryl sulfonate compounds, alkyl sulfonate-aryl alkyl sulfonate compounds and aryl sulfonate-aryl alkyl sulfonate compounds.

In this case, mentioned is a method for producing a polymer compound having repeating unit orientation and a linkage controlled by using, for example, a halogen-alkyl sulfonate compound, halogen-aryl sulfonate compound, halogen-aryl alkyl sulfonate compound, alkyl sulfonate-aryl sulfonate compound, alkyl sulfonate-aryl alkyl sulfonate compound or aryl sulfonate-aryl alkyl sulfonate compound, as a raw material compound.

In the production method of the present invention, it is preferable that substituents correlating with condensation polymerization (Yₜ, Yᵤ, Yₜ₁, Yᵤ₁, Yₜ₂, Yᵤ₂, Yₜ₃, Yᵤ₃, Yₜ₄ and Yᵤ₄ and Y₅, Y₆, Y₇, Y₈, Y₉, Y₁₀, Y₁₁, Y₁₂, Y₁₃, Y₁₄, Y₁₅ and Y₁₆) are selected each independently from halogen atoms, alkyl sulfonate groups, aryl sulfonate groups, aryl alkyl sulfonate groups, boric group and borate groups, the ratio of the sum (K) of mol numbers of boric group (—B(OH)₂) and borate groups to the sum (J) of mol numbers of halogen atoms, alkyl sulfonate groups, aryl sulfonate groups and aryl alkyl sulfonate groups, in all raw material compounds, is substantially 1 (usually, K/J is in the range of 0.7 to 1.2), and condensation polymerization is performed using a nickel catalyst or palladium catalyst.

As specific combinations of raw material compounds, there are mentioned combinations of dihalide compounds, bis(alkyl sulfonate) compounds, bis(aryl sulfonate) compounds or bis(aryl alkyl sulfonate) compounds with diboric acid compounds or diborate compounds.

Further mentioned are halogen-boric acid compounds, halogen-borate compounds, alkyl sulfonate-boric acid compounds, alkyl sulfonate-borate compounds, aryl sulfonate-boric acid compounds, aryl sulfonate-borate compounds, aryl alkyl sulfonate-boric acid compounds, aryl alkyl sulfonate-boric acid compounds and aryl alkyl sulfonate-borate compounds.

In this case, mentioned is a method for producing a polymer compound having repeating unit orientation and a linkage controlled by using, for example, a halogen-boric acid compound, halogen-borate compound, alkyl sulfonate-boric acid compounds, alkyl sulfonate-borate compound, aryl sulfonate-boric acid compound, aryl sulfonate-borate compound, aryl alkyl sulfonate-boric acid compound, aryl alkyl sulfonate-boric acid or aryl alkyl sulfonate-borate compound, as a raw material compound.

The organic solvent varies depending on the compound to be used and the reaction, and it is preferable that the solvent to be used is subjected to a deoxidation treatment sufficiently and the reaction is allowed to progress under an inert atmosphere, in general for suppressing side reactions. Likewise, a dehydration treatment is preferably conducted. Here, a case of a reaction in a two-phase system with water such as the Suzuki coupling reaction is not included.

Exemplified as the solvent are saturated hydrocarbons such as pentane, hexane, heptane, octane, cyclohexane and the like, unsaturated hydrocarbons such as benzene, toluene, ethylbenzene, xylene and the like, halogenated unsaturated hydrocarbons such as carbon tetrachloride, chloroform, dichloromethane, chlorobutane, bromobutane, chloropentane, bromopentane, chlorohexane, bromohexane, chlorocyclohexane, bromocyclohexane and the like, halogenated unsaturated hydrocarbons such as chlorobenzene, dichlorobenzene, trichlorobenzene and the like, alcohols such as methanol, ethanol, propanol, isopropanol, butanol, t-butyl alcohol and the like, carboxylic acids such as formic acid, acetic acid, propionic acid and the like, ethers such as dimethyl ether, diethyl ether, methyl-t-butyl ether, tetrahydrofuran, tetrahydropyran, dioxane and the like, amines such as trimethylamine, triethylamine, N,N,N′,N′-tetramethylethylene diamine, pyridine and the like, and amides such as N,N-dimethylformamide, N,N-dimethylacetamide, N,N-diethylacetamide, N-methylmorpholine, and the like, and these may be used singly or in admixture. Of them, ethers are preferable, and tetrahydrofuran and diethyl ether are further preferable.

For reaction, alkalis or suitable catalysts are appropriately added. These may be selected depending on the reaction to be used. As the alkalis or catalysts, those capable of being dissolved sufficiently in a solvent used in the reaction are preferable. As the method for mixing an alkali or catalyst, there is exemplified a method in which a solution of an alkali or catalyst is added slowly while stirring the reaction liquid under an inert atmosphere such as argon or nitrogen and the like, or adversely, the reaction liquid is added slowly to a solution of an alkali or catalyst.

When the polymer compound of the present invention is used in a polymer LED and the like, the purity thereof has an influence on performances of a device such as a light emitting property and the like, thus, it is preferable that monomers before polymerization are purified by a method such as distillation, sublimation purification, re-crystallization and the like before performing polymerization. It is preferable, after polymerization, to perform a refinement treatment such as reprecipitation purification, fractionation by chromatography, and the like. Among polymer compounds of the present invention, those produced by a method of polymerization using a nickel zerovalent complex are preferable from the standpoint of device properties such as life of polymer LD, light emission initiation voltage, current density, increase in voltage in driving and the like, or heat resistance and the like.

Those in which Yₜ, Yᵤ, Yₜ₁, Yᵤ₁, Yₜ₂, Yᵤ₂, Yₜ₃, Yᵤ₃, Yₜ₄ and Yᵤ₄ represent a halogen among (14-A), (14-B), (14-1), (14-2), (14-3), (14-4), (14-5), (14-6) and (14-7) useful as raw materials of the polymer compound of the present invention are obtained by synthesizing compounds having structures in which Yₜ, Yᵤ, Yₜ₁, Yᵤ₁, Yₜ₂, Yᵤ₂, Yₜ₃, Yᵤ₃, Yₜ₄ and Yᵤ₄ in (14-A), (14-B), (14-1), (14-2), (14-3), (14-4), (14-5), (14-6) and (14-7) are substituted by a hydrogen atom by using, for example, a coupling reaction, ring-opening reaction and the like, then, performing halogenation with various halogenating reagents such as, for example, chlorine, bromine, iodine, N-chlorosuccinimide, N-bromosuccinimide, benzyltrimethylammonium tribromide and the like.

Among (14-A), (14-B), (14-1), (14-2), (14-3), (14-4), (14-5), (14-6) and (14-7) useful as raw materials of the polymer compound of the present invention, those in which Yₜ, Yᵤ, Yₜ₁, Yᵤ₁, Yₜ₂, Yᵤ₂, Yₜ₃, Yᵤ₃, Yₜ₄ and Yᵤ₄ represent a halogen are preferable, and from the standpoint of increase in molecular weight and from the standpoint of easiness of purification after completion of the reaction, the halogen is preferably bromine.

Among (14-A), (14-B), (14-1), (14-2), (14-3), (14-4), (14-5), (14-6) and (14-7) useful as raw materials of the polymer compound of the present invention, those in which Yₜ, Yᵤ, Yₜ₁, Yᵤ₁, Yₜ₂, Yᵤ₂, Yₜ₃, Yᵤ₃, Yₜ₄ and Yᵤ₄ represent an alkyl sulfonate group, aryl sulfonate group or aryl alkyl sulfonate group are obtained by, for example, subjecting compounds having a functional group which can be derived into a hydroxyl group such as an alkoxy group or the like to a coupling reaction, ring-closing reaction and the like to synthesize compounds in which Yₜ, Yᵤ, Yₜ₁, Yᵤ₁, Yₜ₂, Yᵤ₂, Yₜ₃, Yᵤ₃, Yₜ₄ and Yᵤ₄ in (14-A), (14-B), (14-1), (14-2), (14-3), (14-4), (14-5), (14-6) and (14-7) are substituted by a functional group which can be derived into a hydroxyl group such as an alkoxy group or the like, then, synthesizing compounds in which Yₜ, Yᵤ, Yₜ₁, Yᵤ₁, Yₜ₂, Yᵤ₂, Yₜ₃, Yᵤ₃, Yₜ₄ and Yᵤ₄ are substituted by a hydroxyl group by various reactions such as a reaction using a de-alkylation reagent and the like by boron tribromide and the like for example, then, sulfonylating the hydroxyl group with, for example, various sulfonyl chlorides, sulfonic anhydride and the like.

Those in which Yₜ, Yᵤ, Yₜ₁, Yᵤ₁, Yₜ₂, Yᵤ₂, Yₜ₃, Yᵤ₃, Yₜ₄ and Yᵤ₄ represent a boric group or borate group among (14-A), (14-B), (14-1), (14-2), (14-3), (14-4), (14-5), (14-6) and (14-7) useful as raw materials of the polymer compound of the present invention are obtained by synthesizing compounds in which Yₜ, Yᵤ, Yₜ₁, Yᵤ₁, Yₜ₂, Yᵤ₂, Yₜ₃, Yᵤ₃, Yₜ₄ and Yᵤ₄ in (14-A), (14-B), (14-1), (14-2), (14-3), (14-4), (14-5), (14-6) and (14-7) are substituted by a hydrogen atom by the above-described method and the like, then, allowing an alkyl lithium, metal magnesium and the like to act on the compounds, further performing boric acid formation with trimethyl borate to convert a halogen atom into a boric group, and, after boric acid formation, allowing alcohol to act on the boric acid to perform borate formation. Alternatively, compounds in which Yₜ, Yᵤ, Yₜ₁, Yᵤ₁, Yₜ₂, Yᵤ₂, Yₜ₃, Yᵤ₃, Yₜ₄ and Yᵤ₄ in (14-A), (14-B), (14-1), (14-2), (14-3), (14-4), (14-5), (14-6) and (14-7) are substituted by a halogen, trifluoromethane sulfonate group and the like may be synthesized by the above-described method and the like, then, methods described in no-patent documents [Journal of Organic Chemistry, 11995, 60, 7508-7510, Tetrahedron Letters, 1997, 28(19), 3447-3450] and the like may be effected to perform borate formation. Among polymer compounds of the present invention, those produced by a method of polymerization using a nickel zerovalent complex are preferable from the standpoint of a life property.

Next, applications of the polymer compound of the present invention will be described.

The polymer compound of the present invention usually emits fluorescence or phosphorescence in solid state and can be used as a polymer light emitter (light emitting material of high molecular weight).

The polymer compound has an excellent charge transporting ability, and can be suitably used as a polymer LED material or charge transporting material. The polymer LED using this polymer light emitter is a polymer LED of high performance which can be driven at low voltage with high efficiency. Therefore, the polymer LED can be preferably used as back light of a liquid crystal display, or a curved or flat light source for illumination, and in apparatuses such as a segment type display device, dot matrix type flat panel display and the like.

The polymer compound of the present invention can also be used as a coloring matter for laser, a material for organic solar battery, an organic semiconductor for organic transistor, or a material for conductive thin films such as an electrically conductive thin film, organic semiconductor thin film and the like.

Further, the polymer compound can also be used as a material for luminescent thin films emitting fluorescence or phosphorescence.

Next, the application of the compound of the present invention will be described.

The compound of the above-described formula (14) can be used as a material for LED and as a charge transporting material.

Next, the polymer LED of the present invention will be illustrated.

The polymer LED of the present invention is characterized in that an organic layer is present between electrodes composed of an anode and a cathode and the organic layer contains a polymer compound of the present invention.

The organic layer (layer containing an organic substance) may be any one of a light emitting layer, hole transporting layer, electron transporting layer or the like, and it is preferable that the organic layer is a light emitting layer.

Here, the light emitting layer means a layer having a function of light emission, the hole transporting layer means a layer having a function of transporting holes, and the electron transporting layer means a layer having a function of transporting electrons. The electron transporting layer and hole transporting layer are called collectively a charge transporting layer. The light emitting layer, hole transporting layer and electron transporting layer may be used each independently in two or more layers.

When the organic layer is a light emitting layer, the light emitting layer as an organic layer may further contain a hole transporting material, electron transporting material or luminescent material. Here, the luminescent material means a material manifesting fluorescence and/or phosphorescence.

When a polymer compound of the present invention and a hole transporting material are mixed, the mixing ratio of the hole transporting material is 1 wt % to 80 wt %, preferably 5 wt % to 60 wt % based on the whole mixture. When a polymer compound of the present invention and an electron transporting material are mixed, the mixing ratio of the electron transporting material is 1 wt % to 80 wt %, preferably 5 wt % to 60 wt % based on the whole mixture. Further, when a polymer compound of the present invention and a luminescent material are mixed, the mixing ratio of the luminescent material is 1 wt % to 80 wt %, preferably 5 wt % to 60 wt % based on the whole mixture. When a polymer compound of the present invention and a luminescent material, hole transporting material and/or electron transporting material are mixed, the mixing ratio of the luminescent material is 1 wt % to 50 wt %, preferably 5 wt % to 40 wt %, the sum of the hole transporting material and the electron transporting material is 1 wt % to 50 wt %, preferably 5 wt % to 40 wt %, and the content of the polymer compound of the present invention is 99 wt % to 20 wt %, based on the whole mixture.

As the hole transporting material, electron transporting material and luminescent material to be mixed, known lower molecular weight compounds, triplet light emitting complexes or polymer compounds can be used, and polymer compounds are preferably used. Examples of the hole transporting material, electron transporting material and luminescent material as a polymer compound include polyfluorenes, derivatives and copolymers thereof, polyarylenes, derivatives and copolymers thereof, polyarylenevinylenes, derivatives and copolymers thereof, and (co)polymers of aromatic amines and derivatives thereof disclosed in WO 99/13692, WO 99/48160, GB2340304A, WO 00/53656, WO 01/19834, WO 00/55927, GB2348316 and WO 00/46321, WO 00/06665, WO 99/54943, WO 99/54385, U.S. Pat. No. 5,777,070 and WO 98/06773, WO 97/05184, WO 00/35987, WO 00/53655, WO 01/34722, WO 99/24526, WO 00/22027, WO 00/22026, WO 98/27136, U.S. Pat. No. 573,636 and WO 98/21262, U.S. Pat. No. 5,741,921, WO 97/09394, WO 96/29356, WO 96/10617, EP0707020, WO 95/07955, JP-A-2001-181618, JP-A-2001-123156, JP-A-2001-3045, JP-A-2000-351967, JP-A-2000-303066, JP-A-2000-299189, JP-A-2000-252065, JP-A-2000-136379, JP-A-2000-104057, JP-A-2000-80167, JP-A-10-324870, JP-A-10-114891, JP-A-9-111233, JP-A-9-45478 and the like.

As the fluorescent material as a lower molecular weight compound, there can be used, for example, naphthalene derivatives, anthracene or derivatives thereof, perylene or derivatives thereof; coloring matters such as polymethine, xanthene, coumarin, cyanine and the like; metal complexes of 8-hydroxyquinoline or derivatives thereof; aromatic amines, tetraphenylcyclopentadiene or derivatives thereof, or tetraphenylbutadiene or derivatives thereof, and the like.

Specifically, known compounds such as those described in, for example, JP-A Nos. 57-51781 and 59-194393, and the like, can be used.

Examples of the triplet light emitting complex include Ir(ppy)₃ containing iridium as a center metal, Btp₂Ir(acac), PtOEP containing platinum as a center metal, Eu(TTA)₃-phen containing europium as a center metal, and the like.

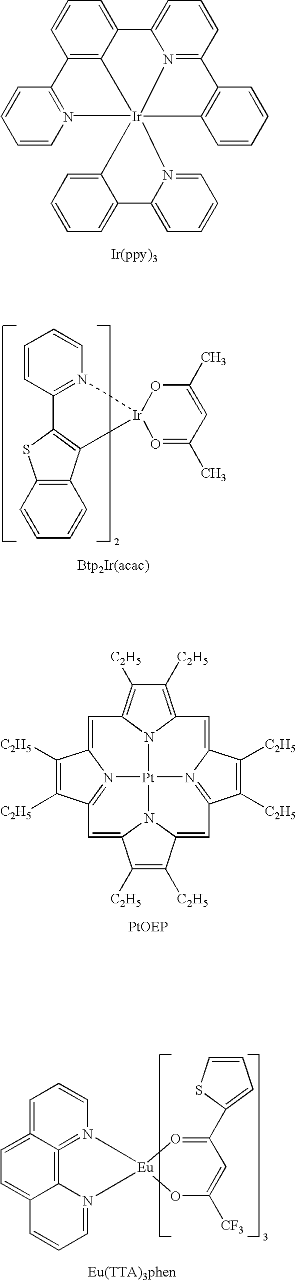

The triplet light emitting complex is described specifically in, for example, Nature, (1998), 395, 151, Appl. Phys. Lett. (1999), 75(1), 4, Proc. SPIE-Int. Soc. Opt. Eng. (2001), 4105 (Organic Light-Emitting Materials and Devices IV), 119, J. Am. Chem. Soc., (2001), 123, 4304, Appl. Phys. Lett., (1997), 71(18), 2596, Syn. Met., (1998), 94(1), 103, Syn. Met., (1999), 99(2), 1361, Adv. Mater., (1999), 11(10), 852, Jpn. J. Appl. Phys., 34, 1883 (1995), and the like.

The polymer compound of the present invention is characterized by high heat resistance. The polymer compound has a glass transition temperature of preferably 130° C. or higher, more preferably 150° C. or higher, further preferably 160° C. or higher.

The polymer composition of the present invention contains at least one material selected from hole transporting materials, electron transporting materials and light emitting materials, and a polymer compound of the present invention, and can be used as a light emitting material or charge transporting material.

The content ratio of at least one material selected from hole transporting materials, electron transporting materials and light emitting materials to a polymer compound of the present invention may be advantageously determined depending on the application, and in the case of an application of a light emitting material, the same content ratio as in the above-mentioned light emitting layer is preferable.

As another embodiment of the present invention, a polymer composition is exemplified containing two or more polymer compounds of the present invention (polymer compound containing a repeating unit of the formula (1-A)).

Specifically, a polymer composition containing two or more polymer compounds containing a repeating unit of the above-described formula (1-A) wherein the total amount of the polymer compounds is 50 wt % or more based on the whole weight is preferable since if it is used as a light emitting material of a polymer LED, then, light emitting efficiency, lifer property and the like are excellent. More preferably, the total amount of the polymer compounds is 70 wt % or more based on the whole weight. The polymer composition of the present invention can give higher device properties such as life and the like than in the case of use of a polymer compound singly in a polymer LED.

A preferable example of the polymer composition is a polymer composition containing at least one polymer compound composed of a repeating unit of the above-described formula (1-A) and at least one copolymer containing a repeating unit of the above-described formula (1-A) in an amount of 50 mol % or more. It is more preferable that the copolymer contains a repeating unit of the above-described formula (1-A) in an amount of 70 mol % or more from the standpoint of light emitting efficiency, life property and the like.

Another preferable example is a polymer composition containing two or more copolymers containing a repeating unit of the above-described formula (1-A) in an amount of 50 mol % or more wherein the copolymers contain also mutually different repeating units. It is more preferable that at least one of the copolymers contains a repeating unit of the above-described formula (1-A) in an amount of 70 mol % or more from the standpoint of light emitting efficiency, life property and the like.

Still another preferable example is a polymer composition containing two or more copolymers containing a repeating unit of the above-described formula (1-A) in an amount of 50 mol % or more wherein the copolymers have an identical combination of repeating units though the copolymerization ratios thereof are mutually different. It is more preferable that at least one of the copolymers contains a repeating unit of the above-described formula (1-A) in an amount of 70 mol % or more from the standpoint of light emitting efficiency, life property and the like.

Alternatively, another preferable example is a polymer composition containing two or more polymer compounds each composed of a repeating unit of the above-described formula (1-A).

A more preferable example of the polymer composition is a polymer composition in which at least one polymer compound contained in the polymer composition exemplified above is a copolymer containing a repeating unit of the above-described formula (1-A) in an amount of 50 mol % or more, and contains also a repeating unit of the above-described formula (13), and wherein the molar ratio of the repeating unit of the above-described formula (1-A) to the repeating unit of the above-described formula (13) is 99:1 to 50:50. It is more preferable that the molar ratio is 98:2 to 70:30 from the standpoint of light emitting efficiency, life property and the like.

A still another preferable example of the polymer composition is a polymer composition containing at least one polymer compound composed of a repeating unit of the above-described formula (1-A) and at least one copolymer containing a repeating unit of the above-described formula (1-A) in an amount of 50 mol % or more, wherein the copolymer is composed of a repeating unit of the above-described formula (1-A) and a repeating unit of the above-described formula (13) and the molar ratio of the repeating unit of the above-described formula (1-A) to the repeating unit of the above-described formula (13) is 90:10 to 50:50. It is more preferable that the molar ratio is 90:10 to 60:40 from the standpoint of light emitting efficiency, life property and the like.

When the polymer compound of the present invention is used as a polymer composition, it is preferable that the repeating unit of the above-described formula (1-A) is selected from repeating units of the above-described formula (1-1) or repeating units of the above-described formula (1-2), more preferable are repeating units of the formula (1-1), and it is further preferable that a and b are 0 in the formula (1-1), from the standpoint of dissolvability in an organic solvent and from the standpoint of device properties such as light emitting efficiency, life property and the like. Further, it is preferable that the repeating unit of the above-described formula (13) is a repeating unit of the above-described formula 134 or a repeating unit of the above-described formula 137, and more preferable are repeating units of the above-described formula (17) or repeating units of the above-described formula (20).

As the polymer composition of the present invention, preferable are a polymer composition containing one polymer compound composed of a repeating unit of the above-described formula (1-A) and one copolymer containing a repeating unit of the above-described formula (1-A) in an amount of 50 mol % or more, and a polymer composition containing two copolymers each containing a repeating unit of the above-described formula (1-A) in an amount of 50 mol % or more wherein the copolymers have an identical combination of repeating units though the copolymerization ratios thereof are mutually different, from the standpoint of dissolvability into an organic solvent and from the standpoint of device properties such as light emitting efficiency, life property and the like.

The polymer composition of the present invention has a polystyrene reduced number average molecular weight of usually about 10³ to 10⁸, preferably 10⁴ to 10⁶. The polystyrene reduced weight average molecular weight is usually about 10³ to 10⁸, and from the standpoint of film formability and from the standpoint of efficiency when processing the composition into a device, preferably 5×10⁴ to 5×10⁶, further preferably 10⁵ to 5×10⁶. Here, the average molecular weight of the polymer composition is a value obtained by GPC analysis of a composition obtained by mixing two or more polymer compounds.

The thickness of a light emitting layer in a polymer LED of the present invention has an optimum value varying depending on a material to be used and may be advantageously selected to give suitable driving voltage and light emitting efficiency, and is for example from 1 nm to 1 μm, preferably from 2 nm to 500 nm, further preferably from 5 nm to 200 nm.

As the method for forming a light emitting layer, for example, a method of film formation from a solution is exemplified. As the method for film formation from a solution, application methods such as a spin coat method, casting method, micro gravure coat method, gravure coat method, bar coat method, roll coat method, wire bar coat method, dip coat method, spray coat method, screen printing method, flexographic printing method, offset printing method, inkjet printing method and the like can be used. From the standpoint of easiness of pattern formation and multicolor divisional painting, preferable are printing methods such as a screen printing method, flexographic printing method, offset printing method, inkjet printing method and the like.

In a solution (ink composition) to be used in the printing method and the like, at least one polymer compound of the present invention may be contained, and additives such as hole transporting materials, electron transporting materials, light emitting materials, solvents, stabilizers and the like may also be contained in addition to the polymer compound of the present invention.

The proportion of the polymer compound of the present invention in the ink composition is usually 20 wt % to 100 wt %, preferably 40 wt % to 100 wt % based on the total weight of the composition excepting a solvent.

When a solvent is contained in the ink composition, the proportion of the solvent is 1 wt % to 99.9 wt %, preferably 60 wt % to 99.5 wt %, further preferably 80 wt % to 99.0 wt % based on the total weight of the composition.

The viscosity of the ink composition varies depending on the printing method, and when the ink composition passes through a discharging apparatus such as in an ink jet printing method and the like, the viscosity at 25° C. is preferably in the range from 2 to 20 mPa·s, more preferably in the range from 5 to 20 mPa·s, further preferably in the range from 7 to 20 mPa·s, for preventing clogging and aviation curve in discharging.

The solution of the present invention may contain additives for controlling viscosity and/or surface tension in addition to the polymer compound of the present invention. As the additives, polymer compounds of higher molecular weight (thickening agents) for enhancing viscosity, poor solvents, compounds of lower molecular weight for lowering viscosity, surfactants for lowering surface tension, and the like may be appropriately combined in use.

As the above-described polymer compound of higher molecular weight, those which are soluble in the same solvent as for the polymer compound of the present invention and do not disturb light emission and charge transportation are advantageous. For example, polystyrene and polymethyl methacrylate of higher molecular weight, or polymer compounds of the present invention having higher molecular weight, and the like can be used. The weight average molecular weight is preferably 500000 or more, and more preferably 1000000 or more.

A poor solvent can also be used as a thickening agent. That is, viscosity can be enhanced by adding a small amount of poor solvent for solid components in a solution. When a poor solvent is added for this purpose, the kind and addition amount of the solvent may be advantageously selected so as not to cause deposition of solid components in a solution. When stability in preservation is also taken into consideration, the amount of a poor solvent is preferably 50 wt % or less, further preferably 30 wt % or less based on the whole solution.

The solution of the present invention may contain also an antioxidant in addition to the polymer compound of the present invention, for improving preservation stability. As the antioxidant, those which are soluble in the same solvent as for the polymer compound of the present invention and dot not disturb light emission and charge transportation are advantageous, and exemplified are phenol-based antioxidants, phosphorus-based antioxidants and the like.

As the solvent used for film formation from a solvent, those capable of dissolving or uniformly dispersing the polymer compound of the present invention are preferable. Exemplified as the solvent are chlorine-based solvents such as chloroform, methylene chloride, 1,2-dichloroethane, 1,1,2-trichloroethane, chlorobenzene, o-dichlorobenzene and the like, ether solvents such as tetrahydrofuran, dioxane and the like, aromatic hydrocarbon solvents such as toluene, xylene and the like, aliphatic hydrocarbon solvents such as cyclohexane, methylcyclohexane, n-pentane, n-hexane, n-heptane, n-octane, n-nonane, n-decane and the like, ketone solvents such as acetone, methyl ethyl ketone, cyclohexanone and the like, ester solvents such as ethyl acetate, butyl acetate, ethyl cellosolve acetate and the like, polyhydric alcohols such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerin, 1,2-hexanediol and the like and derivatives thereof, alcohol solvents such as methanol, ethanol, propanol, isopropanol, cyclohexanol and the like, sulfoxide solvents such as dimethyl sulfoxide and the like, and amide solvents such as N-methyl-2-pyrrolidone, N,N-dimethylformamide and the like. These organic solvents can be used singly or in combination of two or more. Of the above-described solvents, at least one organic solvent having a structure containing at least one benzene ring and having a melting point of 0° C. or lower and a boiling point of 100° C. or higher is preferably contained.

Regarding the kind of the solvent, aromatic hydrocarbon solvents, aliphatic hydrocarbon solvents, ester solvents and ketone solvents are preferable, and toluene, xylene, ethylbenzene, diethylbenzene, trimethylbenzene, n-propylbenzene, i-propylbenene, n-butylbenzene, i-butylbenzene, s-butylbenzene, anisole, ethoxybenzene, 1-methylnaphthalene, cyclohexane, cyclohexanone, cyclohexylbenzene, bicyclohexyl, cyclohexenylcyclohexanone, n-heptylcyclohexane, n-hexylcyclohexane, 2-propylcyclohexanone, 2-heptanone, 3-heptanone, 4-heptanone, 2-octanone, 2-nonanone, 2-decanone, tetralin, dicyclohexylketone, cyclohexanone, phenylhexane and decalin are preferable, and at least one of xylene, anisole, cyclohexylbenzene, bicyclohexyl, cyclohexanone, phenylhexane and decalin is more preferably contained, from the standpoint of dissolvability into an organic solvent, uniformity in film formation, viscosity property and the like.

The number of the kinds of solvents in a solution is preferably 2 or more, more preferably 2 to 3, further preferably 2 from the standpoint of film formability and from the standpoint of device properties and the like.

When two solvents are contained in a solution, one solvent of them may be in solid state at 25° C. From the standpoint of film formability, it is preferable that one solvent has a boiling point of 180° C. or higher and another solvent has a boiling point of 180° C. or lower, and it is more preferable that one solvent has a boiling point of 200° C. or higher and another solvent has a boiling point of 180° C. or lower. From the standpoint of viscosity, it is preferable that both of two solvents dissolve a polymer compound in an amount of 1 wt % or more at 60° C., and it is preferable that one of two solvents dissolves a polymer compound in an amount of 1 wt % or more at 25° C.

When three solvents are contained in a solution, one to two solvents of them may be in solid state at 25° C. From the standpoint of film formability, it is preferable that at least one of three solvents has a boiling point of 180° C. or higher and at least one solvent has a boiling point of 180° C. or lower, and it is more preferable that at least one of three solvents has a boiling point of 200° C. or higher and 300° C. or lower and at least one solvent has a boiling point of 180° C. or lower. From the standpoint of viscosity, it is preferable that two of three solvents dissolve a polymer compound in an amount of 1 wt % or more at 60° C., and it is preferable that one of three solvents dissolves a polymer compound in an amount of 1 wt % or more at 25° C.

When two or more solvents are contained in a solution, the proportion of a solvent having the highest boiling point is preferably 40 to 90 wt %, more preferably 50 to 90 wt %, further preferably 65 to 85 wt % based on the weight of all solvents in the solution from the standpoint of viscosity and film formability.

As the solution of the present invention, preferable from the standpoint of viscosity and film formability are a solution composed of anisole and bicyclohexyl, a solution composed of anisole and cyclohexylbenzene, a solution composed of xylene and bicyclohexyl and a solution composed of xylene and cyclohexylbenzene.

From the standpoint of dissolvability of a polymer compound into a solvent, the difference between the solubility parameter of a solvent and the solubility parameter of a polymer compound is preferably 10 or less, more preferably 7 or less.

The solubility parameter of a solvent and the solubility parameter of a polymer compound can be measured by a method described in “Solvent Handbook (Kodansha Ltd. Publishers, 1976)”.

The polymer compounds of the present invention to be contained in a solution may be used singly or in combination of two or more, and polymer compounds other than the polymer compound of the present invention may be contained in a range not deteriorating device properties and the like.

The solution of the present invention may contain water, metals and salts thereof in an amount of 1 to 1000 ppm. As the metal, specifically mentioned are lithium, sodium, calcium, potassium, iron, copper, nickel, aluminum, zinc, chromium, manganese, cobalt, platinum, iridium and the like. Further, silicon, phosphorus, fluorine, chlorine and bromine may be contained in an amount of 1 to 1000 ppm.

Using the solution of the present invention, a thin film can be manufactured by a spin coat method, casting method, micro gravure coat method, gravure coat method, bar coat method, roll coat method, wire bar coat method, dip coat method, spray coat method, screen printing method, flexographic printing method, offset printing method, inkjet printing method and the like. Particularly, the solution of the present invention is preferably used in applications for film formation by a screen printing method, flexographic printing method, offset printing method or inkjet printing method, and more preferably used in an application for film formation by an inkjet printing method.

In the case of manufacturing of a thin film using the solution of the present invention, baking at temperatures of 100° C. or higher is possible and lowering of device properties is very small even if baking is performed at a temperature of 130° C., since the polymer compound contained in the solution has high glass transition temperature. Depending on the kind of the polymer compound, baking at temperatures of 160° C. or higher is also possible.

As the thin film which can be manufactured using the solution of the present invention, exemplified are luminescent thin films, electrically conductive thin films and organic semiconductor thin films.

The luminescent thin film of the present invention has a light emission quantum yield of preferably 50% or more, more preferably 60% or more, further preferably 70% or more, from the standpoint of brilliance and light emission voltage of a device and the like.

The electrically conductive thin film of the present invention preferably has a surface resistance of 1 KO/□ or less. By doping the thin film with Lewis acid, ionic compound and the like, electrically conductivity can be enhanced. The surface resistance is more preferably 100 O/□ or less, further preferably 10 O/□.

The organic semiconductor thin film of the present invention has either higher value of electron mobility or hole mobility of preferably 10⁻⁵ cm²/V/second or more, more preferably 10⁻³ cm²/V/second or more, further preferably 10⁻¹ cm²/V/second or more.

An organic transistor can be obtained by forming the organic semiconductor thin film on a Si substrate on which an insulation film made of SiO₂ and the like an a gate electrode have been formed, and forming a source electrode and a drain electrode with Au and the like.

In the polymer light emitting device of the present invention, the maximum outer quantum yield when a voltage of 3.5 V or more is applied between an anode and a cathode is preferably 1% or more, more preferably 1.5% or more, from the standpoint of brilliance of a device and the like.

Furthermore, exemplified are: a polymer-LED in which a layer containing a conductive polymer is disposed between at least one of the above electrodes and a light emitting layer adjacently to the electrode; and a polymer LED in which a buffer layer having a mean film thickness of 2 nm or less is disposed between at least one of the above electrodes and a light emitting layer adjacently to the electrode.

Specifically, the following structures a)-d) are exemplified.

a) anode/light emitting layer/cathode
b) anode/hole transporting layer/light emitting layer/cathode
c) anode/light emitting layer/electron transporting layer/cathode
d) anode/hole transporting layer/light emitting layer/electron transporting layer/cathode
(wherein, “/” indicates adjacent lamination of layers. Hereinafter, the same).

As the polymer LED of the present invention, those having a polymer compound of the present invention contained in a hole transporting layer and/or electron transporting layer are also include.

When the polymer compound of the present invention is used in a hole transporting layer, it is preferable that the polymer compound of the present invention is a polymer compound containing a hole transportable group, and specifically, copolymers with an aromatic amine, copolymers with stilbene, and the like are exemplified.

When the polymer compound of the present invention is used in an electron transporting layer, it is preferable that the polymer compound of the present invention is a polymer compound containing an electron transportable group, and specifically, copolymers with oxadiazole, copolymers with triazole, copolymers with quinoline, copolymers with quinoxaline, copolymers with benzothiadiazole, and the like are exemplified.

When the polymer LED of the present invention has a hole transporting layer, exemplified as the hole transporting material to be used are polyvinylcarbazole or derivatives thereof, polysilane or derivatives thereof, polysiloxane derivatives having an aromatic amine at a side chain or main chain, pyrazoline derivatives, arylamine derivatives, stilbene derivatives, triphenyldiamine derivatives, polyaniline or derivatives thereof, polythiophene or derivatives thereof, polypyrrole or derivatives thereof, poly(p-phenylenevinylene) or derivatives thereof, poly(2,5-thienylenevinylene) or derivatives thereof, and the like.

Specifically, those described in JP-A Nos. 63-70257, 63-175860, 2-135359, 2-135361, 2-209988, 3-37992 and 3-152184, and the like are exemplified as the hole transporting material.

Of them, preferable as the hole transporting material to be used in a hole transporting layer are polymer hole transporting materials such as polyvinylcarbazole or derivatives thereof, polysilane or derivatives thereof, polysiloxane derivatives having an aromatic amine at a side chain or main chain, polyaniline or derivatives thereof, polythiophene or derivatives thereof, poly(p-phenylenevinylene) or derivatives thereof, poly(2,5-thienylenevinylene) or derivatives thereof, and the like, and further preferable are polyvinylcarbazole or derivatives thereof, polysilane or derivatives thereof, and polysiloxane derivatives having an aromatic amine at a side chain or main chain.

As the hole transporting material as a lower molecular weight compound, exemplified are pyrazoline derivatives, arylamine derivatives, stilbene derivatives and triphenyldiamine derivatives. In the case of a lower molecular weight hole transporting material, the material is preferably dispersed in a polymer binder.

As the polymer binder to be mixed, those not extremely disturbing charge transportation are preferable, and those showing no strong absorption for visible light are suitably used. As the polymer binder, exemplified are poly(N-vinylcarbazole), polyaniline or derivatives thereof, polythiophene or derivatives thereof, poly(p-phenylenevinylene) or derivatives thereof, poly(2,5-thienylenevinylene) or derivatives thereof, polycarbonates, polyacrylates, polymethyl acrylate, polymethyl methacrylate, polystyrene, polyvinyl chloride, polysiloxane and the like.

Polyvinylcarbazole or derivatives thereof are obtained by, for example, cation polymerization or radical polymerization from a vinyl monomer.

As polysilane or derivatives thereof, exemplified are compounds described in Chem. Rev., vol. 89, p. 1359 (1989) and United Kingdom Patent GB2300196, and the like. Also as the synthesis method, those described in these documents can be used, and particularly, the Kipping method is suitably used.

As polysiloxane or derivatives thereof, those having the structure of the above-described lower molecular weight hole transporting material at a side chain or main chain are suitably used, since a siloxane skeleton structure has scarce hole transportability. Particularly, those having a hole transportable aromatic amine at a side chain or main chain are exemplified.

Though the method for film formation of a hole transporting layer is not restricted, exemplified in the case of a lower molecular weight hole transporting material is a method for film formation from a mixed solution with a polymer binder. Exemplified in the case of a polymer hole transporting material is a method for film formation from a solution.

As the solvent used in film formation from a solution, those capable of dissolving or uniformly dispersing a hole transporting material are preferable. Exemplified as the solvent are chlorine solvents such as chloroform, methylene chloride, 1,2-dichloroethane, 1,1,2-trichloroethane, chlorobenzene, o-dichlorobenzene and the like, ether solvents such as tetrahydrofuran, dioxane and the like, aromatic hydrocarbon solvents such as toluene, xylene and the like, aliphatic hydrocarbon solvents such as cyclohexane, methylcyclohexane, n-pentane, n-hexane, n-heptane, n-octane, n-nonane, n-decane and the like, ketone solvents such as acetone, methyl ethyl ketone, cyclohexanone and the like, ester solvents such as ethyl acetate, butyl acetate, ethyl cellosolve acetate and the like, polyhydric alcohols such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerin, 1,2-hexanediol and the like and derivatives thereof, alcohol solvents such as methanol, ethanol, propanol, isopropanol, cyclohexanol and the like, sulfoxide solvents such as dimethyl sulfoxide and the like, and amide solvents such as N-methyl-2-pyrrolidone, N,N-dimethylformamide and the like. These organic solvents can be used singly or in combination of two or more.

As the method for film formation from a solution, applications methods such as a spin coat method, casting method, micro gravure coat method, gravure coat method, bar coat method, roll coat method, wire bar coat method, dip coat method, spray coat method, screen printing method, flexographic printing method, offset printing method, inkjet printing method and the like, from a solution, can be used.

The optimum value of the thickness of the hole transporting layer varies depending on the material to be used and may be selected so as to give suitable values of driving voltage and light emitting efficiency, and at least thickness not causing generation of pin holes is necessary, however, too large thickness is undesirable because the driving voltage of a device increases. Therefore, the thickness of the hole transporting layer is, for example, from 1 nm to 1 μm, preferably from 2 nm to 500 nm, further preferably from 5 nm to 200 nm.

When the polymer LED of the present invention has an electron transporting layer, known materials can be used as the electron transporting material to be used, and exemplified are oxadiazole derivatives, anthraquinodimethane or derivatives thereof, benzoquinone or derivatives thereof, naphthoquinone or derivatives thereof, anthraquinone or derivatives thereof, tetracyanoanthraquinodimethane or derivatives thereof, fluorenone derivatives, diphenyldicyanoethylene or derivatives thereof, diphenoquinone derivatives; metal complexes of 8-hydroxyquinoline or derivatives thereof; polyquinoline or derivatives thereof, polyquinoxaline or derivatives thereof, polyfluorene or derivatives thereof, and the like.

Specifically, those described in JP-A Nos. 63-70257, 63-175860, 2-135359, 2-135361, 2-209988, 3-37992 and 3-152184, and the like are exemplified.

Of them, preferable are oxadiazole derivatives, benzoquinone or derivatives thereof, anthraquinone or derivatives thereof; metal complexes of 8-hydroxyquinoline or derivatives thereof; polyquinoline or derivatives thereof, polyquinoxaline or derivatives thereof and polyfluorene or derivatives thereof, and further preferable are 2-(4-biphenylyl)-5-(4-t-butylphenyl)-1,3,4-oxadiazole, benzoquinone, anthraquinone, tris(8-quinolinol)aluminum, and polyquinoline.

Though the method for film formation of the electron transporting layer is not particularly restricted, exemplified in the case of a lower molecular weight electron transporting material is a vacuum vapor deposition method from a powder or a method for film formation from a solution or molten condition, and in the case of a polymer electron transporting material is a method for film formation from a solution or molten condition, respectively. In film formation from a solution or molten condition, the above-described polymer binder may be used together.

As the solvent to be used for film formation from a solution, those capable of dissolving or uniformly dispersing electron transporting materials and/or polymer binders are preferable. Exemplified as the solvent are chlorine-based solvents such as chloroform, methylene chloride, 1,2-dichloroethane, 1,1,2-trichloroethane, chlorobenzene, o-dichlorobenzene and the like, ether solvents such as tetrahydrofuran, dioxane and the like, aromatic hydrocarbon solvents such as toluene, xylene and the like, aliphatic hydrocarbon solvents such as cyclohexane, methylcyclohexane, n-pentane, n-hexane, n-heptane, n-octane, n-nonane, n-decane and the like, ketone solvents such as acetone, methyl ethyl ketone, cyclohexanone and the like, ester solvents such as ethyl acetate, butyl acetate, ethyl cellosolve acetate and the like, polyhydric alcohols such as ethylene glycol, ethylene glycol monobutyl ether, ethylene glycol monoethyl ether, ethylene glycol monomethyl ether, dimethoxyethane, propylene glycol, diethoxymethane, triethylene glycol monoethyl ether, glycerin, 1,2-hexanediol and the like and derivatives thereof, alcohol solvents such as methanol, ethanol, propanol, isopropanol, cyclohexanol and the like, sulfoxide solvents such as dimethyl sulfoxide and the like, and amide solvents such as N-methyl-2-pyrrolidone, N,N-dimethylformamide and the like. These organic solvents can be used singly or in combination of two or more.

As the method for film formation from a solution or molten condition, application methods such as a spin coat method, casting method, micro gravure coat method, gravure coat method, bar coat method, roll coat method, wire bar coat method, dip coat method, spray coat method, screen printing method, flexographic printing method, offset printing method, inkjet printing method and the like can be used.

The polymer compound of the present invention can be used also as a polymer electric field effect transistor. Regarding the structure of the polymer electric field effect transistor, it is usually advantageous that a source electrode and a drain electrode are provided in close proximity to an active layer composed of a polymer and gate electrodes are provided sandwiching an insulation layer in close proximity to the active layer.

The polymer electric field effect transistor is usually formed on a supporting substrate. The material of the supporting substrate is not particularly restricted providing it does not disturb a property as the electric field effect transistor, and also a glass substrate, flexible film substrate and plastic substrate can also be used.

The electric field effect transistor can be produced by known methods, for example, a method described in JP-A No. 5-110069.

It is very advantageous and preferable for production, to use a polymer soluble in an organic solvent in forming the active layer. As the method for film formation from a solution prepared by dissolving a polymer in an organic solvent, application methods such as a spin coat method, casting method, micro gravure coat method, gravure coat method, bar coat method, roll coat method, wire bar coat method, dip coat method, spray coat method, screen printing method, flexographic printing method, offset printing method, inkjet printing method and the like can be used.

A sealed polymer electric field effect transistor obtained by performing sealing after production of a polymer electric field effect transistor is preferable. By this, a polymer electric field effect transistor is blocked from atmospheric air and lowering of a property of a polymer electric field effect transistor can be suppressed.

As the sealing method, there are mentioned a method for covering with a UV hardening resin, thermosetting resin, inorganic SiONx film and the like, a method for pasting glass plates or films together with a UV hardening resin, thermosetting resin and the like, and other methods. For effectively blocking from atmospheric air, it is preferable that a process from production of a polymer electric field effect transistor to completion of insulation thereof is performed without exposing to atmospheric air (for example, in dried nitrogen atmosphere, in vacuum and the like).

The optimum value of the thickness of the electron transporting layer varies depending on the material to be used and may be selected so as to give suitable values of driving voltage and light emitting efficiency, and at least thickness not causing generation of pin holes is necessary, however, too large thickness is undesirable because the driving voltage of a device increases. Therefore, the thickness of the electron transporting layer is, for example, from 1 nm to 1 μm, preferably from 2 nm to 500 nm, further preferably from 5 nm to 200 nm.

Of charge transporting layers provided in close proximity to an electrode, those having a function of improving efficiency of charge injection from an electrode and having an effect of lowering driving voltage of a device are in general called particularly as a charge injection layer (hole injection layer, electron injection layer) in some cases.

Further, for improvement of close adherence with an electrode and for improvement of charge injection from an electrode, the above-described charge injection layer or an insulation layer having a thickness of 2 nm or less may be provided adjacent to an electrode, and for improvement of close adherence of an interface and for prevention of mixing, and the like, a thin buffer layer may be inserted into an interface of a charge transporting layer or light emitting layer.

The order and number of layers to be laminated and the thickness of each layer can be appropriately selected in view of light emitting efficiency and device life.

In the present invention, as the polymer LED having a charge injecting layer (electron injecting layer, hole injecting layer) provided, there are listed a polymer LED having a charge injecting layer provided adjacent to a cathode and a polymer LED having a charge injecting layer provided adjacent to an anode.

For example, the following structures e) to p) are specifically exemplified.

e) anode/charge injecting layer/light emitting layer/cathode
f) anode/light emitting layer/charge injecting layer/cathode
g) anode/charge injecting layer/light emitting layer/charge injecting layer/cathode
h) anode/charge injecting layer/hole transporting layer/light emitting layer/cathode
i) anode/hole transporting layer/light emitting layer/charge injecting layer/cathode
j) anode/charge injecting layer/hole transporting layer/light emitting layer/charge injecting layer/cathode
k) anode/charge injecting layer/light emitting layer/electron transporting layer/cathode
l) anode/light emitting layer/electron transporting layer/charge injecting layer/cathode
m) anode/charge injecting layer/light emitting layer/electron transporting layer/charge injecting layer/cathode
n) anode/charge injecting layer/hole transporting layer/light emitting layer/electron transporting layer/cathode
o) anode/hole transporting layer/light emitting layer/electron transporting layer/charge injecting layer/cathode
p) anode/charge injecting layer/hole transporting layer/light emitting layer/electron transporting layer/charge injecting layer/cathode

The polymer LED of the present invention includes also those in which a polymer compound of the present invention is contained in a hole transporting layer and/or electron transporting layer as described above.

The polymer LED of the present invention includes also those in which a polymer compound of the present invention is contained in a hole injection layer and/or electron injection layer. When a polymer compound of the present invention is used in a hole injection layer, it is preferably used simultaneously with an electron receptive compound. When a polymer compound of the present invention is used in an electron transporting layer, it is preferably used simultaneously with an electron donative compound. Here, for simultaneous use, mentioned are methods of mixing, copolymerization, introduction as a side chain, and the like.

As the specific examples of the charge injecting layer, there are exemplified layers containing an conducting polymer, layers which are disposed between an anode and a hole transporting layer and contain a material having an ionization potential between the ionization potential of an anode material and the ionization potential of a hole transporting material contained in the hole transporting layer, layers which are disposed between a cathode and an electron transporting layer and contain a material having an electron affinity between the electron affinity of a cathode material and the electron affinity of an electron transporting material contained in the electron transporting layer, and the like.

When the above-described charge injecting layer is a layer containing an conducting polymer, the electric conductivity of the conducting polymer is preferably 10⁻⁵ S/cm or more and 10³ S/cm or less, and for decreasing the leak current between light emitting pixels, more preferably 10⁻⁵ S/cm or more and 10² S/cm or less, further preferably 10⁻⁵ S/cm or more and 10¹ S/cm or less.

Usually, to provide an electric conductivity of the conducting polymer of 10⁻⁵ S/cm or more and 10³ S/cm or less, a suitable amount of ions are doped into the conducting polymer.

Regarding the kind of an ion doped, an anion is used in a hole injecting layer and a cation is used in an electron injecting layer. As examples of the anion, a polystyrene sulfonate ion, alkylbenzene sulfonate ion, camphor sulfonate ion and the like are exemplified, and as examples of the cation, a lithium ion, sodium ion, potassium ion, tetrabutyl ammonium ion and the like are exemplified.

The thickness of the charge injecting layer is for example, from 1 nm to 100 nm, preferably from 2 nm to 50 nm.

Materials used in the charge injecting layer may properly be selected in view of relation with the materials of electrode and adjacent layers, and there are exemplified conducting polymers such as polyaniline and derivatives thereof, polythiophene and derivatives thereof, polypyrrole and derivatives thereof, poly(phenylene vinylene) and derivatives thereof, poly(thienylene vinylene) and derivatives thereof, polyquinoline and derivatives thereof, polyquinoxaline and derivatives thereof, polymers containing aromatic amine structures in the main chain or the side chain, and the like, and metal phthalocyanine (copper phthalocyanine and the like), carbon and the like.

The insulation layer having a thickness of 2 nm or less has function to make charge injection easy. As the material of the above-described insulation layer, metal fluoride, metal oxide, organic insulation materials and the like are listed. As the polymer LED having an insulation layer having a thickness of 2 nm or less, there are listed polymer LEDs having an insulation layer having a thickness of 2 nm or less provided adjacent to a cathode, and polymer LEDs having an insulation layer having a thickness of 2 nm or less provided adjacent to an anode.

Specifically, there are listed the following structures q) to ab) for example.

q) anode/insulation layer having a thickness of 2 nm or less/light emitting layer/cathode
r) anode/light emitting layer/insulation layer having a thickness of 2 nm or less/cathode
s) anode/insulation layer having a thickness of 2 nm or less/light emitting layer/insulation layer having a thickness of 2 nm or less/cathode
t) anode/insulation layer having a thickness of 2 nm or less/hole transporting layer/light emitting layer/cathode
u) anode/hole transporting layer/light emitting layer/insulation layer having a thickness of 2 nm or less/cathode
v) anode/insulation layer having a thickness of 2 nm or less/hole transporting layer/light emitting layer/insulation layer having a thickness of 2 nm or less/cathode
w) anode/insulation layer having a thickness of 2 nm or less/light emitting layer/electron transporting layer/cathode
x) anode/light emitting layer/electron transporting layer/insulation layer having a thickness of 2 nm or less/cathode
y) anode/insulation layer having a thickness of 2 nm or less/light emitting layer/electron transporting layer/insulation layer having a thickness of 2 nm or less/cathode
z) anode/insulation layer having a thickness of 2 nm or less/hole transporting layer/light emitting layer/electron transporting layer/cathode
aa) anode/hole transporting layer/light emitting layer/electron transporting layer/insulation layer having a thickness of 2 nm or less/cathode
ab) anode/insulation layer having a thickness of 2 nm or less/hole transporting layer/light emitting layer/electron transporting layer/insulation layer having a thickness of 2 nm or less/cathode

As the polymer LED of the present invention, in the device structures shown by the above a)-ab), exemplified are those which contain a polymer compound of the present invention in any of a hole injection layer, a hole transporting layer, a light emitting layer, an electron transporting layer or an electron injection layers.

The substrate forming the polymer LED of the present invention may preferably be that does not change in forming an electrode and layers of organic materials, and there are exemplified glass, plastics, polymer film, silicon substrates and the like. In the case of a opaque substrate, it is preferable that the opposite electrode is transparent or semitransparent.

Usually, at least one of the electrodes consisting of an anode and a cathode, is transparent or semitransparent. It is preferable that the anode is transparent or semitransparent.

As the material of this anode, electron conductive metal oxide films, semitransparent metal thin films and the like are used. Specifically, there are used indium oxide, zinc oxide, tin oxide, and composition thereof, i.e. indium/tin/oxide (ITO), and films (NESA and the like) fabricated by using an electron conductive glass composed of indium/zinc/oxide, and the like, and gold, platinum, silver, copper and the like. Among them, ITO, indium/zinc/oxide, tin oxide are preferable. As the fabricating method, a vacuum vapor deposition method, sputtering method, ion plating method, plating method and the like are used. As the anode, there may also be used organic transparent conducting films such as polyaniline or derivatives thereof, polythiophene or derivatives thereof and the like.

The thickness of the anode can be appropriately selected while considering transmission of a light and electric conductivity, and for example, from 10 nm to 10 μm, preferably from 20 nm to 1 μm, further preferably from 50 nm to 500 nm.

Further, for easy charge injection, there may be provided on the anode a layer comprising a phthalocyanine derivative conducting polymers, carbon and the like, or a layer having an average film thickness of 2 nm or less comprising a metal oxide, metal fluoride, organic insulating material and the like.

As the material of a cathode used in the polymer LED of the present invention, that having lower work function is preferable. For example, there are used metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, or alloys comprising two of more of them, or alloys comprising one or more of them with one or more of gold, silver, platinum, copper, manganese, titanium, cobalt, nickel, tungsten and tin, graphite or graphite intercalation compounds and the like. Examples of alloys include a magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may be formed into a laminated structure of two or more layers.

The thickness of the cathode can be appropriately selected while considering transmission of a light and electric conductivity, and for example, from 10 nm to 10 μm, preferably from 20 nm to 1 μm, further preferably from 50 nm to 500 nm.

As the method for fabricating a cathode, there are used a vacuum vapor deposition method, sputtering method, lamination method in which a metal thin film is adhered under heat and pressure, and the like. Further, there may also be provided, between a cathode and an organic layer, a layer comprising an conducting polymer, or a layer having an average film thickness of 2 nm or less comprising a metal oxide, metal fluoride, organic insulation material and the like, and after fabrication of the cathode, a protective layer may also be provided which protects the polymer LED. For stable use of the polymer LED for a long period of time, it is preferable to provide a protective layer and/or protective cover for protection of the device in order to prevent it from outside damage.

As the protective layer, there can be used a polymeric compound, metal oxide, metal fluoride, metal borate and the like. As the protective cover, there can be used a glass plate, a plastic plate the surface of which has been subjected to lower-water-permeation treatment, and the like, and there is suitably used a method in which the cover is pasted with an device substrate by a thermosetting resin or light-curing resin for sealing. If space is maintained using a spacer, it is easy to prevent an device from being injured. If an inner gas such as nitrogen and argon is sealed in this space, it is possible to prevent oxidation of a cathode, and further, by placing a desiccant such as barium oxide and the like in the above-described space, it is easy to suppress the damage of an device by moisture adhered in the production process. Among them, any one means or more are preferably adopted.

The polymer LED of the present invention can be used for a flat light source, a segment display, a dot matrix display, and a liquid crystal display as a back light, etc.

For obtaining light emission in plane form using the polymer LED of the present invention, an anode and a cathode in the plane form may properly be placed so that they are laminated each other. Further, for obtaining light emission in pattern form, there is a method in which a mask with a window in pattern form is placed on the above-described plane light emitting device, a method in which an organic layer in non-light emission part is formed to obtain extremely large thickness providing substantial non-light emission, and a method in which any one of an anode or a cathode, or both of them are formed in the pattern. By forming a pattern by any of these methods and by placing some electrodes so that independent on/off is possible, there is obtained a display device of segment type which can display digits, letters, simple marks and the like. Further, for forming a dot matrix device, it may be advantageous that anodes and cathodes are made in the form of stripes and placed so that they cross at right angles. By a method in which a plurality of kinds of polymeric compounds emitting different colors of lights are placed separately or a method in which a color filter or luminescence converting filter is used, area color displays and multi color displays are obtained. A dot matrix display can be driven by passive driving, or by active driving combined with TFT and the like. These display devices can be used as a display of a computer, television, portable terminal, portable telephone, car navigation, view finder of a video camera, and the like.

Further, the above-described light emitting device in plane form is a thin self-light-emitting one, and can be suitably used as a flat light source for back-light of a liquid crystal display, or as a flat light source for illumination. Further, if a flexible plate is used, it can also be used as a curved light source or a display.

Examples are shown below for illustrating the present invention further in detail, however, the present invention is not limited to them.

### (Number Average Molecular Weight and Weight Average Molecular Weight)

Here, as the number average molecular weight and weight average molecular weight, polystyrene reduced number average molecular weight and polystyrene reduced weight average molecular weight were measured by GPC (manufactured by Shimadzu Corporation.; LC-10Avp). A polymer to be subjected to measurement was dissolved in tetrahydrofuran so as give a concentration of about 0.5 wt %, and the resultant solution was injected in an amount of 50 μL into GPC. A the mobile phase of GPC, tetrahydrofuran was used and allowed to flow at a flow rate of 0.6 mL/min. Regarding the column, two columns of TSKgel Super HM-H (manufactured by Tosoh Corporation) and one column of TSKgel Super H2000 (manufactured by Tosoh Corporation) were connected. As the detector, a differential refractive index detector (manufactured by Shimadzu Corporation: RID-10A) was used.

### (Fluorescence Spectrum)

Measurement of fluorescence spectrum was carried out by the following method. A 0.8 wt % solution of a polymer was spin-coated on quartz to form a thin film of the polymer. This thin film was excited at a wavelength of 350 nm, and fluorescence spectrum was measured using a fluorescence spectrophotometer (manufactured by Horiba Ltd.: Fluorolog). For obtaining relative fluorescence intensity on the thin film, fluorescence spectrum in which wave numbers are plotted against the intensity of Raman line of water as standard was integrated in a spectrum measurement range, and allocated with absorbances at excitation wavelengths, measured using a spectrophotometer (manufactured by Varian; Cary5E).

### (Glass Transition Temperature)

The glass transition temperature was measured by DSC (DSC2920, manufactured by TA Instruments).

### (HPLC Measurement)

Measuring apparatus: Agilent 1100LC

Measuring condition: L-Column ODS, 5 μm, 2.1 mm×150 mm;

Liquid A: acetonitrile, Liquid B: THF

Gradient

Liquid B:

0% (60 min.)→10% up/min→100% (10 min.)

Sample concentration: 5.0 mg/mL (THF solution)

Injection amount: 1 μL

Detection wavelength: 350 nm

### (Measurement of Fluorescence Quantum Yield)

A 0.8% toluene solution of a polymer compound was prepared, and the solution was spin-coated on a quartz plate at a revolution of 1400 rpm to obtain a uniform thin film. This thin film was subjected to fluorescence quantum yield measurement using an organic EL light emission property evaluation apparatus manufactured by Optel K.K. In measurement, an excited light obtained by dispersing a light from a xenon lamp through a diffraction grating was used. The center wavelength of the excited light was 350 nm, the measurement range of the excited light intensity was 330 nm to 370 nm, and the measurement wavelength range of the fluorescence intensity was 400 nm to 800 nm.

### SYNTHESIS EXAMPLE 1

### Synthesis of 1-bromo-4-t-butyl-2,6-dimethylbenzene

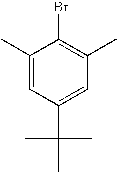

Under an inert atmosphere, 225 g of acetic acid was charged into a 500 ml three-necked flask, and to this was added 24.3 g of 5-t-butyl-m-xylene. Subsequently, 31.2 g of bromine was added, then, the solution was reacted at 15 to 20° C. for 3 hours.

The reaction liquid was added to 500 ml of water and the deposited precipitate was filtrated. The precipitate was washed with 250 ml of water twice, to obtain 34.2 g of white solid.

### Synthesis of N,N′-diphenyl-N,N′-bis(4-t-butyl-2,6-dimethylphenyl)-1,4-phenylenediamine

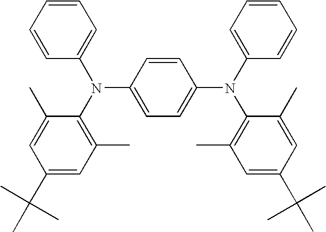

Under an inert atmosphere, 36 ml of deaerated dehydrated toluene was charged into a 100 ml three-necked flask, and to this was added 0.63 g of tri(t-butyl)phosphine. Subsequently, 0.41 g of tris(dibenzylideneacetone)dipalladium, 9.6 g of 1-bromo-4-t-butyl-2,6-dimethylbenzene, 5.2 g of t-butoxysodium and 4.7 g of N,N′-diphenyl-1,4-phenylenediamine were added, then, the solution was reacted at 100° C. for 3 hours. The reaction liquid was added to 300 ml of saturated saline, and extracted with 300 ml of chloroform warmed at about 50° C. The solvent was distilled off, then, 100 ml of toluene was added and the mixture was heated until dissolving of solid and allowed to cool, then, the resultant precipitate was filtrated to obtain 9.9 g of white solid.

### Synthesis of N,N′-bis(4-bromophenyl)-N,N′-bis(4-t-butyl-2,6-dimethylphenyl)-1,4-phenylenediamine

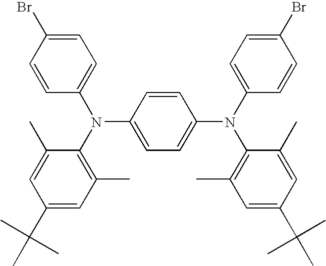

Under an inert atmosphere, 350 ml of dehydrated N,N-dimethylformamide was charged into a 1000 ml three-necked flask, and 5.2 g of N′-diphenyl-N,N′-bis(4-t-butyl-2,6-dimethylphenyl)-1,4-phenylenediamine was dissolved, then, a N-bromosuccinimide 3.5 g/N,N-dimethylformamide solution was dropped in an ice bath, and the resultant solution was reacted over night and day.

150 ml of water was added to the reaction solution, the deposited precipitate was filtrated and washed with 50 ml of methanol twice to obtain 4.4 g of white solid.

¹H-NMR (300 MHz/THF-d8):

δ (ppm)=1.3 [s, 18H], 2.0 [s, 12H], 6.6 to 6.7 [d, 4H], 6.8 to 6.9 [br, 4H], 7.1 [s, 4H], 7.2 to 7.3 [d, 4H]

MS (FD+) M+738

### SYNTHESIS EXAMPLE 2

### Synthesis of N,N′-diphenyl-N,N′-bis(4-t-butyl-2,6-dimethylphenyl)-benzidine

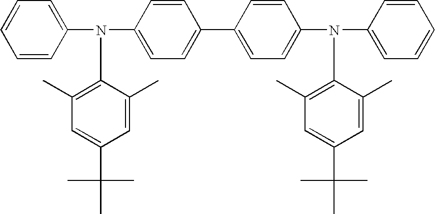

Under an inert atmosphere, 1660 ml of dehydrated toluene was charged into a 300 ml three-necked flask, and to this was added 275.0 g of N,N′-diphenylbenzidine and 449.0 g of 4-t-butyl-2,6-dimethylbromobenzene. Subsequently, 7.48 g of tris(dibenzylideneacetone)dipalladium and 196.4 g of t-butoxysodium were added, then, 5.0 g of tri(t-butyl)phosphine was added. Thereafter, the resultant solution was reacted at 105° C. for 7 hours.

To the reaction liquid was added 2000 ml of toluene and the solution was filtrated through cerite, the filtrate was washed with 1000 ml of water three times, then, concentrated to 700 ml. To this was added 1600 ml of a toluene/methanol (1:1) solution, and the deposited crystal filtrated and washed with methanol. 479.4 g of white solid was obtained.

### Synthesis of N,N′-bis(4-bromophenyl)-N,N′-bis(4-t-butyl-2,6-dimethylphenyl)-benzidine

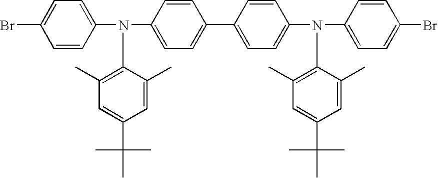

Under an inert atmosphere, into 4730 g of chloroform was dissolved 472.8 g of the above-mentioned N,N′-diphenyl-N,N′-bis(4-t-butyl-2,6-dimethylphenyl)-benzidine, then, 281.8 g of N-bromosuccinimide was charged in 12-divided portions under light shielding in an ice bath over 1 hour, and the solution was reacted for 3 hours.

1439 ml of chloroform was added to the reaction liquid, and filtrated, and a chloroform solution of the filtrate was washed with 2159 ml of 5% sodium thiosulfate, and the toluene solvent was distilled off to obtain a white crystal. The resultant white crystal was re-crystallized from toluene/ethanol, to obtain 678.7 g of a white crystal.

MS (APCI(+)): (M+H)⁺ 815.2

### EXAMPLE 1

### Synthesis of Compound C

### (Synthesis of Compound A)

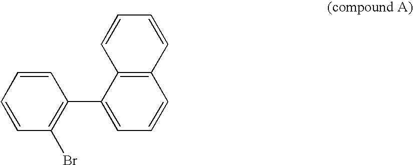

Into a three-necked round bottomed flask (500 ml) was added 25.1 g of 2-bromoiodobenzene, 20.0 g of naphthaleneboronic acid, 0.427 g of tetrakistriphenylphosphinepalladium (0) and 25.5 g of potassium carbonate, then, 92 ml of toluene and 91 ml of water were added and the mixture was refluxed while heating. The solution was stirred for 24 hours, then, cooled down to room temperature. The reaction solution was filtrated through silica gel, and the solvent was distilled off to obtain 25 g of a crude product. The product was purified by silica gel column chromatography, then, re-crystallization was performed using hexane, to obtain 12.2 g of compound A as while solid.

### (Synthesis of Compound B)

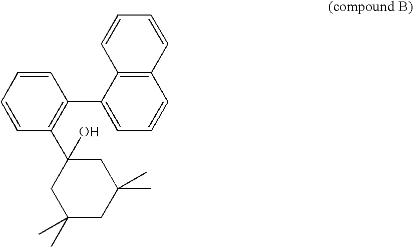

Into a nitrogen-purged three-necked round bottomed flask (500 ml) was added 10.0 g of compound A and 120 ml of tetrahydrofuran and the mixture was stirred at −78° C. 43.9 ml of a n-butyllithium hexane solution was added and the resultant solution was stirred for 2 hours, then, 13.7 ml of 3,3,5,5-tetramethylcyclohexanone was dropped. The temperature was raised up to room temperature, then, cooled to 0° C., and 200 ml of a saturated ammonium chloride aqueous solution was added to terminate the reaction, and the resultant solution was washed with 100 ml of water twice. The resulting organic layer was filtrated through silica gel, and the solvent was distilled off, to obtain a crude product containing 21 g of compound B. The product was used in the subsequent reaction without purification.

### (Synthesis of Compound C)

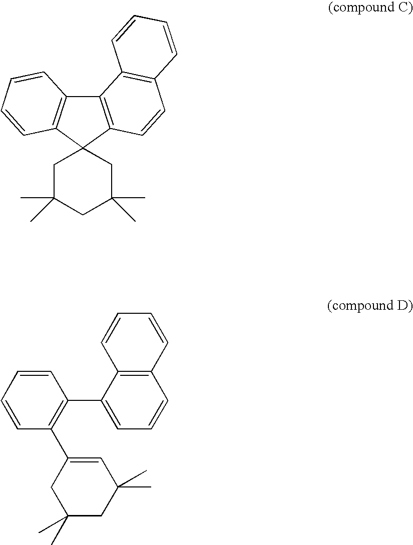

Into a nitrogen-purged three-necked round bottomed flask (500 ml) was added 82 ml of a boron trifluoride ether complex and 300 ml of dichloromethane, and the mixture was cooled to 0° C., and into this solution was dropped a solution prepared by dissolving 21 g of compound B in 100 ml of dichloromethane. The resulting solution was stirred for 30 minutes at room temperature, then, 200 ml of water was added to terminate the reaction, and extraction was performed using 300 ml of chloroform, the resultant organic layer was filtrated through silica gel, and the solvent was distilled off, to obtain 17.6 g of a crude product. The product was purified by silica gel column chromatography, to obtain 4.5 g of compound C in the form of oil and 4.6 g of compound D.

(Synthesis of Compound C from Compound D)

4.60 g of compound D was charged into a nitrogen-purged 100 ml eggplant-shaped flask and to this was added 50 ml of toluene and the mixture was stirred. 2.57 g of p-toluenesulfonic acid was added and the resulting mixture was heated for 3 hours under heat reflux. The solution was cooled down to room temperature to stop the reaction, and washed with 50 ml of a saturated sodium hydrogen carbonate aqueous solution added, and washed with 100 ml of water. The resultant solution was filtrated through pre-coated silica gel to obtain 4 g of a crude product containing compound C.

### EXAMPLE 2

### Synthesis of Compound E

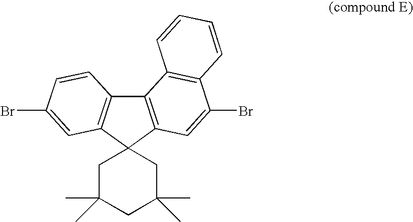

Under a nitrogen atmosphere, into a 300 ml three-necked flask was charged 2.23 g of compound C, to this was added 20 ml of dichloromethane to cause dissolution, and 40 ml of acetic acid was added and the mixture was heated up to 50° C. in an oil bath. 1.68 g of zinc chloride was added while heating and the mixture was stirred, and a solution prepared by dissolving 5.06 g of benzyltrimethylammonium tribromide in 20 ml of dichloromethane was added over 30 minutes under reflux with heating. Further, the mixture was stirred at 50° C. for 1 hour, and cooled down to room temperature, then, 100 ml of water was added to terminate the reaction. The reaction solution was separated, and the aqueous layer was extracted with 50 ml of chloroform, and the organic layers were combined. The combined organic layer was washed with 100 ml of a saturated sodium thiosulfate aqueous solution, then, washed with 150 ml of a saturated sodium hydrogen carbonate aqueous solution and 100 ml of water. The resultant organic layer was filtrated through pre-coated silica gel, to obtain 3.9 g of a crude product. This mixture was purified by re-crystallizing from hexane, to obtain 2.39 g of compound E as white solid.

¹H-NMR (300 MHz/CDCl₃)

δ 8.63 (1H, d), 8.36 (1H, d), 8.11 (1H, d), 7.95 (1H, s), 7.70 to 7.61 (3H, m), 7.52 (1H, dd), 1.89 (2H, d), 1.82 (2H, d), 1.68 (2H, s), 1.18 (3H, s), 1.17 (3H, s)

### EXAMPLE 3

### Synthesis of Polymer Compound 1

Compound E (0.474 g) and 2,2′-bipyridyl (0.401 g) were dissolved in 68 mL of dehydrated tetrahydrofuran, then, to this solution was added bis(1,5-cyclooctadiene)nickel(0) {Ni(COD)₂} (0.706 g) under a nitrogen atmosphere, and the mixture was heated up to 60° C. and reacted for 3 hours. This reaction liquid was cooled down to room temperature, and dropped into a mixed solution of 25% ammonia water 3 mL/methanol 68 mL/ion exchanged water 68 mL and the mixture was stirred for 1 hour, then, the deposited precipitate was filtrated and dried under reduced pressure, and dissolved in 29 ml of toluene. After dissolution, 2.28 g of radiolite was added and the mixture was stirred for 30 minutes, and insoluble materials were filtrated. The resultant filtrate was purified by passing through an alumina column. Next, 56 mL of 5.2% hydrochloric acid water was added and the mixture was stirred for 3 hours, then, the aqueous phase was removed. Subsequently, 56 mL of 4% ammonia water was added and the mixture was stirred for 2 hours, then, the aqueous phase was removed. Further, about 56 mL of ion exchanged water was added to the organic layer and the mixture was stirred for 1 hour, then, the aqueous phase was removed. Thereafter, the organic layer was poured into 112 ml of methanol and the mixture was stirred for 1 hour, and the deposited precipitate was filtrated and dried under reduced pressure. The yield of the resultant polymer (hereinafter, referred to as polymer compound 1) was 0.19 g. The polystyrene reduced number average molecular weight was 4.2×10⁴ and the polystyrene reduced weight average molecular weight was 5.8×10⁵.

The glass transition temperature of polymer compound 1 was measured to fin a temperature of 160° C.

### EXAMPLE 4

### Synthesis of Polymer Compound 2

Compound E (0.332 g), N,N′-bis(4-bromophenyl)-N,N′-bis(4-t-butyl-2,6-dimethylphenyl)-benzidine (0.232 g) and 2,2′-bipyridyl (0.401 g) were dissolved in 68 mL of dehydrated tetrahydrofuran, then, to this solution was added bis(1,5-cyclooctadiene)nickel(0) {Ni(COD)₂} (0.706 g) under a nitrogen atmosphere, and the mixture was heated up to 60° C. and reacted for 3 hours. This reaction liquid was cooled down to room temperature, and dropped into a mixed solution of 25% ammonia water 3 mL/methanol 68 mL/ion exchanged water 68 mL and the mixture was stirred for 1 hour, then, the deposited precipitate was filtrated and dried under reduced pressure, and dissolved in 29 ml of toluene. After dissolution, 2.28 g of radiolite was added and the mixture was stirred for 30 minutes, and insoluble materials were filtrated. The resultant filtrate was purified by passing through an alumina column. Next, 56 mL of 5.2% hydrochloric acid water was added and the mixture was stirred for 3 hours, then, the aqueous phase was removed. Subsequently, 56 mL of 4% ammonia water was added and the mixture was stirred for 2 hours, then, the aqueous phase was removed. Further, about 56 mL of ion exchanged water was added to the organic layer and the mixture was stirred for 1 hour, then, the aqueous phase was removed. Thereafter, the organic layer was poured into 112 ml of methanol and the mixture was stirred for 1 hour, and the deposited precipitate was filtrated and dried under reduced pressure. The yield of the resultant polymer (hereinafter, referred to as polymer compound 2) was 0.31 g. The polystyrene reduced number average molecular weight was 2.1×10⁴ and the polystyrene reduced weight average molecular weight was 3.4×10⁵.

### EXAMPLE 5

### Synthesis of Polymer Compound 3

Compound E (0.426 g), N,N′-bis(4-bromophenyl)-N,N′-bis(4-t-butyl-2,6-dimethylphenyl)-1,4-phenylenediamine (0.070 g) and 2,2′-bipyridyl (0.401 g) were dissolved in 34 mL of dehydrated tetrahydrofuran, then, to this solution was added bis(1,5-cyclooctadiene)nickel(0) (Ni(COD)₂) (0.706 g) under a nitrogen atmosphere, and the mixture was heated up to 60° C. and reacted for 3 hours. This reaction liquid was cooled down to room temperature, and dropped into a mixed solution of 25% ammonia water 3 mL/methanol 34 mL/ion exchanged water 34 mL and the mixture was stirred for 1 hour, then, the deposited precipitate was filtrated and dried under reduced pressure, and dissolved in 29 ml of toluene. After dissolution, 3.5 g of radiolite was added and the mixture was stirred for 30 minutes, and insoluble materials were filtrated. The resultant filtrate was purified by passing through an alumina column. Next, 56 mL of 5.2% hydrochloric acid water was added and the mixture was stirred for 3 hours, then, the aqueous phase was removed. Subsequently, 56 mL of 4% ammonia water was added and the mixture was stirred for 2 hours, then, the aqueous phase was removed. Further, about 56 mL of ion exchanged water was added to the organic layer and the mixture was stirred for 1 hour, then, the aqueous phase was removed. Thereafter, the organic layer was poured into 112 ml of methanol and the mixture was stirred for 1 hour, and the deposited precipitate was filtrated and dried under reduced pressure. The yield of the resultant polymer (hereinafter, referred to as polymer compound 3) was 0.20 g. The polystyrene reduced number average molecular weight was 4.0×10⁴ and the polystyrene reduced weight average molecular weight was 6.0×10⁵.

### EXAMPLE 6

### Synthesis of Polymer Compound 4

Compound E (0.100 g), compound F (0.113 g) and 2,2′-bipyridyl (0.125 g) were dissolved in 72 mL of dehydrated tetrahydrofuran, then, to this solution was added bis(1,5-cyclooctadiene)nickel(0) (Ni(COD)₂) (0.220 g) under a nitrogen atmosphere, and the mixture was stirred, and heated up to 60° C., then, reacted for 3 hours. This reaction liquid was cooled down to room temperature, diluted with 140 ml of toluene, then, 30 g of 5.2% hydrochloric acid was added and the mixture was stirred for 0.5 hours, then, the aqueous layer was removed. Subsequently, 30 g of 4% ammonia water was added, the mixture was stirred for 0.4 hours, then, the aqueous layer was removed. Further, 30 g of ion exchanged water was added to the organic layer and the mixture was stirred for 0.45 hours, then, the aqueous layer was removed. The solvent was distilled off, then, the residue was re-dissolved in 100 g of toluene, and the supernatant was purified by passing through an alumina column. Distilling off of the solvent and drying under reduced pressure were carried out. The yield of the resultant polymer (hereinafter, referred to as polymer compound 4) was 0.07 g. The polystyrene reduced number average molecular weight and weight average molecular weight were Mn=4.6×10⁴ and Mw=1.9×10⁵, respectively.

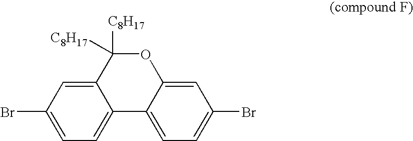

### EXAMPLE 7

### Synthesis of Compound H

### (Synthesis of Compound G)

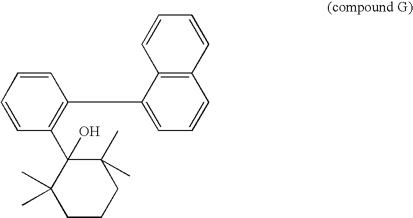

Into a nitrogen-purged 100 ml two-necked round bottomed flask was charged 3.00 g of compound A and 30 ml of tetrahydrofuran was added and the mixture was stirred at −78° C. 7.9 ml of a n-butyllithium hexane solution was added, then, 2.10 ml of 2,2,6,6-tetramethylcyclohexanone was dissolved in 2 ml of tetrahydrofuran and the resulting solution was dropped. The solution was heated up to room temperature, then, stirred for 2 hours. The solution was cooled to 0° C., and 50 ml of a saturated ammonium chloride aqueous solution was added to terminate the reaction and the mixture was washed twice with 20 ml of water. The resulting organic layer was filtrated through silica gel, and the solvent was distilled off to obtain 3.87 g of a crude product of compound G. The product was used in the subsequent reaction without purification.

### (Synthesis of Compound H)

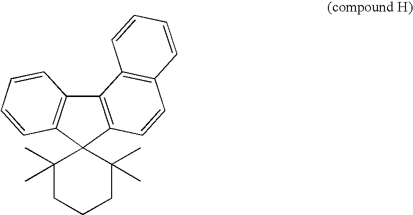

Under a nitrogen atmosphere, into a 200 ml two-necked flask was charged 13.6 ml of a boron trifuoride ether complex, and 30 ml of dichloromethane was added and the mixture was stirred. A solution prepared by dissolving 3.8 g of compound G in 40 ml of dichloromethane was added while cooling in a water bath. The mixture was stirred for 1 hour, then, 100 ml of water was added to terminate the reaction and the mixture was extracted twice with 50 ml of chloroform. The resultant organic layer was filtrated through pre-coated silica gel, to obtain 3.7 g of a crude product of compound H.

¹H-NMR (300 MHz/CDCl₃)

δ8.85 (1H, d), 8.42 (1H, d), 8.06 (1H, d), 7.94 to 7.90 (2H, m), 7.73 (1H, d), 7.63 to 7.57 (1H, m), 7.52 to 7.40 (2H, m), 7.29 to 7.26 (1H, m), 1.95 (6H, brs), 0.84 (12H, brs)

### EXAMPLE 8

### Synthesis of Compound I

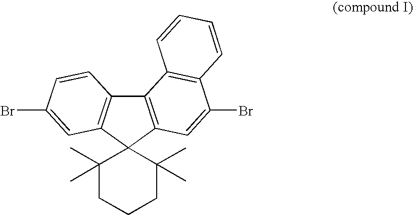

Under a nitrogen atmosphere, into a 300 ml three-necked flask was charged 2 g of compound H (purity: 89.9%), 33 ml of dichloromethane was added to cause dissolution, 33 ml of acetic acid was added and the mixture was heated up to 50° C. in an oil bath. 1.58 g of zinc chloride was added while heating and the mixture was stirred, and a solution prepared by dissolving 4.53 g of benzyltrimethylammonium tribromide in 33 ml of dichloromethane was added over 30 minutes while heating under reflux. Further, the mixture was stirred for 1 hour at 50° C., cooled down to room temperature, then, 50 ml of water was added to terminate the reaction. The solution was separated, and the aqueous layer was extracted with 50 ml of chloroform and the organic layers were combined. The organic layer was washed with 100 ml of a saturated sodium thiosulfate aqueous solution, then, washed with 50 ml of a saturated sodium hydrogen carbonate aqueous solution and 50 ml of water. The resulting organic layer was filtrated through pre-coated silica gel, to obtain 2.7 g of a mixture containing an intended dibromo body compound. This mixture was re-crystallized from hexane, to obtain 0.5 g of compound I as while solid (purity: 99.41%, yield: 16.6%).

¹H-NMR (300 MHz/CDCl₃): δ 0.84 (brs, 6H), 0.87 (brs, 6H), 1.93 (brs, 6H), 7.57 (dt, 1H), 7.63 (td, 1H), 7.65 (td, 1H), 8.04 (s, 1H), 8.24 (d, 1H), 8.38 (s, 1H), 8.38 (dd, 1H), 8.75 (d, 1H), LC/MS (APPI (+)): m/z calcd for [C₂₆H₂₆Br₂]+, 498.3; found, 498

### EXAMPLE 9

### Synthesis of Polymer Compound 5

Compound I (0.448 g), N,N′-bis(4-bromophenyl)-N,N′-bis(4-t-butyl-2,6-dimethylphenyl)-1,4-phenylenediamine (0.074 g) and 2,2′-bipyridyl (0.422 g) were dissolved in 54 mL of dehydrated tetrahydrofuran, then, to this solution was added bis(1,5-cyclooctadiene)nickel(0) {Ni(COD)₂} (0.743 g) under a nitrogen atmosphere, and the mixture was stirred, and heated up to 60° C., then, reacted for 3 hours. This reaction liquid was cooled down to room temperature, and dropped into a mixed solution of 25% ammonia water 4 mL/methanol 54 mL/ion exchanged water 54 mL and the mixture was stirred for 1 hour, then, the deposited precipitate was filtrated and dried under reduced pressure, and dissolved in 70 ml of toluene. After dissolution, 5.2 g of radiolite was added and the mixture was stirred for 30 minutes, and insoluble materials were filtrated. The resultant filtrate was purified by passing through an alumina column. Next, 140 mL of 5.2% hydrochloric acid water was added and the mixture was stirred for 3 hours, then, the aqueous layer was removed. Subsequently, 140 mL of 4% ammonia water was added and the mixture was stirred for 2 hours, then, the aqueous layer was removed. Further, about 140 mL of ion exchanged water was added to the organic layer and the mixture was stirred for 1 hour, then, the aqueous layer was removed. Thereafter, the organic layer was poured into 420 ml of methanol and the mixture was stirred for 0.5 hours, and the deposited precipitate was filtrated and dried under reduced pressure. The yield of the resultant polymer (hereinafter, referred to as polymer compound 5) was 0.22 g. The polystyrene reduced number average molecular weight and weight average molecular weight were Mn=1.9×10⁴ and Mw=7.7×10⁴, respectively.

### EXAMPLE 10

### Synthesis of Compound M

### (Synthesis of Compound J)

Into an argon gas-purged 10 L separable flask was added 619 g of methyl bromobenzoate, 904 g of potassium carbonate and 450 g of 1-naphthylboronic acid, and 3600 ml of toluene and 4000 ml of water were added and the mixture was stirred. 30 g of tetrakistriphenylphosphinepalladium (0) was added and the mixture was heated under reflux, and stirred without any other operation for 3 hours. The mixture was cooled to room temperature, then, separated, and washed with 2000 ml of water. The solvent was distilled off, then, purification was performed by a silica gel column using toluene. The resulting curd was concentrated and washed twice with 774 ml of hexane, and dried, to obtain 596.9 g of compound J as while solid.

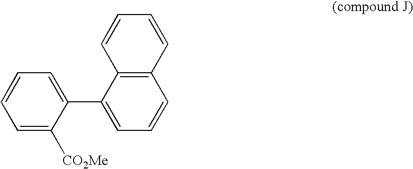

### (Synthesis of Compound K)

A 2 L flask was purged with argon, and 340 g of polyphosphoric acid and 290 ml of methanesulfonic acid were added and the mixture was stirred until uniformity. To this solution was added 50.0 g (0.19 mol) of compound J synthesized above. The mixture was stirred at 50° C. for 8 hours, then, allowed to cool to room temperature, and dropped into 2 L of ice water. The resultant crystal was filtrated, washed with water, and dried under reduced pressure, to obtain 56.43 g of a crude product of compound K. Though the product was a mixture with benzanthrone, the product was not purified and used in the subsequently process.

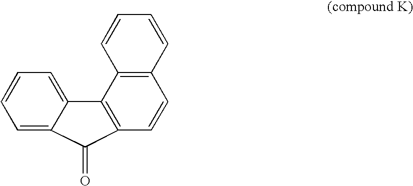

### (Synthesis of Compound L)

A 1 L three-necked flask was purged with nitrogen, and 12.0 g of compound K synthesized above, 250 ml of diethylene glycol and 15 ml of hydrazine monohydrate were added, and the mixture was stirred at 180° C. for 4.5 hours. The mixture was allowed to cool down to room temperature, then, 1 L of water was added, and the resultant mixture was extracted three times with 500 ml of toluene. The toluene phases were combined, and washed with hydrochloric acid, water and saturated saline, and passed through 20 g of silica gel, then, the solvent was distilled off, to obtain 6.66 g of a crude product of compound L. Though the product was a mixture with benzanthrone, the product was not purified and used in the subsequent process.

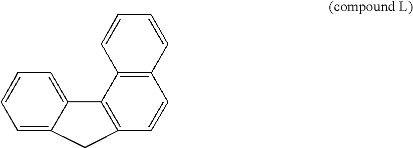

### (Synthesis of Compound M)

A 50 ml two-necked flask was purged with nitrogen, and 6.50 g of compound L synthesized above, 6.5 ml of water, 20 ml of dimethyl sulfoxide, 8.80 g of 1,5-dibromo-3-methylpentane, 5.01 g of sodium hydroxide and 0.98 g of tetra(b-butyl)ammonium bromide were added, and the mixture was stirred at 100° C. for 1 hour. 50 ml of water was added and the mixture was extracted twice with 50 ml of toluene. The toluene phase was filtrated by passing through 10 g of silica gel, and the solvent was distilled off, to obtain 10.18 g of a crude product. The product was purified by silica gel column chromatography (silica gel: 300 g, developing solvent: hexane only), to obtain 6.64 g of compound M (mixture of diastereomers).

MS [APPI(+)] 298 ([M]⁺)

¹H-NMR (300 MHz/CDCl₃) Mixture (about 1:1) of two diastereomers δ 8.81 (1H, d), 8.78 (1H, d), 8.41 (1H, d), 8.37 (1H, s), 8.03 (1H, d), 7.96 to 7.93 (1H×2, m), 7.85 (1H, d), 7.81 (1H, d), 7.66 to 7.30 (5H+6H, m), 2.21 to 2.07 (2H×2, m), 1.85 to 1.77 (5H×2, m), 1.64 to 1.43 (2H×2, m), 1.20 to 1.16 (3H×2, m)

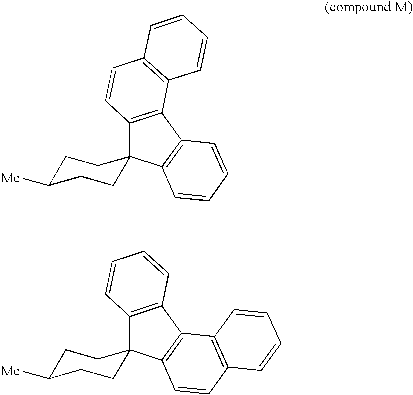

### EXAMPLE 11

### Synthesis of Compound N

A 500 ml three-necked flask was purged with nitrogen, and 6.60 g of compound M, 6.92 g of zinc chloride, 140 ml of acetic acid and 70 ml of dichloromethane were added and the mixture was heated up to 50° C. Into this solution, a solution prepared by dissolving 18.07 g of benzyltrimethylammonium tribromide in 70 ml of dichloromethane was dropped over 1 hour, and the resultant mixture was thermally insulated further for 2 hours. The mixture was cooled down to room temperature, and 200 ml of water was added to terminate the reaction. 50 ml of chloroform was added, and the resulting mixture was washed twice with 100 ml of water. Further, the resulting mixture was washed with 200 mL of a saturated sodium thiosulfate aqueous solution, 200 mL of saturated sodium hydrogen carbonate and 100 mL of water. The resulting organic layer was filtrated by passing through pre-coated silica gel, and the solution was concentrated to obtain 13 g of a crude product containing an intended compound. The product was purified by silica gel column chromatography (developing solvent: hexane only), to obtain 5.58 g of a mixture of diastereomers of compound N.

MS [APPI(+)] 454, 456, 458 ([M]⁺)

¹H-NMR (300 MHz/CDCl₃) Mixture (about 1:1) of two diastereomers δ 8.70 (1H, d), 8.67 (1H, d), 8.38 (1H×2, d), 8.30 (1H, s), 8.21 (1H, d), 8.19 (1H, d), 8.00 (1H, s), 7.90 (1H, s), 7.71 to 7.53 (4H+5H, m), 2.17 to 1.49 (9H×2, m), 1.22 to 1.17 (3H×2, m)

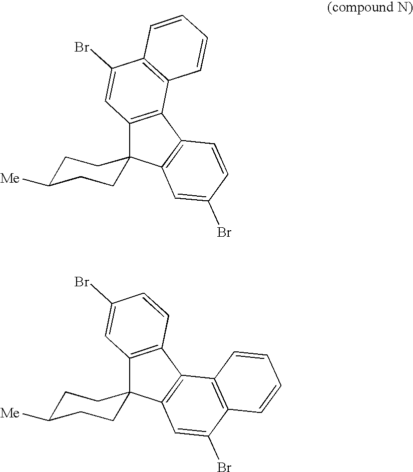

### EXAMPLE 12

### Synthesis of Polymer Compound 6

Compound N (1.1 g), N,N′-bis(4-bromophenyl)-N,N′-bis(4-t-butyl-2,6-dimethylphenyl)-benzidine (0.86 g) and 2,2′-bipyridyl (1.5 g) were dissolved in 285 mL of dehydrated tetrahydrofuran, then, an atmosphere in the system was purged with nitrogen by bubbling with nitrogen. The mixture was heated up to 60° C., then, to this solution was added bis(1,5-cyclooctadiene)nickel(0) {Ni(COD)₂} (2.616 g) under a nitrogen atmosphere, and the mixture was stirred and reacted for 3 hours. This reaction liquid was cooled down to room temperature, and dropped into a mixed solution of 25% ammonia water 13 mL/methanol 285 mL/ion exchanged water 285 mL and the mixture was stirred for 1 hour, then, the deposited precipitate was filtrated and dried under reduced pressure, and dissolved in 106 ml of toluene. After dissolution, 0.42 g of radiolite (manufactured by Showa Kagaku Kogyo K.K.) was added and the mixture was stirred for 30 minutes, and insoluble materials were filtrated. The resultant filtrate was purified by passing through an alumina column. Next, 208 mL of 5.2% hydrochloric acid water was added and the mixture was stirred for 3 hours, then, the aqueous phase was removed. Subsequently, 208 mL of 4% ammonia water was added and the mixture was stirred for 2 hours, then, the aqueous phase was removed. Further, about 208 mL of ion exchanged water was added to the organic layer and the mixture was stirred for 1 hour, then, the aqueous phase was removed. Thereafter, the organic layer was poured into 331 ml of methanol and the mixture was stirred for 1 hour, and the deposited precipitate was filtrated and dried under reduced pressure. The yield of the resultant polymer (hereinafter, referred to as polymer compound 5) was 1.07 g. The polystyrene reduced number average molecular weight and weight average molecular weight were Mn=1.3×10⁴ and Mw=1.1×10⁵, respectively.

### EXAMPLE 13

### Synthesis of Polymer Compound 7

Compound N (2.0 g) and 2,2′-bipyridyl (1.8 g) were dissolved in 316 mL of dehydrated tetrahydrofuran, then, an atmosphere in the system was purged with nitrogen by bubbling with nitrogen. The mixture was heated up to 60° C., then, to this solution was added bis(1,5-cyclooctadiene)nickel(0) {Ni(COD)₂} (3.3 g) under a nitrogen atmosphere, and the mixture was stirred and reacted for 3 hours. This reaction liquid was cooled down to room temperature, and dropped into a mixed solution of 25% ammonia water 16 mL/methanol 316 mL/ion exchanged water 316 mL and the mixture was stirred for 1 hour, then, the deposited precipitate was filtrated and dried under reduced pressure, and dissolved in 132 ml of toluene. After dissolution, 0.53 g of radiolite (manufactured by Showa Kagaku Kogyo K.K.) was added and the mixture was stirred for 30 minutes, and insoluble materials were filtrated. The resultant filtrate was purified by passing through an alumina column. Next, 259 mL of 5.2% hydrochloric acid water was added and the mixture was stirred for 3 hours, then, the aqueous phase was removed. Subsequently, 259 mL of 4% ammonia water was added and the mixture was stirred for 2 hours, then, the aqueous phase was removed. Further, about 259 mL of ion exchanged water was added to the organic layer and the mixture was stirred for 1 hour, then, the aqueous phase was removed. Thereafter, the organic layer was poured into 412 ml of methanol and the mixture was stirred for 1 hour, and the deposited precipitate was filtrated and dried under reduced pressure. The yield of the resultant polymer (hereinafter, referred to as polymer compound 7) was 0.41 g. The polystyrene reduced number average molecular weight and weight average molecular weight were Mn=1.8×10⁴ and Mw=9.9×10⁴, respectively. The glass transition temperature was measured to find a temperature of 165° C.

### EXAMPLE 14

### Synthesis of Polymer Compound 8

Compound N (1.0 g), N,N′-bis(4-bromophenyl)-N,N′-bis(4-t-butyl-2,6-dimethylphenyl)-1,4-phenylenediamine (0.18 g) and 2,2′-bipyridyl (1.03 g) were dissolved in 88 mL of dehydrated tetrahydrofuran, then, an atmosphere in the system was purged with nitrogen by bubbling with nitrogen. The mixture was heated up to 60° C., then, to this solution was added bis(1,5-cyclooctadiene)nickel(0) {Ni(COD)₂} (1.81 g) under a nitrogen atmosphere, and the mixture was stirred and reacted for 3 hours. This reaction liquid was cooled down to room temperature, and dropped into a mixed solution of 25% ammonia water 9 mL/methanol 88 mL/ion exchanged water 88 mL and the mixture was stirred for 1 hour, then, the deposited precipitate was filtrated and dried under reduced pressure, and dissolved in 50 ml of toluene. After dissolution, 5.84 g of radiolite (manufactured by Showa Kagaku Kogyo K.K.) was added and the mixture was stirred for 30 minutes, and insoluble materials were filtrated. The resultant filtrate was purified by passing through an alumina column. Next, 49 mL of 5.2% hydrochloric acid water was added and the mixture was stirred for 3 hours, then, the aqueous phase was removed. Subsequently, 49 mL of 4% ammonia water was added and the mixture was stirred for 2 hours, then, the aqueous phase was removed. Further, about 49 mL of ion exchanged water was added to the organic layer and the mixture was stirred for 1 hour, then, the aqueous phase was removed. Thereafter, the organic layer was poured into 287 ml of methanol and the mixture was stirred for 1 hour, and the deposited precipitate was filtrated and dried under reduced pressure. The yield of the resultant polymer (hereinafter, referred to as polymer compound 8) was 0.55 g. The polystyrene reduced number average molecular weight and weight average molecular weight were Mn=2.9×10⁴ and Mw=1.9×10⁵, respectively.

### EXAMPLE 15

### Manufacturing of Device

(Preparation of solution 1)

Polymer compound 1 and polymer compound 2 obtained above were mixed at a weight ratio of 75:25, and dissolved in toluene so as to give a concentration of 1.3 wt %, manufacturing solution 1.

### (Manufacturing of EL Device)

On a glass substrate carrying thereon an ITO film with a thickness of 150 nm formed by a sputtering method, a solution obtained by filtrating a suspension of poly(3,4)ethylenedioxythiophene/polystyrenesulfonic acid (manufactured by Bayer, BaytronP AI4083) through a 0.2 μm membrane filter was spin-coated to form a thin film with a thickness of 70 nm, and dried on a hot plate at 2000° C. for 10 minutes. Next, solution 1 obtained above was spin-coated at a revolution of 4000 rpm to form a film. The thickness after film formation was about 80 nm. Further, this was dried at 80° C. for 1 hour under reduced pressure, then, lithium fluoride was vapor-deposited with a thickness of about 4 nm, and as a cathode, calcium was vapor-deposited with a thickness of about 5 nm and then aluminum was vapor-deposited with a thickness of about 80 nm, to manufacture an EL device. After the degree of vacuum reached 1×10⁻⁴ Pa or less, vapor-deposition of a metal was initiated. By applying voltage on the resultant device, EL light emission having a peak at 485 nm was obtained from this device. The intensity of EL light emission was approximately in proportion to current density. This device showed initiation of light emission from 4.1 V, and the maximum light emitting efficiency was 4.53 cd/m².

### (Life Measurement)

The EL element obtained above was driven at a constant current of 75 mA/cm², and time change in brilliance was measured, to find an initial brilliance of the device of 3300 cd/m² and a brilliance half time thereof of 9.8 hours. This was converted into the value at an initial brilliance of 400 cd/m² while hypothesizing the acceleration factor of brilliance-life was square, to obtain a half life of 668 hours.

### EXAMPLE 16

### Manufacturing of Device

### (Preparation of Solution 2)

Polymer compound 7 and polymer compound 6 obtained above were mixed at a weight ratio of 75:25, and dissolved in toluene so as to give a concentration of 1.3 wt %, manufacturing solution 2.

### (Manufacturing of EL Device)

On a glass substrate carrying thereon an ITO film with a thickness of 150 nm formed by a sputtering method, a solution obtained by filtrating a suspension of poly(3,4)ethylenedioxythiophene/polystyrenesulfonic acid (manufactured by Bayer, BaytronP AI4083) through a 0.2 μm membrane filter was spin-coated to form a thin film with a thickness of 70 nm, and dried on a hot plate at 200° C. for 10 minutes. Next, solution 2 obtained above was spin-coated at a revolution of 4000 rpm to form a film. The thickness after film formation was about 80 nm. Further, this was dried at 80° C. for 1 hour under reduced pressure, then, lithium fluoride was vapor-deposited with a thickness of about 4 nm, and as a cathode, calcium was vapor-deposited with a thickness of about 5 nm and then aluminum was vapor-deposited with a thickness of about 80 nm, to manufacture an EL device. After the degree of vacuum reached 1×10⁻⁴ Pa or less, vapor-deposition of a metal was initiated. By applying voltage on the resultant device, EL light emission having a peak at 490 nm was obtained from this device. The intensity of EL light emission was approximately in proportion to current density. This device showed initiation of light emission from 3.3 V, and the maximum light emitting efficiency was 3.78 cd/m².

### (Life Measurement)

The EL element obtained above was driven at a constant current of 75 mA/cm², and time change in brilliance was measured, to find an initial brilliance of the device of 2880 cd/m² and a brilliance half time thereof of 2.8 hours. This was converted into the value at an initial brilliance of 400 cd/m² while hypothesizing the acceleration factor of brilliance-life was square, to obtain a half life of 145 hours.

### EXAMPLE 17

### Measurement of Fluorescence Quantum Yield

Polymer compound 1 was subjected to measurement of fluorescence quantum yield by the method described above, to find a value of 73.4%.

### EXAMPLE 18

### Preparation of Solution 3

Polymer compound 2 was dissolved in toluene so as to give a concentration of 0.8 wt %, to prepare solution 3.

### (Measurement of Fluorescence Spectrum)

Solution 3 was spin-coated on quartz, to manufacture a thin film of a polymer. This thin film was excited at a wavelength of 350 nm, and the fluorescence spectrum was measured using a fluorescence spectrophotometer (manufactured by Horiba Ltd.: Fluorolog), to obtain fluorescence spectrum having a peak at 471 nm.

### EXAMPLE 19

### Preparation of Solution 4

Polymer compound 2 was dissolved in xylene so as to give a concentration of 0.8 wt %, to prepare solution 4.

### (Measurement of Fluorescence Spectrum)

Solution 4 was spin-coated on quartz, to manufacture a thin film of a polymer. The fluorescence spectrum was measured by the same method as in Example 18, to obtain fluorescence spectrum having a peak at 472 nm.

### EXAMPLE 20

### Preparation of Solution 5

Polymer compound 2 was dissolved in anisole so as to give a concentration of 0.8 wt %, to prepare solution 5.

### (Measurement of Fluorescence Spectrum)

Solution 5 was spin-coated on quartz, to manufacture a thin film of a polymer. The fluorescence spectrum was measured by the same method as in Example 18, to obtain fluorescence spectrum having a peak at 471 nm.

### EXAMPLE 21

### Preparation of Solution 6

Polymer compound 2 was dissolved in bicyclohexyl so as to give a concentration of 0.8 wt %, to prepare solution 6.

### (Measurement of Fluorescence Spectrum)

Solution 6 was spin-coated on quartz, to manufacture a thin film of a polymer. The fluorescence spectrum was measured by the same method as in Example 18, to obtain fluorescence spectrum having a peak at 471 nm.

### EXAMPLE 22

### Preparation of Solution 7

Polymer compound 2 was dissolved in tetralin so as to give a concentration of 0.8 wt %, to prepare solution 7.

### (Measurement of Fluorescence Spectrum)

Solution 7 was spin-coated on quartz, to manufacture a thin film of a polymer. The fluorescence spectrum was measured by the same method as in Example 18, to obtain fluorescence spectrum having a peak at 470 nm.

### EXAMPLE 23

### Preparation of Solution 8

Polymer compound 2 was dissolved in decalin so as to give a concentration of 0.8 wt %, to prepare solution 8.

### (Measurement of Fluorescence Spectrum)

Solution 8 was spin-coated on quartz, to manufacture a thin film of a polymer. The fluorescence spectrum was measured by the same method as in Example 18, to obtain fluorescence spectrum having a peak at 471 nm.

### EXAMPLE 24

### Preparation of Solution 9

Polymer compound 2 was dissolved in cyclohexanone so as to give a concentration of 0.8 wt %, to prepare solution 9.

### (Measurement of Fluorescence Spectrum)

Solution 9 was spin-coated on quartz, to manufacture a thin film of a polymer. The fluorescence spectrum was measured by the same method as in Example 18, to obtain fluorescence spectrum having a peak at 472 nm.

### EXAMPLE 25

### Preparation of Solution 10

Polymer compound 2 was dissolved in phenylhexane so as to give a concentration of 0.8 wt %, to prepare solution 10.

### (Measurement of Fluorescence Spectrum)

Solution 10 was spin-coated on quartz, to manufacture a thin film of a polymer. The fluorescence spectrum was measured by the same method as in Example 18, to obtain fluorescence spectrum having a peak at 468 nm.

### EXAMPLE 26

### Preparation of Solution 11

Polymer compound 1 was dissolved in toluene so as to give a concentration of 0.8 wt %, to attain dissolution at room temperature, manufacturing solution 11.

### EXAMPLE 27

### Preparation of Solution 11

Polymer compound 7 was dissolved in toluene so as to give a concentration of 0.8 wt %, to attain no dissolution at room temperature, however, when heated at 50° C., solution 12 was prepared.

### INDUSTRIAL APPLICABILITY

The polymer compound of the present invention is useful as a light emitting material and a charge transporting material, and is excellent in heat resistance. Therefore, a polymer LED containing the polymer compound of the present invention can be used as back light of a liquid crystal display, or a curved or flat light source for illumination, and in a segment type display device, dot matrix type flat panel display and the like.

1. A polymer compound comprising a structure of the following formula (1): 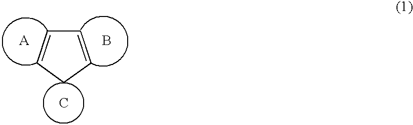
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

2. The polymer compound according to claim 1, comprising a structure of the following formula (1-A): 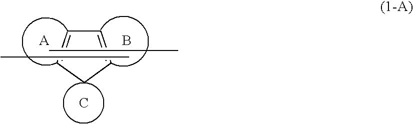
A ring, B ring and C ring represent the same meanings as described above, and two connecting bonds are present each on A ring or B ring.

3. The polymer compound according to claim 1, comprising as a repeating unit a structure of said formula (1-A).

4. The polymer compound according to claim 1, comprising a structure of the following formula (1-B): 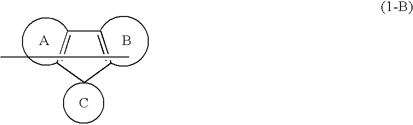
A ring, B ring and C ring represent the same meanings as described above, and a connecting bond is present on A ring or B ring.

5. The polymer compound according to claim 1, comprising a structure of the following formula (1-C): 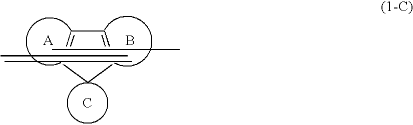
A ring, B ring and C ring represent the same meanings as described above, and three connecting bonds are present each on A ring or B ring.

6. The polymer compound according to claim 1, wherein at least one of A ring and B ring is an aromatic hydrocarbon ring obtained by condensation of two or more benzene rings.

7. The polymer compound according to claim 6 wherein A ring is a benzene ring and B ring is a naphthalene ring.

8. The polymer compound according to claim 2, wherein the structure of said formula (1-A) is a structure of the following formula (1-1) or (1-2): 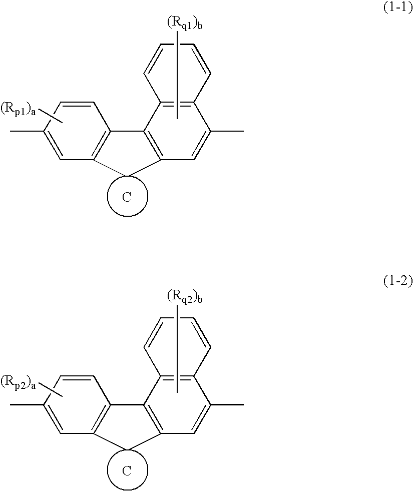
wherein, Rₚ₁, R_{q1}, Rₚ₂ and R_{q2} each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, nitro group or cyano group, a represents an integer of 0 to 3, and b represents an integer of 0 to 5, and when Rₚ₁, R_{q1}, Rₚ₂ and R_{q2} are present each in plural number, they may be the same or different.

9. The polymer compound according to claim 1, wherein the sum of numbers of carbon atoms contained in all substituents carried on C ring is 2 or more.

10. The polymer compound according to claim 9 wherein the sum of numbers of carbon atoms contained in all substituents carried on C ring is 4 or more.

11. The polymer compound according to claim 1, wherein a substituent is connected to at least one of atoms on C ring adjacent to a carbon atom shared by a 5-membered ring to which A ring and B ring are condensed and by C ring, and the substituent has at least one carbon atom.

12. The polymer compound according to claim 11 wherein both of atoms on C ring adjacent to a carbon atom shared by a 5-membered ring to which A ring and B ring are condensed and by C ring are carbon atoms, and alkyl groups in a total number of 2 to 4 are connected as a substituent to these carbon atoms.

13. The polymer compound according to claim 1, wherein A ring and/or B ring has as a substituent at least one alkyl group having a branched structure or cyclic structure.

14. The polymer compound according to claim 2, comprising a repeating unit of said formula (1-A).

15. The polymer compound according to claim 2, comprising two repeating units of said formula (1-A).

16. The polymer compound according to claim 1, wherein an elution curve of GPC is substantially unimodal.

17. The polymer compound according to claim 1, wherein an elution curve of GPC is substantially bimodal.

18. The polymer compound according to claim 1, further comprising a repeating unit of the following formula (3), (4), (5) or (6):
—Ar₁— (3)
-(Ar₂—X₁)_{ff}—Ar₃— (4)
—Ar₄—X₂— (5)
—X₃— (6)
wherein, Ar₁, Ar₂, Ar₃ and Ar₄ each independently represent an arylene group, divalent heterocyclic group or divalent group having a metal complex structure, X₁, X₂ and X₃ each independently represent —CR₉═CR₁₀—, —C≡C—, —N(R₁₁)— or —(SiR₁₂R₁₃)ₘ, R₉ and R₁₀ each independently represent a hydrogen atom, alkyl group, aryl group, monovalent heterocyclic group, carboxyl group, substituted carboxyl group or cyano group, R₁₁, R₁₂ and R₁₃ each independently represent a hydrogen atom, alkyl group, aryl group, monovalent heterocyclic group, arylalkyl group or substituted amino group, ff represents 1 or 2. m represents an integer of 1 to 12, and when and when R₉, R₁₀, R₁₁, R₁₂ and R₁₃ are present each in plural number, they each may be the same or different.

19. The polymer compound according to claim 18 wherein the repeating unit of said formula (3) is a repeating unit of the following formula (1-D) or (1-E): 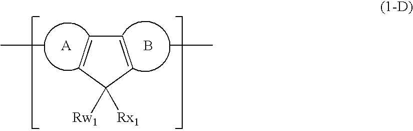
wherein, A ring and B ring represent the same meanings as described above, two connecting bonds are present each on A ring and/or B ring, and Rw₁ and Rx₁ each independently represent a substituent, 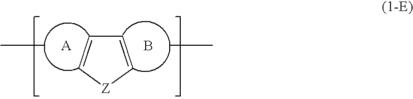
wherein, A ring and B ring represent the same meanings as described above, two connecting bonds are present each on A ring and/or B ring, and Z represents —O—, —S—, —S(═O)—, —S(═O)(═O)—, —N(Rw₂)-, —Si(Rw₂)(Rx₂)-, —P(═O)(Rw₂)-, —P(Rw₂)-, —B(Rw₂)-, —C(Rw₂)(Rx₂)—O—, —C(Rw₂)═N— or —Se, and Rw₂ and Rx₂ each independently represent a substituent.

20. The polymer compound according to claim 18 wherein the repeating unit of said formula (3) is a repeating unit of the following formula (7), (8), (9), (10), (11) or (12): 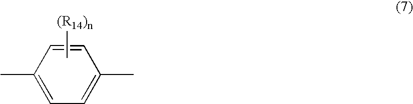
wherein, R₁₄ represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group, n represents an integer of 0 to 4, when there are several R₁₄s, they each may be the same or different 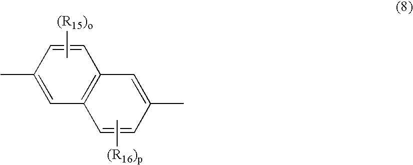
wherein, R₁₅ and R₁₆ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group, o and p each independently represent an integer of 0 to 3, when R₁₅ and R₁₆ are present each in plural number, they each may be the same or different 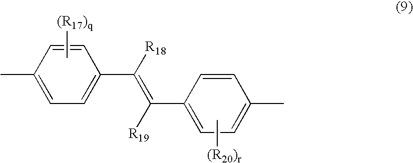
wherein, R₁₇ and R₁₈ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group, q and r each independently represent an integer of 0 to 4, R₁₈ and R_{1g} each independently represent a hydrogen atom, alkyl group, aryl group, monovalent heterocyclic group, carboxyl group, substituted carboxyl group or cyano group, when R₁₇ and R₂₀ are present each in plural number, they each may be the same or different 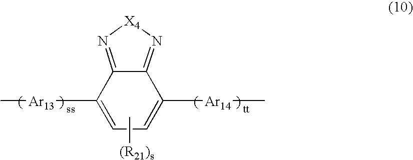
wherein, R₂₁, represents an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group. s represents an integer of 0 to 2, Ar₁₃ and Ar₁₄ each independently represent an arylene group, divalent heterocyclic group or divalent group having a metal complex structure, ss and tt each independently represent 0 or 1, X₄ represents O, S, SO, SO₂, Se or Te, when there are several R₂₁s, they each may be the same or different 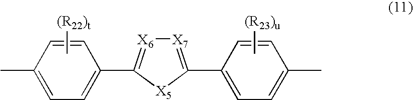
wherein, R₂₂ and R₂₃ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group, t and u each independently represent an integer of 0 to 4, X₅ represents O, S, SO₂, Se, Te, N—R₂₄ or SiR₂₅R₂₆, X₆ and X₇ each independently represent N or C—R₂₇, R₂₄, R₂₅, R₂₆ and R₂₇ each independently represent a hydrogen atom, alkyl group, aryl group, arylalkyl group or monovalent heterocyclic group, when R₂₂, R₂₃ and R₂₇ are present each in plural number, they may be the same or different 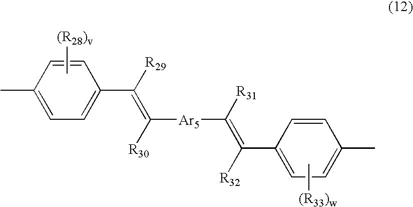
wherein, R₂₈ and R₃₃ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group or cyano group, v and w each independently represent an integer of 0 to 4, R₂₉, R₃₀, R₃₁ and R₃₂ each independently represent a hydrogen atom, alkyl group, aryl group, monovalent heterocyclic group, carboxyl group, substituted carboxyl group or cyano group, Ar₅ represents an arylene group, divalent heterocyclic group or divalent group having a metal complex structure, and when R₂₈ and R₃₃ are present each in plural number, they may be the same or different.

21. The polymer compound according to claim 18 wherein the repeating unit of said formula (4) is a repeating unit of the following formula (13): 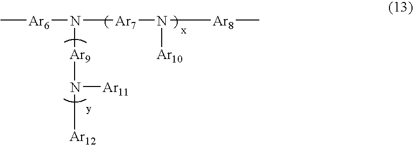
wherein, Ar₆, Ar₇, Ar₈ and Ar₉ each independently represent an arylene group or divalent heterocyclic group, Ar₁₀, Ar₁₁ and Ar₁₂ each independently represent an arylene group or monovalent heterocyclic group, Ar₆, Ar₇, Ar₈, Ar₉ and Ar₁₀ may have a substituent, and x and y each independently represent 0 or positive integer.

22. The polymer compound according to claim 1, comprising at least one repeating unit of the following formula (31), (32) or (33): 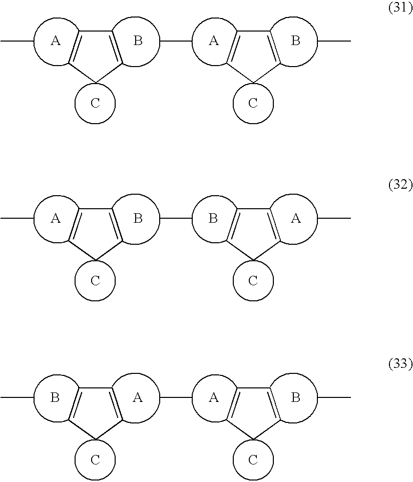
wherein, A ring and B ring each independently represent an aromatic hydrocarbon ring optionally having a substituent, and the aromatic hydrocarbon ring A and the aromatic hydrocarbon ring B have mutually different ring structures, and C ring represents the same meaning as described above.

23. The polymer compound according to claim 22 comprising a repeating unit of said formula (1-A) in an amount of 50 mol % or more based on all repeating units wherein if the proportion that a repeating unit of the formula (1-A) is adjacent to a repeating unit of the formula (1-A) is represented by Q₁₁, Q₁₁ is 25% or more.

24. The polymer compound according to claim 21 comprising a repeating unit of said formula (13) in an amount of 15 to 50 mol % based on all repeating units wherein if the proportion that a repeating unit of the formula (13) is adjacent to a repeating unit of the formula (13) is represented by Q₂₂, Q₂₂ is 15 to 50% or more.

25. The polymer compound according to claim 1, wherein at least one of molecular chain ends of the polymer compound has an end group selected from the group consisting of monovalent heterocyclic groups, monovalent aromatic amine groups, monovalent groups derived from heterocyclic coordinated metal complexes and aryl groups having a formula weight of 90 or more.

26. The polymer compound according to claim 1, wherein the glass transition temperature is 130° C. or higher.

27. The polymer compound according to claim 1, wherein the fluorescence quantum yield is 50% or more.

28. The polymer compound according to claim 1, wherein the polystyrene reduced number average molecular weight is 10³ to 10⁸.

29. The polymer compound according to claim 1, wherein the polystyrene reduced weight average molecular weight is 5×10⁴ or more.

30. A compound of the following formula (14): 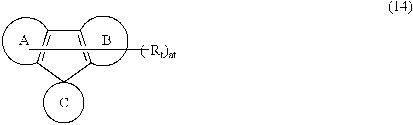
wherein, R₁ represents a substituent, and is connected to A ring and/or B ring, at represents an integer of 0 or more, and A ring, B ring and C ring represents the same meanings as described above.

31. A compound of the following formula (14-A): 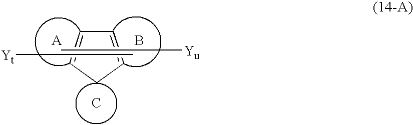
wherein, Y₁ and Yᵤ each independently represent a substituent correlating with polymerization, and are each connected to A ring and/or B ring, and A ring, B ring and C ring represents the same meanings as described above.

32. The compound according to claim 31 wherein said formula (14-A) is the following formula (14-1) or (14-2): 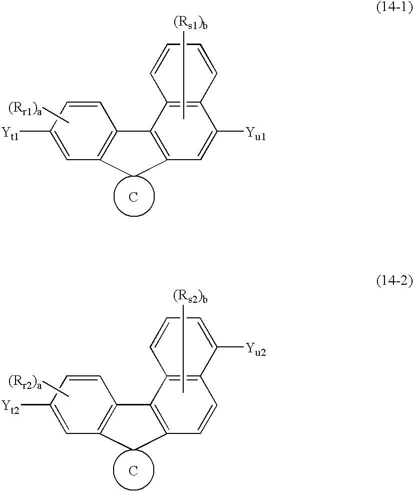
wherein, Rᵣ₁, Rₛ₁, Rᵣ₂ and Rₛ₂ each independently represent an alkyl group, alkoxy group, alkylthio group, aryl group, aryloxy group, arylthio group, arylalkyl group, arylalkoxy group, arylalkylthio group, arylalkenyl group, arylalkynyl group, amino group, substituted amino group, silyl group, substituted silyl group, halogen atom, acyl group, acyloxy group, imine residue, amide group, acid imide group, monovalent heterocyclic group, carboxyl group, substituted carboxyl group, nitro group or cyano group, a represents an integer of 0 to 3, and b represents an integer of 0 to 5 when Rᵣ₁, Rₛ₁, Rᵣ₂ and Rₛ₂ are present each in plural number, they may be the same or different, Y₁₁, Yᵤ₁, Y₁₂ and Yᵤ₂ each independently represent a substituent correlating with polymerization, and C ring represents the same meaning as described above.

33. A method for producing the polymer compound according to claim 1, comprising polymerizing the compound of the following formula (14): 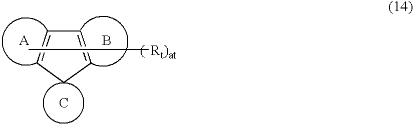
wherein, R₁ represents a substituent, and is connected to A ring and/or B ring, at represents an integer of 0 or more, and A ring, B ring and C ring represents the same meanings as described above.

34. The production method according to claim 33 wherein the substituents correlating with polymerization are each independently selected from halogen atoms, alkyl sulfonate groups, aryl sulfonate groups and aryl alkyl sulfonate groups, and polymerization is performed in the presence of a nickel zerovalent complex.

35. The production method according to claim 33 wherein the substituents correlating with polymerization are each independently selected from halogen atoms, alkyl sulfonate groups, aryl sulfonate groups, aryl alkyl sulfonate groups, —B(OH)₂ and borate groups, the ratio of the sum of mol numbers of halogen atoms, alkyl sulfonate groups, aryl sulfonate groups and aryl alkyl sulfonate groups to the sum of mol numbers of —B(OH)₂ and borate groups, on all raw material compounds, is substantially 1, and polymerization is performed using a nickel or palladium catalyst.

36. A polymer composition comprising at least one material selected from hole transporting materials, electron transporting materials and light emitting materials, and a polymer compound comprising a structure of the following formula (1): 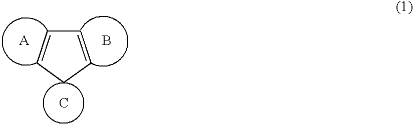
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

37. A polymer composition comprising two or more of the polymer compounds comprising a structure of the following formula (1): 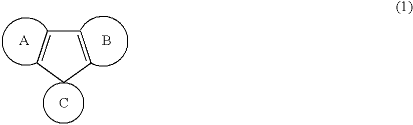
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

38. A solution comprising a polymer compound comprising a structure of the following formula (1): 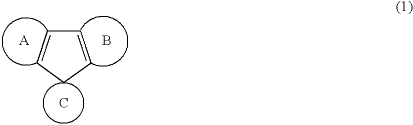
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

39. The solution according to claim 38 wherein the viscosity thereof is 5 to 20 mPa·s at 25° C.

40. A luminescent thin film comprising a polymer compound comprising a structure of the following formula (1): 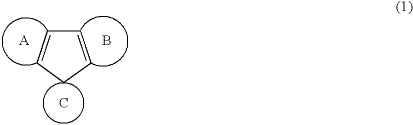
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

41. An electrically conductive thin film comprising a polymer compound comprising a structure of the following formula (1): 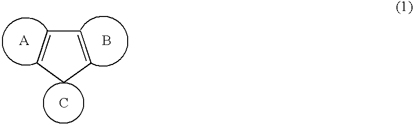
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

42. An organic semiconductor thin film comprising a polymer compound comprising a structure of the following formula (1): 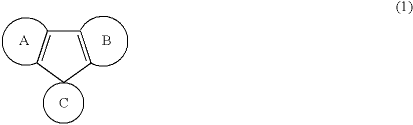
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

43. An organic transistor comprising the organic semiconductor thin film comprising a polymer compound comprising a structure of the following formula (1): 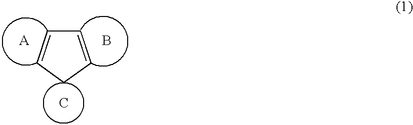
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

44. A polymer light emitting device having an organic layer between electrodes composed of an anode and a cathode wherein the organic layer comprises a polymer compound comprising a structure of the following formula (1): 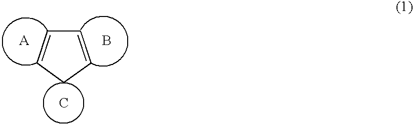
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

45. The polymer light emitting device according to claim 44 wherein the organic layer is a light emitting layer.

46. The polymer light emitting device according to claim 44 wherein the light emitting layer comprises further a hole transporting material, electron transporting material or light emitting material.

47. The polymer light emitting device according to claim 44 having a light emitting layer and a charge transporting layer between electrodes composed of an anode and a cathode wherein the charge transporting layer comprises a polymer compound having an organic layer between electrodes composed of an anode and a cathode wherein the organic layer comprises a polymer compound comprising a structure of the following formula (1): 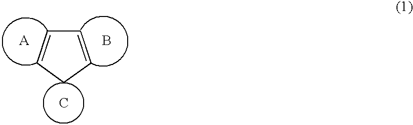
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

48. The polymer light emitting device according to claim 44 having a light emitting layer and a charge transporting layer between electrodes composed of an anode and a cathode and having a charge injection layer between the charge transporting layer and the electrode wherein the charge injection layer comprises a polymer compound comprising a structure of the following formula (1): 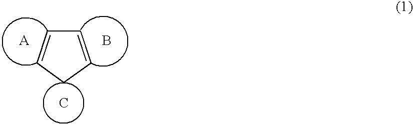
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

49. A sheet light source using a polymer light emitting device having an organic layer between electrodes composed of an anode and a cathode wherein the organic layer comprises a polymer compound comprising a structure of the following formula (1): 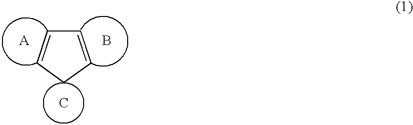
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

50. A segment display using a polymer light emitting device having an organic layer between electrodes composed of an anode and a cathode wherein the organic layer comprises a polymer compound comprising a structure of the following formula (1): 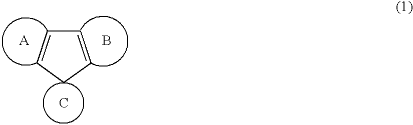
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

51. A dot matrix display using a polymer light emitting device having an organic layer between electrodes composed of an anode and a cathode wherein the organic layer comprises a polymer compound comprising a structure of the following formula (1): 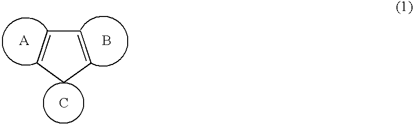
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.

52. A liquid crystal display using as back light a polymer light emitting device having an organic layer between electrodes composed of an anode and a cathode wherein the organic layer comprises a polymer compound comprising a structure of the following formula (1): 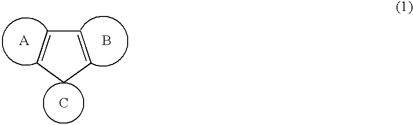
wherein, A ring and B ring each independently represent an aromatic hydrocarbon ring optionally having a substituent, C ring represents an alicyclic hydrocarbon ring having at least one substituent, and the alicyclic hydrocarbon ring may contain a hetero atom.
